(19) United States
(12) Patent Application Publication
(10) Pub. No.: US 2005/0261395 A1
(43) Pub. Date: Nov. 24, 2005

(54) Ink composition and inkjet recording method

(75) Inventors: Takahiro Ishizuka, Kanagawa (JP); Toshiki Fujiwara, Kanagawa (JP); Osamu Takahashi, Kanagawa (JP); Junichi Yamanouchi, Kanagawa (JP); Yoshiharu Yabuki, Kanagawa (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM CO., LTD.

(21) Appl. No.: 11/125,406

(22) Filed: May 10, 2005

Related U.S. Application Data
(63) Continuation of application No. 10/352,973, filed on Jan. 29, 2003, now abandoned.

(30) Foreign Application Priority Data
Jan. 30, 2002 (JP) P. 2002-21652
Jan. 30, 2002 (JP) P. 2002-22012
Jan. 30, 2002 (JP) P. 2002-22493

(51) Int. Cl. C03C 17/00; C09D 11/00

(52) U.S. Cl. 523/160; 523/161

(57) ABSTRACT

To provide an ink composition that when printed using a nozzle, does not cause clogging at the chip of the nozzle, is free from paper dependency, and when printed on an arbitrarily chosen paper, exhibits superior properties in water resistance, scratch resistance, lightfastness and ozone resistance and an inkjet recording method using it. The ink composition contains colored fine particles containing an oil-soluble polymer and an oil-soluble dye having an oxidation potential higher than 1.0 V (vs SCE), in an aqueous medium.

### FIELD OF THE INVENTION

The present invention relates to an ink composition comprising an aqueous colored fine particle dispersion and an inkjet recording method using it. More specifically, the present invention relates to an ink composition that is high in quality of recorded images, is superior in ejection stability and is superior in preservability of obtained images and to an inkjet recording method using it.

### BACKGROUND OF THE INVENTION

In recent years, with the spread of computer, inkjet printers are widely used for printing on papers, films, cloths, etc. in not only offices but also households. As inkjet inks, oily inks, aqueous inks, and solid inks are known. Among them, the aqueous inks are the main current from the standpoints of productivity, easiness in handling, odor, and stability.

However, since the most of the aqueous inks use a water-soluble dye that is dissolved in a molecular state, they are poor in water resistance though they have advantages such as high transparency and high color density. Accordingly, when the aqueous ink is used for printing on plain paper, it causes bleeding, thereby remarkably lowering the printing quality. Additionally, the aqueous inks involved a defect such that they are poor in lightfastness and resistance to oxidizing gases (such SOₓ, NOₓ, and ozone) Thus, for the purpose of solving the foregoing problems, aqueous inks using a pigment or a disperse dye are proposed in, for example, JP-A-56-157468, JP-A-4-18468, JP-A-8-183920, JP-A-10-110126, and JP-A-10-195355. In these aqueous inks, the water resistance is enhanced to some extent but is not complete yet. In particular, as compared with the dye inks, the pigment dyes are inferior in color development and are lacking in storage stability of the dispersion so that they had a defect such that clogging in a ejection outlet likely occurs. Further, though disperse dyes are comparable in transparency and color density to water-soluble dyes, the disperse dyes did not become greatly improved in image preservability as compared with the water-soluble dyes.

When a recording paper having an ink receiving layer containing a porous inorganic pigment on the surface thereof (so-called “photo quality paper”), which has appeared with a rise in intension to high quality of the latest inkjet technology, is used, it has become clear that there is a defect such that the foregoing aqueous inks using a pigment or disperse dye are poor in penetration properties so that when rubbed by fingers, the pigment or dye likely peels apart.

JP-A-58-45272, JP-A-6-340825, JP-A-7-268254, JP-A-7-268257, JP-A-7-268260 and U.S. Pat. No. 4,692,188 propose a method of incorporating a dye into polyurethane or polyester dispersion particles.

However, the dispersions as described in the above-cited patents had a defect such that when the dye is incorporated in a predetermined concentration into the dispersion, colored particles having superior dispersion stability are hardly obtained. Also, these dispersions had a problem of peeling of the dye like the foregoing cases.

On the other hand, JP-A-11-286637 proposes a method of incorporating a dye into a condensed polymer mainly containing dissociative group (such as polyurethanes) and describes that a (water-soluble or water-insoluble) high-boiling solvent may be present. However, in this patent, the amount of a water-soluble hydrophobic high-boiling solvent as used among the high-boiling solvents is very small so that the problem of peeling of the dye occurring in the case of use in the photo quality paper could not be solved.

Also, U.S. Pat. No. 6,025,412 discloses the colored fine particles in which the dye is chemically bonded to a polymer, but since a monomer having a dye basic structure (i.e., a dye skeleton) is synthesized with difficulty, they are insufficient in the general purpose property.

In addition, JP-A-10-279873 discloses a method in which an acrylic polymer and an oil-soluble dye are dissolved and dispersed in an organic solvent, and the organic solvent is then removed to prepare colored polymer fine particles. There were problems in the recorded image quality, particularly the quality when recorded on a paper medium for photo quality and the stability in continuous recording. Also, it could not be said that the lapsing stability of the dispersion is sufficient.

### SUMMARY OF THE INVENTION

The problem that the present invention is to solve is to provide an ink composition having properties such that in an aqueous ink advantageous in handling properties, odor and stability, the ejection stability is high, the color formation is good, and the image obtained when printed on an arbitrarily selected paper is superior in hue, preservability, stability and water resistance and overcoming a defect in image quality such as bleeding of fine lines. In addition, the present invention is to provide an ink composition in which an ink even after lapsing over a long period of time or under severe conditions is high in ejection stability and which is free from the defects in hue, preservability, stability, water resistance and image quality.

The foregoing problems have been solved by the following means.

(1) An ink composition comprising colored fine particles containing an oil-soluble polymer and an oil-soluble dye having an oxidation potential higher than 1.0 V (vs SCE), dispersed in an aqueous medium.

(2) The ink composition as set forth in (1) as above, wherein the oil-soluble dye is at least one member selected from dyes represented by the following general formula (M-I): 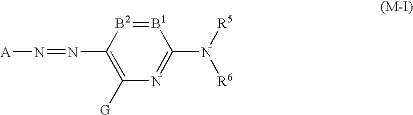
wherein A represents a residue of a 5-membered heterocyclic diazo component A-NH₂; B¹ and B² each represents —CR¹═ or —CR 2═, or either one represents a nitrogen atom, and the other represents —CR¹═ or —CR²═; R⁵ and R⁶ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group, each of which may be substituted; G, R¹, and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group (inclusive of an anilino group), an acylamino group, a ureido group, a sulfamoylamino group, an alkoxycarbonylamino group, an aryloxycarbonylamino group, an alkyl- or arylsulfonylamino group, an aryloxycarbonylamino group, a nitro group, an alkyl- or arylthio group, an alkyl- or arylsulfonyl group, an alkyl- or arylsulfinyl group, a sulfamoyl group, a sulfo group, or a heterocyclic thio group, each of which may further be substituted; and R¹ and R⁵, or R⁵ and R⁶ may be taken together to form a 5-membered or 6-membered ring,
dyes represented by the following general formula (C-I): 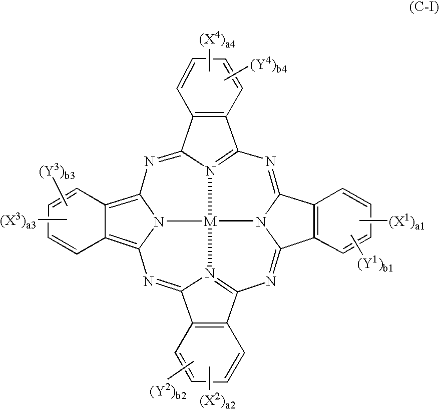
wherein X¹, X², X³, and X⁴ each independently represents at least one substituent selected from —SO-Z, —SO₂-Z, —SO₂NR¹R², —CONR¹R², and —CO₂R¹; Zs′ each independently represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group; R¹ and R² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, provided that both of R¹ and R² do not represent a hydrogen atom at the same time; Y¹, Y², Y³, and Y⁴ each independently represents a monovalent substituent; and a1 to a4 and b1 to b4 represent the number of substituents of X¹ to X⁴ and Y¹ to Y⁴, respectively, a1 to a4 each independently represents an integer of from 0 to 4, and b1 to b4 each independently represents an integer of from 0 to 4, provided that the total sum of a1 to a4 is 2 or more, and dyes represented by the following general formula (Y-I):
A-N═N—B (Y-I)
wherein A and B each independently represents an optionally substituted heterocyclic group.

(3) The ink composition as set forth in (1) or (2) as above, containing a hydrophobic high-boiling organic solvent having a boiling point of 150° C. or higher.

(4) An inkjet recording method comprising using the ink composition as set forth in (1) to (3) as above.

Preferred embodiments of the ink composition and inkjet recording method as set forth in (1) to (4) as above are ink compositions and inkjet recording method as set forth in (5) to (11) as below.

(5) The ink composition as set forth in (2) or (3) as above, wherein the dye represented by the general formula (C-I) is represented by the following general formula (C-II): 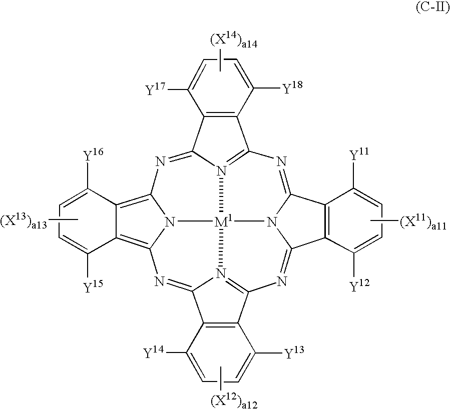
wherein X¹¹ to X¹⁴, Y¹¹ to Y¹⁸, and M¹ are synonymous with X¹ to X⁴, Y¹ to Y⁴, and M in the general formula (C-I), respectively; and all to a14 each independently represents an integer of 1 or 2.

(6) The ink composition as set forth in (1) to (3) and (5) as above, wherein the oil-soluble polymer is a vinyl polymer.

(7) The ink composition as set forth in (3), (5) and (6) as above, wherein the hydrophobic high-boiling organic solvent has a relative dielectric constant as 25° C. in the range of from 3 to 12.

(8) The ink composition as set forth in (3) and (5) to (7) as above, wherein a proportion of the hydrophobic high-boiling organic solvent to the dispersed particle component is 25% or more.

(9) The ink composition as set forth in (3) and (5) to (8) as above, wherein the colored fine particles have a mean particle size of 100 nm or less.

(10) The ink composition as set forth in (3) and (5) to (9) as above, containing at least one member of compounds represented by the following general formula (W-I) or (W-II): 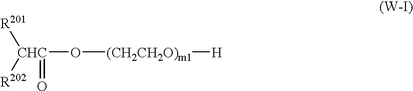
wherein R²⁰¹ and R²⁰² each independently represents a saturated hydrocarbon having from 2 to 20 carbon atoms, and m1 is from 2 to 40, and 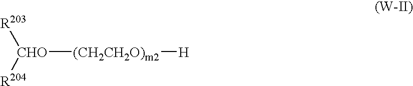
wherein R²⁰³ and R²⁰⁴ each independently represents a saturated hydrocarbon having from 4 to 10 carbon atoms, provided that the total sum of carbon atoms of R²⁰³ and R²⁰⁴ is from a to 18, and m2 is from 3 to 20.

(11) The inkjet recording method as set forth in (4) as above, wherein the recording is carried out on a material to be recorded comprising a support having a porous inorganic pigment-containing ink receiving layer provided thereon.

### DETAILED DESCRIPTION OF THE INVENTION

The present invention will be described below in detail.

(Oil-Soluble Dye)

In order to enhance the anti-fading resistance, especially resistance to oxidizing substances such as ozone, it is preferred that the oil-soluble dye to be used in the ink composition of the present invention has a high oxidation potential. Desirably, the oxidation potential of the oil-soluble dye is high than 1.0 V (vs SCE). It is preferred that the oxidation potential is higher. The oxidation potential of the oil-soluble dye is preferably higher than 1.1 V (vs SCE), more preferably higher than 1.2 V (vs SCE), and most preferably higher than 1.3 V (vs SCE).

The measurement method of the value (Eox) of oxidation potential is described in, for example, Delahay, New Instrumental Methods in Electrochemistry, (1954), by Interscience Publishers; A. J. Bard, et al., Electrochemical Methods, (1980), by John Wiley & Sons; and Akira Fujishima, et al., Denkikagaku Sokuteiho (Electrochemical Measurement Methods), (1984), by Gihodo Shuppan.

Concretely, the oxidation potential is measured by dissolving a test sample (1×10⁻⁴ to 1×10⁻⁶ mole/L) in a solvent (such as dimethylformamide and acetonitrile) containing a supporting electrolyte (such as sodium perchlorate and tetrapropylammonium perchlorate) and measuring a value against SCE (saturated calomel electrode) by using cyclic voltammetry or direct current polarography. This value may deviate by about several tens millivolts by influences such as a liquid potential and a liquid resistance of the sample solution, but it is possible to guarantee the reproductivity of the potential by charging a standard sample (such as hydroquinone).

In the present invention, in order to univocally define the potential, a value (vs SCE) as measured in dimethylformamide containing 0.1 moldm⁻³ of tetrapropylammonium perchlorate as a supporting electrolyte (dye contencentration: 0.001 moldm⁻³) by direct current polarography is defined as the oxidation potential.

The Eox value stands for easiness of the movement of an electron from the sample to the electrode. The higher the value (the higher the oxidation potential), the more difficult the movement of the electron from the sample to the electrode, i.e., the sample is hardly oxidized. In accordance with the relationship with the structure of a compound, when an electron-withdrawing group is introduced, the oxidation potential increases, whereas when an electron-donating group is introduced, the oxidation potential decreases. Accordingly, when the Hammett's substituent constant, op value as a measure of the electron-withdrawing group or electron-donating group is used, it can be said that by introducing a substituent having a large op value, such as a sulfinnyl group, a sulfonyl group, and a sulfamoyl group, the oxidation potential can be made higher.

The oil-soluble dye to be used in the ink composition of the present invention is characterized in that at least one member thereof is a compound represented by the following general formula (M-I), (C-I) or (Y-I).

First, the pigment represented by the general formula (M-I) of the present invention will be described below in detail.

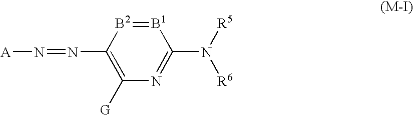

In the general formula (M-I), A represents a residue of a 5-membered heterocyclic diazo component A-NH₂; B¹ and B² each represents —CR¹═ or —CR²═, or either one represents a nitrogen atom, and the other represents —CR¹═ or —CR²═; R⁵ and R⁶ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group, each of which may be substituted; G, R¹, and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group (inclusive of an anilino group), an acylamino group, a ureido group, a sulfamoylamino group, an alkoxycarbonylamino group, an aryloxycarbonylamino group, an alkyl- or arylsulfonylamino group, an aryloxycarbonylamino group, a nitro group, an alkyl- or arylthio group, an alkyl- or arylsulfonyl group, an alkyl- or arylsulfinyl group, a sulfamoyl group, a sulfo group, or a heterocyclic thio group, each of which may further be substituted; and R¹ and R⁵, or R⁵ and R⁶ may be taken together to form a 5-membered or 6-membered ring.

The dye represented by the foregoing general formula (M-I) will be described below in more detail.

In the general formula (M-I), A represents a residue of a 5-membered heterocyclic diazo component A-NH₂. Examples of the hetero atom of the heterocyclic ring include N, O, and S. Preferably, the heterocyclic ring is a nitrogen-containing 5-membered heterocyclic ring which may be condensed with an aliphatic ring, an aromatic ring or other heterocyclic ring. Preferred examples of the heterocyclic ring of A include a pyrazole ring, an imidazole ring, a thiazole ring, an isothiazole ring, a thiadiazole ring, a benzothiazole ring, a benzoxazole ring, and a benzoisothiazole ring. Each of these heterocyclic rings may further be substituted. Of these are preferable a pyrazole ring, an imidazole ring, an isothiazole ring, a thiadiazole ring, and a benzothiazole ring represented by the following general formulae (a) to (f), respectively.

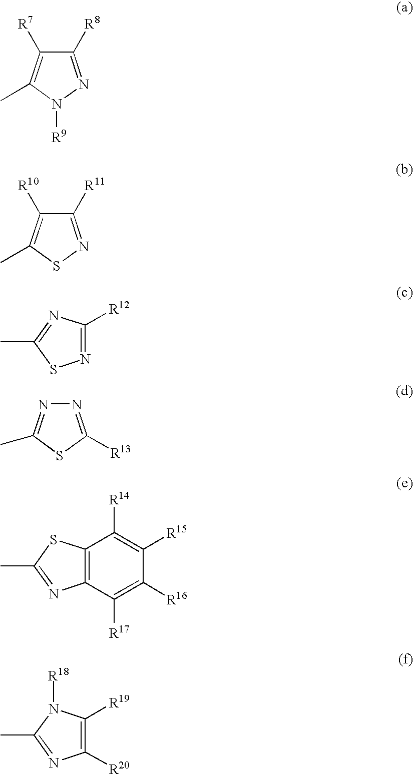

In the general formulae (a) to (f), R⁷ to R²⁰ are the same as in the substituents described in G, R¹ and R².

Among the general formulae (a) to (f), the pyrazole ring represented by the general formula (a) and the isothiazole ring represented by the general formula (b) are more preferred, and the pyrazole ring represented by the general formula (a) is most preferred.

B¹ and B² each represents —CR¹═ or —CR²═, or either one represents a nitrogen atom, and the other represents —CR¹═ or —CR²═, and preferably, B1 and B2 each represents —CR¹═ or —CR^{2═.}

R⁵ and R⁶ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group, each of which may be substituted. Preferred examples of the substituents represented by R⁵ and R⁶ include a hydrogen atom, an aliphatic group, an aromatic group, a heterocyclic group, an acyl group, and an alkyl- or arylsulfonyl group; more preferably a hydrogen atom, an aromatic group, a heterocyclic group, an acyl group, and an alkyl- or aryl-sulfonyl group; and most preferably a hydrogen atom, an aryl group, and a heterocyclic group. Each of these groups may further be substituted. However, both of R⁵ and R⁶ do not represent a hydrogen atom at the same time.

G, R¹, and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, a hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group (inclusive of an anilino group), an acylamino group, a ureido group, a sulfamoylamino group, an alkoxycarbonylamino group, an aryloxycarbonylamino group, an alkyl- or arylsulfonylamino group, a nitro group, an alkyl- or arylthio group, a heterocyclic thio group, an alkyl- or arylsulfonyl group, an alkyl- or arylsulfinyl group, a sulfamoyl group, or a sulfo group, each of which may further be substituted.

Preferred examples of the substituent represented by G include a hydrogen atom, a halogen atom, an aliphatic group, an aromatic group, a hydroxyl group, an alkoxy group, an aryloxy group, an acyloxy group, a heterocyclic oxy group, an amino group (inclusive of an anilino group), an acylamino group, a ureido group, an sulfamoylamino group, an alkoxycarbonylamino group, an aryloxycarbonylamino group, an alkyl- or arylthio group, and a heterocyclic thio group; more preferably a hydrogen atom, a halogen atom, an alkyl group, a hydroxyl group, an alkoxy group, an aryloxy group, an acyloxy group, an amino group (inclusive of an anilino group), and an acylamino group; and most preferably a hydrogen atom, an arylamino group, and an amide group. Each of these groups may further be substituted.

Preferred examples of the substituent represented by R¹ and R² include a hydrogen atom, an alkyl group, an alkoxycarbonyl group, a carboxyl group, a carbamoyl group, and a cyano group. Each of these groups may further be substituted.

R¹ and R⁵, or R⁵ and R⁶ may be taken together to form a 5-membered or 6-membered ring.

As the substituent with which each of the substituents represented by A, R¹, R², R⁵, R⁶, and G can be enumerated the substituents as enumerated above for G, R¹ and R².

In the present invention, the aliphatic group includes an alkyl group, a substituted alkyl group, an alkenyl group, a substituted alkenyl group, an alkynyl group, a substituted alkynyl group, an aralkyl group, and a substituted aralkyl group. The aliphatic group may be branched or may form a ring. The number of carbon atoms of the aliphatic group is preferably from 1 to 20, and more preferably from 1 to 16. The aryl moiety of the aralkyl group and the substituted aralkyl group is preferably phenyl or naphthyl, and particularly preferably phenyl. Examples of the aliphatic group include a methyl group, an ethyl group, a butyl group, an isopropyl group, a t-butyl group, a hydroxyethyl group, a methoxyethyl group, a cyanoethyl group, a trifluoromethyl group, a 3-sulfopropyl group, a 4-sulfobutyl group, a cyclohexyl group, a benzyl group, a 2-phenethyl group, a vinyl group, and an allyl group.

In the present invention, the aromatic group includes an aryl group and a substituted aryl group. The aryl group is preferably phenyl or naphthyl, and particularly preferably phenyl. The number of carbon atoms of the aromatic group is preferably from 6 to 20, and more preferably from 6 to 16. Examples of the aromatic group include phenyl, p-tolyl, p-methoxyphenyl, o-chlorophenyl, and m-(3-sulfopropylamino)phenyl. The heterocyclic group includes a substituted heterocyclic group and an unsubstituted heterocyclic group. The heterocyclic group may be condensed with an aliphatic group, an aromatic group, or other heterocyclic group. The heterocyclic group is preferably a 5-membered or 6-membered heterocyclic group. Examples of the substituent include an aliphatic group, a halogen atom, an alkyl- or arylsulfonyl group, an acyl group, an acylamino group, a sulfamoyl group, a carbamoyl group, and an ionic hydrophilic group. Examples of the heterocyclic group include a 2-pyridyl group, a 2-thienyl group, a 2-thiazolyl group, a 2-benzothiazolyl group, a 2-benzoxazolyl group, and a 2-furyl group.

Examples of the alkyl- or arylsulfonyl group include a methanesulfonyl group and a phenylsulfonyl group.

Examples of the alkyl- or arylsulfinyl group include a methanesulfinyl group and a phenylsulfinyl group.

The acyl group includes a substituted acyl group and an unsubstituted acyl group. The acyl group is preferably an acyl group having from 1 to 12 carbon atoms. Examples of the substituent include an ionic hydrophilic group. Examples of the acyl group include an acetyl group and a benzoyl group.

Examples of the halogen atom include a fluorine atom, a chlorine atom, and a bromine atom.

The amino group includes an amino group substituted with an alkyl group, an aryl group or a heterocyclic group. Each of these alkyl, aryl and heterocyclic groups may further be substituted. The amino group does not include an unsubstituted amino group. As the alkylamino group is preferable an alkylamino group having from 1 to 6 carbon atoms. Examples of the substituent include an ionic hydrophilic group. Examples of the alkylamino group include a methylamino group and a diethylamino group. The arylamino group includes a substituted arylamino group and an unsubstituted arylamino group. As the arylamino group is preferably an arylamino group having from 6 to 12 carbon atoms. Examples of the substituent include a halogen atom and an ionic hydrophilic group. Examples of the arylamino group include an anilino group and a 2-chloroanilino group.

The alkoxy group includes a substituted alkoxy group and an unsubstituted alkoxy group. As the alkoxy group is preferable an alkoxy group having from 1 to 12 carbon atoms. Examples of the substituent include an alkoxy group, a hydroxyl group, and an ionic hydrophilic group. Examples of the alkoxy group include a methoxy group, an ethoxy group, an isopropoxy group, a methoxyethoxy group, a hydroxyethoxy group, and a 3-carboxypropoxy group.

The aryloxy group includes a substituted aryloxy group and an unsubstituted aryloxy group. As the aryloxy group is preferable an aryloxy group having from 6 to 12 carbon atoms. Examples of the substituent include an alkoxy group and an ionic hydrophilic group. Examples of the aryloxy group include a phenoxy group, a p-methoxyphenoxy group, and an o-methoxyphenoxy group.

The acylamino group includes a substituted acylamino group. As the acylamino group is preferable-an acylamino group having from 2 to 12 carbon atoms. Examples of the substituent include an ionic hydrophilic group. Examples of the acylamino group include an acetylamino group, a propionylamino group, a benzoylamino group, an N-phenylacetylamino group, and a 3,5-disulfobenzoylamino group.

The ureido group includes a substituted ureido group and an unsubstituted ureido group. As the ureido group is preferable a ureido group having from 1 to 12 carbon atoms. Examples of the substituent include an alkyl group and an aryl group. Examples of the ureido group include a 3-methylureido group, a 3,3-dimethylureido group, and a 3-phenylureido group.

The sulfamoylamino group includes a substituted sulfamoyl group and an unsubstituted sulfamoylamino group. Examples of the substituent include an alkyl group. Examples of the sulfamoylamino group include an N,N-dipropylsulfamoylamino group.

The alkoxycarbonylamino group includes a substituted alkoxycarbonylamino group and an unsubstituted alkoxycarbonylamino group. As the alkoxycarbonylamino group is preferable an alkoxycarbonylamino group having from 2 to 12 carbon atoms. Examples of the substituent include an ionic hydrophilic group. Examples of the alkoxycarbonylamino group include an ethoxycarbonylamino group.

The alkyl- or arylsulfonylamino group includes a substituted alkyl- or arylsulfonylamino group and an unsubstituted alkyl- or arylsulfonylamino group. As the sulfonylamino group is preferable a sulfonylamino group having from 1 to 12 carbon atoms. Examples of the substituent include an ionic hydrophilic group. Examples of the sulfonylamino group include a methanesulfonylamino group, an N-phenylmethanesulfonylamino group, a benzenesulfonylamino group, and a 3-carboxybenzenesulfonylamino group.

The carbamoyl group includes a substituted carbamoyl group and an unsubstituted carbamoyl group. Examples of the substituent include an alkyl group. Examples of the carbamoyl group include a methylcarbamoyl group and a dimethylcarbamoyl group.

The sulfamoyl group includes a substituted sulfamoyl group and an unsubstituted sulfamoyl group. Examples of the substituent include an alkyl group. Examples of the sulfamoyl group include a dimethylsulfamoyl group and a di-(2-hydroxyethyl)sulfamoyl group.

The alkoxycarbonyl group includes a substituted alkoxycarbonyl group and an unsubstituted alkoxycarbonyl group. As the alkoxycarbonyl group is preferable an alkoxycarbonyl group having from 2 to 12 carbon atoms. Examples of the substituent include an ionic hydrophilic group. Examples of the alkoxycarbonyl group include a methoxycarbonyl group and an ethoxycarbonyl group.

The acyloxy group includes a substituted acyloxy group and an unsubstituted acyloxy group. As the acyloxy group is preferable an acyloxy group having from 1 to 0.12 carbon atoms. Examples of the substituent include an ionic hydrophilic group. Examples of the acyloxy group include an acetoxy group and a benzoyloxy group.

The carbamoyloxy group includes a substituted carbamoyloxy group and an unsubstituted carbamoyloxy group. Examples of the substituent include an alkyl group. Examples of the carbamoyloxy group include an N-methylcarbamoyloxy group.

The aryloxycarbonyl group includes a substituted aryloxycarbonyl group and an unsubstituted aryloxycarbonyl group. As the aryloxycarbonyl group is preferable an aryloxycarbonyl group having from 7 to 12 carbon atoms. Examples of the substituent include an ionic hydrophilic group. Examples of the aryloxycarbonyl group include a phenoxycarbonyl group.

The aryloxycarbonylamino group includes a substituted aryloxycarbonylamino group and an unsubstituted aryloxycarbonylamino group. As the aryloxycarbonylamino group is preferable an aryloxycarbonylamino group having from 7 to 12 carbon atoms. Examples of the substituent include an ionic hydrophilic group. Examples of the aryloxycarbonylamino group include a phenoxycarbonylamino group.

The alkyl, aryl or heterocyclic thio group includes a substituted alkyl, aryl or heterocyclic thio group and an unsubstituted alkyl, aryl or heterocyclic thio group. As the alkyl, aryl or heterocyclic thio group is preferable an alkyl, aryl or heterocyclic thio group having from 1 to 12 carbon atoms. Examples of the substituent include an ionic hydrophilic group. Examples of the alkyl, aryl or heterocyclic thio group include a methylthio group, a phenylthio group, and a 2-pyridylthio group.

In the present invention, a particularly preferred structure is represented by the following general formula (M-II).

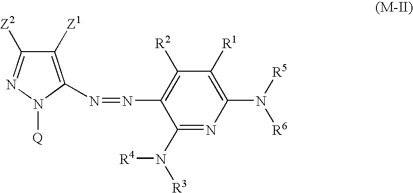

In the general formula (M-II), Z¹ represents an electron-withdrawing group having a Hammett's substituent constant, op value of 0.20 or more.

Z¹ preferably represents an electron-withdrawing group having a op value of 0.30 or more and 1.0 or less. As preferred specific examples of the substituent, electron-withdrawing substituents as described later are enumerated. Especially, an acyl group having from 2 to 12 carbon atoms, an alkyloxycarbonyl group having from 2 to 12 carbon atoms, a nitro group, a cyano group, an alkylsulfonyl group having from 1 to 12 carbon atoms, an arylsulfonyl group having from 6 to 18 carbon atoms, a carbamoyl group having from 1 to 12 carbon atoms, and a halogenated alkyl group having from 1 to 12 carbon atoms are preferred. Of these are particularly preferable a cyano group, an alkylsulfonyl group having from 1 to 12 carbon atoms, and an arylsulfonyl group having from 6 to 18 carbon atoms, with a cyano group being most preferred.

In the general formula (M-II), R R², R⁵, and R⁶ are synonymous with those in the general formula (M-I). R³ and R⁴ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group. Of these are preferable a hydrogen atom, an aromatic group, a heterocyclic group, an acyl group, and an alkyl- or arylsulfonyl group, with a hydrogen atom, an aromatic group, and a heterocyclic group being particularly preferred. Z² represents a hydrogen atom, an aliphatic group, an aromatic group, or a heterocyclic group. Q represents a hydrogen atom, an aliphatic group, an aromatic group, or a heterocyclic group. Especially, it is preferred that Q represents a group comprising a non-metal atomic group necessary for forming a 5- to 8-membered ring. The 5- to 8-membered ring may be substituted or may be a saturated ring, or may have an unsaturated bond. Among them, an aromatic group and a heterocyclic group are particularly preferred. As the non-metal atom are preferable a nitrogen atom, an oxygen atom, a sulfur atom, and a carbon atom. Specific examples of such ring structures include a benzene ring, a cyclopentane ring, a cyclohexane ring, a cycloheptane ring, a cyclooctane ring, a cyclohexene ring, a pyridine ring, a pyrimidine ring, a pyrazine ring, a pyridazine ring, a triazine ring, an imidazole ring, a benzoinidazole ring, an oxazole ring, a benzoxazole ring, a thiazole ring, a benzothiazole ring, an oxane ring, a sulfolane ring, and a thiane ring.

Each of the groups described for the general formula (M-II) may further have a substituent. In the case where each of these groups has a substituent, examples of the substituent include those described for the general formula (M-I), and those enumerated for G, R¹, and R², and an ionic hydrophilic group.

Now, the Hammett's substituent constant, op value as referred to in the present invention will be described. The Hammett's rule is an empirical rule advocated by L. P. Hammett in 1935 in order to quantitatively discuss the influence of substituents on the reaction or equilibrium of benzene derivatives, and propriety of this rule is now widely recognized. The substituent constant required for the Hammett's rule includes a up value and a am value. These values can be found in many general books. For example, the details are given in J. A. Dean ed., Lange's Handbook of Chemistry, 12th Ed. (1979), by McGraw-Hill; and a special issue of Kagaku no Ryoiki (Regions of Chemistry), No. 122, pp. 96-103 (1979), by Nankodo. Needless to say, while in the present invention, each substituent will be limited or described in terms of the Hammett's substituent constant op value, this does not mean that the present invention is limited only to substituents having known values that can be found from the foregoing books, but the present invention also includes substituents, values of which are unknown but will fall within the intended scope when measured according to the Hammett's rule. Further, though compounds that are not a benzene derivative are included within the scopes of the general formulae (1) to (2), the up values are used as a measure to exhibit the electronic effect of the substituent irrespective of the substitution position. In the present invention, the op value is used in such meanings.

Examples of the electron-withdrawing group having a Hammett's substituent constant, up value of 0.60 or more include a cyano group, a nitro group, an alkylsulfonyl group (such as a methanesulfonyl group), and an arylsulfonyl group (such as a benzenesulfonyl group).

Examples of the electron-withdrawing group having a Hammett's substituent constant, op value of 0.45 or more include not only those as enumerated above but also an acyl group (such as an acetyl group), an alkoxycarbonyl group (such as a dodecyloxycarbonyl group), an aryloxycarbonyl group (such as an m-chlorophenoxycarbonyl group), an alkylsulfinyl group (such as an n-propylsulfinyl group), an arylsulfinyl group (such as a phenylsulfinyl group), a sulfamoyl group (such as an N-ethylsulfamoyl group and an N,N-dimethylsulfamoyl group), and a halogenated alkyl group (such as a trifluoromethyl group).

Examples of the electron-withdrawing group having a Hammett's substituent constant, up value of 0.30 or more include not only those as enumerated above but also an acyloxy group (such as an acetoxy group), a carbamoyl group (such as an N-ethylcarbamoyl group and an N,N-dibutylcarbamoyl group), a halogenated alkoxy group (such as a trifluoromethyloxy group), a halogenated aryloxy group (such as a pentafluorophenyloxy group), a sulfonyloxy group (such as a methylsulfonyloxy group), a halogenated alkylthio group (such as a difluoromethylthio group)., an aryl group substituted with two or more electron-withdrawing groups having a op value of 0.15 or more (such as a 2,4-dinitrophenyl group and a pentachlorophenyl group), and a heterocyclic group (such as a 2-benzoxazolyl group, a 2-benzothiazolyl group, and a 1-phenyl-2-benzimidazolyl group). Specific examples of the electron-withdrawing group having a op value of 0.20 or more include not only those as enumerated above but also a halogen atom.

With respect to the particularly preferred combination of substituents as the azo pigment represented by the general formula (M-I), R⁵ and R⁶ are each preferably a hydrogen atom, an alkyl group, an aryl group, a heterocyclic group, a sulfonyl group, or an acyl group; more preferably a hydrogen atom, an aryl group, a heterocyclic group, or a sulfonyl group; and most preferably a hydrogen atom, an aryl group, or a heterocyclic group. However, both of R⁵ and R⁶ do not represent a hydrogen atom at the same time.

G is preferably a hydrogen atom, a halogen atom, an alkyl group, a hydroxyl group, an amino group, or an amide group; more preferably a hydrogen atom, a halogen atom, an amino group, or an amide group; and most preferably a hydrogen atom, an amino group, or an amide group.

A is preferably a pyrazole ring, an imidazole-ring, an isothiazole ring, a thiadiazole ring, or a benzothiazole ring; more preferably a pyrazole ring or an isothiazole ring; and most preferably a pyrazole ring.

Preferably, B¹ and B² each represents —CR¹═ or —CR²═. R¹ and R² are each preferably a hydrogen atom, a halogen atom, a cyano group, a carbamoyl group, a carboxyl group, an alkyl group, a hydroxyl group, or an alkoxy group, and more preferably a hydrogen atom, a cyano group, a carbamoyl group, or an alkoxy group.

With respect to the preferred combination of substituents represented by the general formula (M-I), compounds in which at least one of the various substituents represents a substituent as enumerated above as the preferred examples are preferable; compounds in which many of the various substituents represent substituents as enumerated above as the preferred examples are more preferable; and compounds in which all of the substituents represent substituents as enumerated above as the preferred examples are most preferable.

Specific examples of the azo pigment represented by the general formula (M-I) will be given below, but it should not be construed that the azo pigment to be used in the present invention is limited thereto.

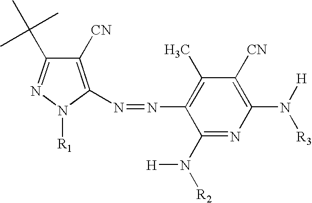

| Dye | R₁ | R₂ | R₃ |
|---|---|---|---|
| a-1 | 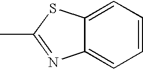 | 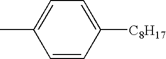 | 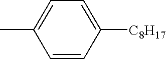 |
| a-2 | 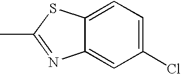 | 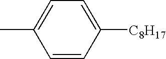 | 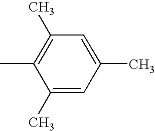 |
| a-3 | 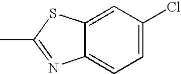 | 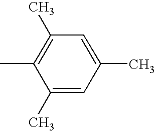 | 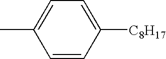 |
| a-4 | 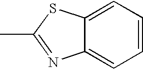 | 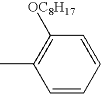 | 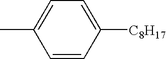 |
| a-5 | 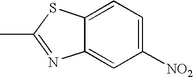 | 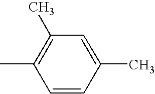 | 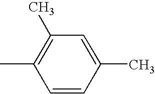 |
| a-6 | 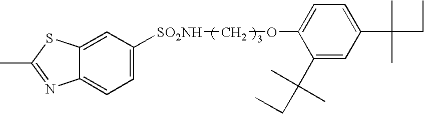 | 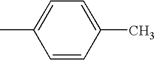 | 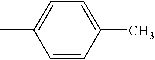 |
| a-7 | 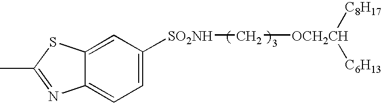 | 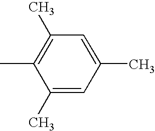 | 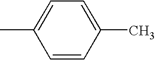 |
| a-8 | 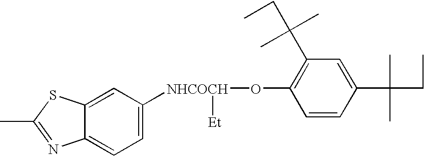 | 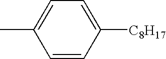 | 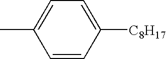 |
| a-9 | 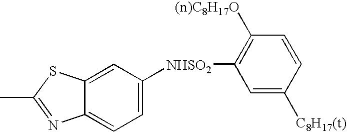 | 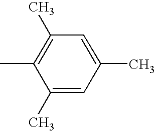 | C₈H₁₇(t) |
| a-10 | 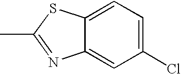 | 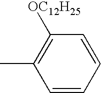 | 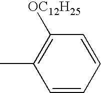 |

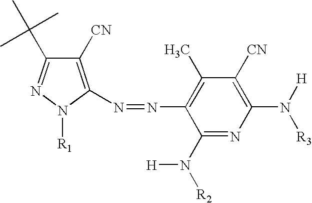

| Dye | R₁ | R₂ |
|---|---|---|
| a-11 | 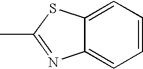 | 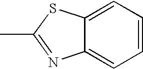 |
| a-12 | 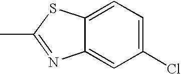 | —SO₂CH₃ |
| a-13 | 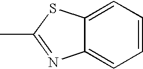 | —COCH₃ |
| a-14 | 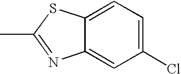 | 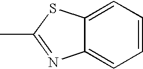 |
| a-15 | 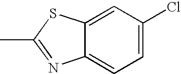 | —SO₂CH₃ |
| a-16 | 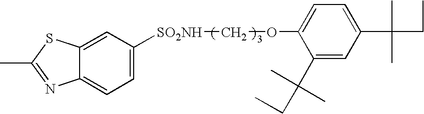 | 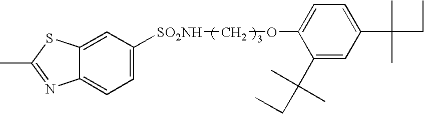 |
| a-17 | 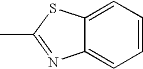 | 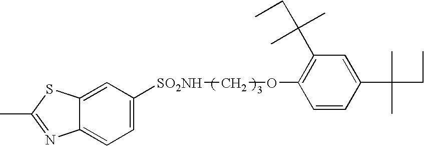 |
| a-18 | 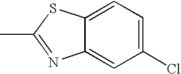 | 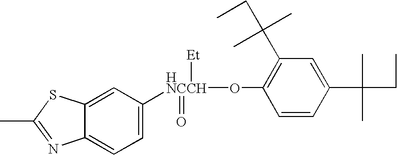 |
| a-19 | 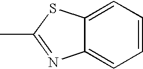 | 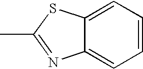 |
| a-20 | 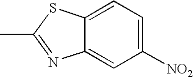 | 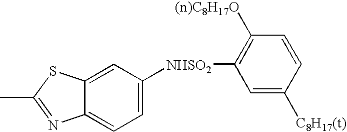 |

| Dye | R₃ | R₄ |
|---|---|---|
| a-11 | 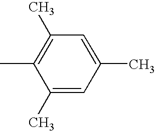 | 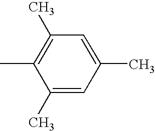 |
| a-12 | 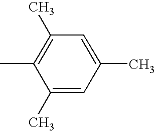 | 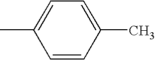 |
| a-13 | C₈H₁₇(t) | C₈H₁₇(t) |
| a-14 | 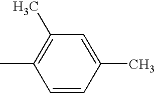 | 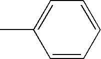 |
| a-15 | 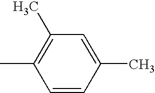 | C₈H₁₇(t) |
| a-16 | 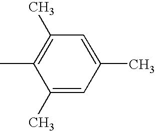 | 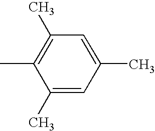 |
| a-17 | 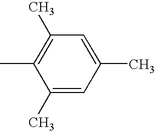 | 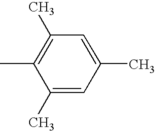 |
| a-18 | 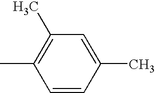 | 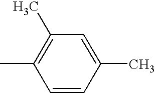 |
| a-19 | 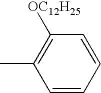 | 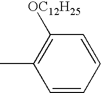 |
| a-20 | 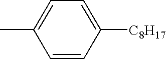 | C₈H₁₇(t) |

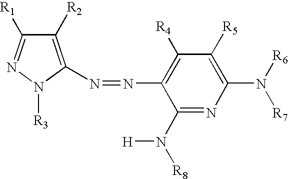

| Dye | R₁ | R₂ | R₃ | R₄ | R₅ | R₆ |
|---|---|---|---|---|---|---|
| a-21 | 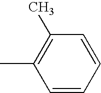 | CN | 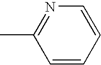 | H | CONH₂ | SO₂CH₃ |
| a-22 | 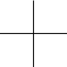 | Br | 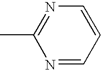 | COOEt | H | 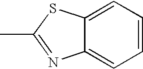 |
| a-23 | 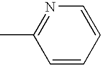 | SO₂CH₃ | 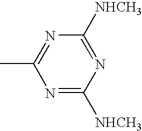 | CONH₂ | H | 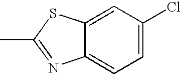 |
| a-24 | 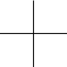 | CN | 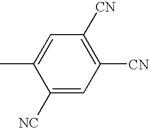 | H | H | 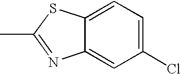 |
| a-25 | 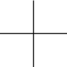 | Br | 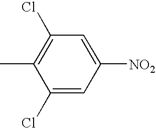 | H | CONH₂ | 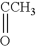 |
| a-26 | 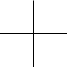 | CN | 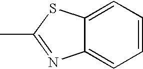 | CH₃ | H | 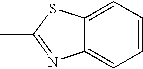 |
| a-27 | 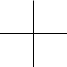 | CN | 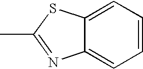 | CH₃ | CN | H |

| Dye | R₇ | R₈ |
|---|---|---|
| a-21 | 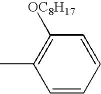 | 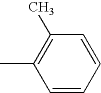 |
| a-22 | C₈H₁₇(t) | COCH₃ |
| a-23 | 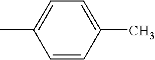 | 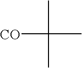 |
| a-24 | 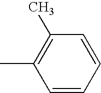 | SO₂CH₃ |
| a-25 | 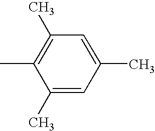 | 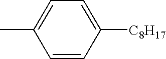 |
| a-26 | 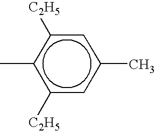 | 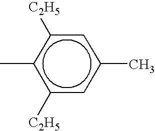 |
| a-27 | 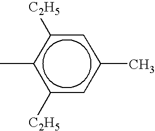 | 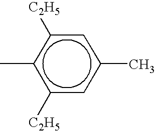 |

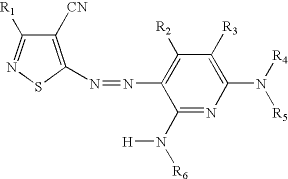

| Dye | R₁ | R₂ | R₃ | R₄ | R₅ | R₆ |
|---|---|---|---|---|---|---|
| b-1 | CH₃ | CH₃ | CN | H | 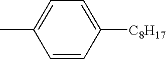 | 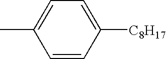 |
| b-2 | CH₃ | CH₃ | CN | H | 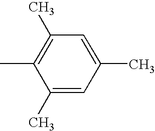 | 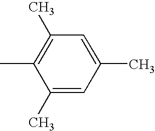 |
| b-3 | CH₃ | CH₃ | CONH₂ | H | 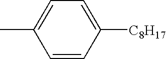 | 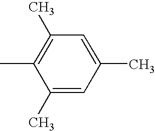 |
| b-4 | CH₃ | CH₃ | H | H | 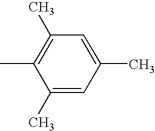 | 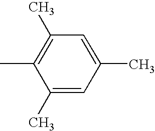 |

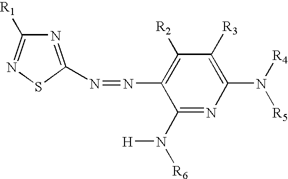

| Dye | R₁ | R₂ | R₃ | R₄ | R₅ | R₆ |
|---|---|---|---|---|---|---|
| c-1 | —SCH₃ | CH₃ | CN | H | C₈H₁₇(t) | 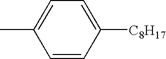 |
| c-2 | —CH₃ | CH₃ | H | 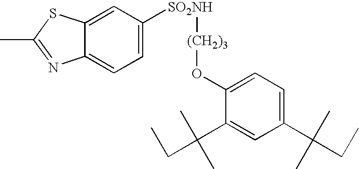 | 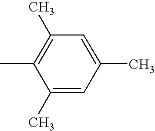 | 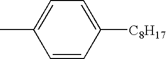 |
| c-3 | 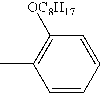 | H | H | 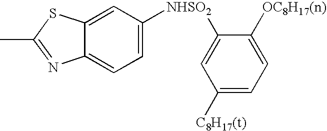 | 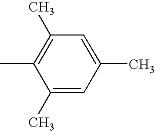 | C₈H₁₇(t) |

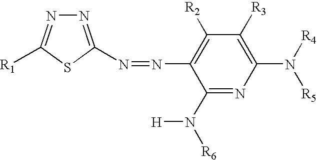

| Dye | R₁ | R₂ | R₃ | R₄ | R₅ | R₆ |
|---|---|---|---|---|---|---|
| d-1 | Me | CH₃ | CN | H | 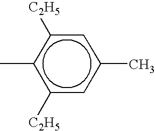 | 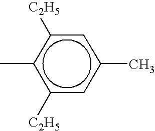 |
| d-2 | Me | H | H | 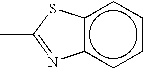 | 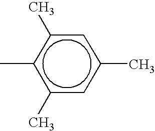 | 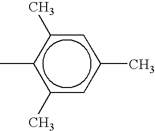 |
| d-3 | Ph | CH₃ | CONH₂ | H | 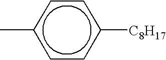 | 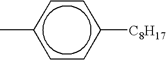 |
| d-4 | Ph | CH₃ | H | 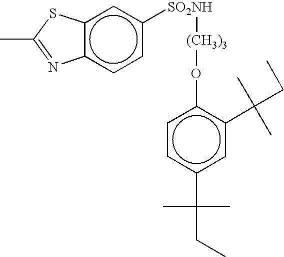 | 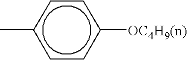 | 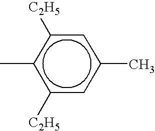 |

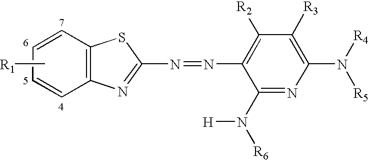

| Dye | R₁ | R₂ | R₃ | R₄ | R₅ | R₆ |
|---|---|---|---|---|---|---|
| e-1 | 5-Cl | CH₃ | CONH₂ | H | C₈H₁₇(t) | C₈H₁₇(t) |
| e-2 | 5,6-diCl | H | H | 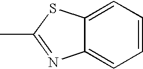 | 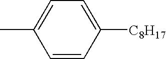 | 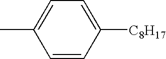 |
| e-3 | 5,6-diCl | CH₃ | H | 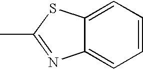 | 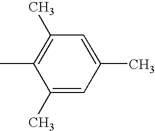 | COCH₃ |
| e-4 | 5-NO₂ | CH₃ | H | SO₂CH₃ | 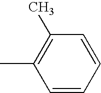 | 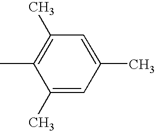 |

The compound represented by the following general formula (C-I) of the present invention will be described below in detail.

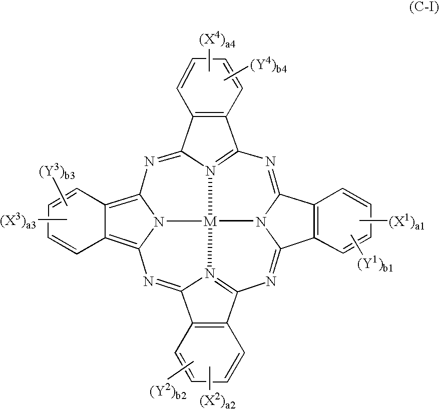

In the general formula (C-I), X¹, X², X³, and X⁴ each independently represents at least one substituent selected from —SO-Z, —SO₂-Z, —SO₂NR¹R², —CONR¹R², and —CO₂R¹. Of these, —SO-Z, —SO₂-Z, —SO₂NR¹R², and —CONR¹R² are preferable; —SO₂-Z and —SO₂NR¹R² are more preferable; and —SO₂-Z is most preferable. When a1 to a4 representing the number of substituents of X¹ to X⁴, respectively are each a number of 2 or more, plural X¹s′, X²s′, X³s′, and X⁴s′ may be the same or different and each independently represents any one of the foregoing groups. Further, all of X¹, X², X³, and X⁴ may represent exactly the same substituent, or all of X¹, X², X³, and X⁴ may represent the same kind of substituent but a partially different substituent, for example, in the case where all of X¹, X², X³, and X⁴ represent —SO₂-Z, but Zs′ are different. Moreover, X¹, X², X³, and X⁴ may each contain different substituents, for example, in the case where —SO₂Z and —SO₂NR¹R² are substituted at the same time.

Zs′ each independently represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group. Of these are preferable a substituted or unsubstituted alkyl group, a substituted or unsubstituted aryl group, and a substituted or unsubstituted heterocyclic group are preferable, with a substituted alkyl group, a substituted aryl group, and a substituted heterocyclic group being most preferred.

R¹ and R² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group. Of these are preferable a hydrogen atom, a substituted or unsubstituted alkyl group, a substituted or unsubstituted aryl group, and a substituted or unsubstituted heterocyclic group are preferable, with a hydrogen atom, a substituted alkyl group, a substituted aryl group, and a substituted heterocyclic group being most preferred. However, both of R¹ and R² do not represent a hydrogen atom at the same time.

As the substituted or unsubstituted alkyl group represented by R¹, R² and Z is preferable an alkyl group having from 1 to 30 carbon atoms. Particularly, a branched alkyl group is preferred for the reason that the dye dissolution properties and ink stability are enhanced. Especially, the case of having an asymmetric carbon atom (use in a racemate) is preferred. As examples of the substituent can be enumerated the same examples of the substituent in the case where Z, R¹, R², Y¹, Y², Y³, and Y⁴ can further be substituted as described below. Among them, a hydroxyl group, an ether group, an ester group, a cyano group, an amide group, and a sulfonamide group are particularly preferred because they enhance the dye association properties and fastness properties. Besides, the alkyl group may have a halogen atom and an ionic hydrophilic group.

As the substituted or unsubstituted cycloalkyl group represented by R¹, R² and Z is preferable a cycloalkyl group having from 5 to 30 carbon atoms. Particularly, the case of having an asymmetric carbon atom (use in a racemate) is preferred for the reason that the dye dissolution properties and ink stability are enhanced. As examples of the substituent can be enumerated the same examples of the substituent in the case where Z, R¹, R², Y¹, Y², Y³, and Y⁴ can further be substituted as described below. Among them, a hydroxyl group, an ether group, an ester group, a cyano group, an amide group, and a sulfonamide group are particularly preferred because they enhance the dye association properties and fastness properties. Besides, the cycloalkyl group may have a halogen atom and an ionic hydrophilic group.

As the substituted or unsubstituted alkenyl group represented by R¹, R² and Z is preferable an alkenyl group having from 2 to 30 carbon atoms. Particularly, a branched alkenyl group is preferred for the reason that the dye dissolution properties and ink stability are enhanced. Especially, the case of having an asymmetric carbon atom (use in a racemate) is preferred. As examples of the substituent can be enumerated the same examples of the substituent in the case where Z, R¹, R², Y¹, Y², Y³, and Y⁴ can further be substituted as described below. Among them, a hydroxyl group, an ether group, an ester group, a cyano group, an amide group, and a sulfonamide group are particularly preferred because they enhance the dye association properties and fastness properties. Besides, the alkenyl group may have a halogen atom and an ionic hydrophilic group.

As the substituted or unsubstituted aralkyl group represented by R¹, R² and Z is preferable an aralkyl group having from 7 to 30 carbon atoms. Particularly, a branched aralkyl group is preferred for the reason that the dye dissolution properties and ink stability are enhanced. Especially, the case of having an asymmetric carbon atom (use in a racemate) is preferred. As examples of the substituent can be enumerated the same examples of the substituent in the case where Z, R¹, R², Y¹, Y², Y³, and Y⁴ can further be substituted as described below. Among them, a hydroxyl group, an ether group, an ester group, a cyano group, an amide group, and a sulfonamide group are particularly preferred because they enhance the dye association properties and fastness properties. Besides, the aralkyl group may have a halogen atom and an ionic hydrophilic group.

As the substituted or unsubstituted aryl group represented by R¹, R² and Z is preferable an aryl group having from 6 to 30 carbon atoms. As examples of the substituent can be-enumerated the same examples of the substituent in the case where Z, R¹, R², Y¹, Y², Y³, and Y⁴ can further be substituted as described below. Among them, an electron-withdrawing group is particularly preferred because it makes the oxidation potential of the dye noble and enhances the fastness properties. As specific examples of the electron-withdrawing group can be enumerated those as described with respect to the magenta dye. Among them are preferable a halogen atom, a heterocyclic group, a cyano group, a carboxyl group, an acylamino group, a sulfonamide group, a sulfamoyl group, a carbamoyl group, a sulfonyl group, an imido group, an acyl group, a sulfo group, and a quaternary ammonium group, with a cyano group, a carboxyl group, a sulfamoyl group, a carbamoyl group, a sulfonyl group, an imido group, an acyl group, a sulfo group, and a quaternary ammonium group being more preferred.

As the heterocyclic group represented by R¹, R² and Z is preferable a 5-membered or 6-membered heterocyclic group, which may further be condensed. The heterocyclic group may be of an aromatic heterocyclic ring or a non-aromatic heterocyclic ring. Specific examples of the heterocyclic group represented by R¹, R², and Z will be given below in terms of the form of a heterocyclic ring while omitting the substitution position or positions, but it should be construed that the substitution position or positions are never limited thereto. For example, in the case of a pyridine, it can be substituted at the 2-position, 3-position or 4-position. Examples include pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazoline, and thiazoline. Of these, aromatic heterocyclic groups are preferred. Specific examples of the aromatic heterocyclic group include pyridine, pyrazine, pyrimidine, pyridazine, triazine, pyrazole, imidazole, benzimidazole, triazole, thiazole, benzothiazole, isothiazole, benzisothiazole, and thiadiazole. Each of these groups may further have a substituent as described later.

Y¹, Y², Y³, and Y⁴ each independently represents a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, a carboxyl group, and a sulfo group. Each of these groups may further have a substituent.

Especially, Y¹, Y², Y³, and Y⁴ are each preferably a hydrogen atom, a halogen atom, an alkyl group, an aryl group, a cyano group, an alkoxy group, an amide group, a ureido group, a sulfonamide group, a carbamoyl group, a sulfamoyl group, an alkoxycarbonyl group, a carboxyl group, or a sulfo group; more preferably a hydrogen atom, a halogen atom, a cyano group, a carboxyl group, or a sulfo group; and most preferably a hydrogen atom.

When Z, R¹, R², Y¹, Y², Y³, and Y⁴ each represents a group that can further have a substituent, these groups may have the following substituents.

Examples of the substituent include a linear or branched chain alkyl group having from 1 to 12 carbon atoms, a linear: or branched chain aralkyl group having from 7 to 18 carbon atoms, a linear or branched chain alkenyl group having from 2 to 12 carbon atoms, a linear or branched chain alkynyl group having from 2 to 12 carbon atoms, a linear or branched chain cycloalkyl group having from 3 to 12 carbon atoms, and a linear or branched chain cycloalkenyl group having from 3 to 12 carbon atoms (among them, those having a branched chain are preferred for the reason that they enhance the dye dissolution properties and ink stability, and those having an asymmetric carbon atom are particularly preferred; and specific examples include methyl, ethyl, propyl, isopropyl, sec-butyl, t-butyl, 2-ethylhexyl, 2-methylsulfonylethyl, 3-phenoxypropyl, trifluoromethyl, and cyclopentyl); a halogen atom (such as a chlorine atom and a bromine atom); an aryl group (such as phenyl, 4-t-butylphenyl, and 2,4-di-t-amylphenyl); a heterocyclic group (such as imidazolyl, pyrazolyl, triazolyl, 2-furyl, 2-thienyl, 2-pyrimidinyl, and 2-benzothiazolyl); a cyano group; a hydroxyl group; a nitro group; a carboxy group; an amino group; an alkyloxy group (such as methoxy, ethoxy, 2-methoxyethoxy, and 2-methanesulfonylethoxy); an aryloxy group (such as phenoxy, 2-methylphenoxy, 4-t-butylphenoxy, 3-nitrophenoxy, 3-t-butyloxycarbamoylphenoxy, and 3-methoxycarbamoyl); an acylamino group (such as acetamide, benzamide, and 4-(3-t-butyl-4-hydroxyphenoxy)butanamide); an alkylamino group (such as methylamino, butylamino, diethylamino, and methylbutylamino); an anilino group (such as phenylamino and 2-chloroanilino); a ureido group (such as phenylureido, methylureido, and N,N-dibutylureido); a sulfamoylamino group (such as N,N-dipropylsulfamoylamino); an alkylthio group (such as methylthio, octylthio, and 2-phenoxyethylthio); an arylthio group (such as phenylthio, 2-butoxy-5-t-octylphenylthio, and 2-carboxyphenylthio); an alkyloxycarbonylamino group (such as methoxycarbonylamino); a sulfonamide group (such as methanesulfonamide, benzenesulfonamide, and p-toluenesulfonamide); a carbamoyl group (such as N-ethylcarbamoyl and N,N-dibutylcarbamoyl); a sulfamoyl group (such as N-ethylsulfamoyl, N,N-dipropylsulfamoyl, and N-phenylsulfamoyl); a sulfonyl group (such as methanesulfonyl, octanesulfonyl, benzenesulfonyl, and toluenesulfonyl); an alkyloxycarbonyl group (such as methoxycarbonyl and butyloxycarbonyl); a heterocyclic oxy group (such as 1-phenyltetrazole-5-oxy and 2-tetrahydropyranyloxy); an azo group (such as phenylazo, 4-methoxyphenylazo, 4-pivaroylaminophenylazo, and 2-hydroxy-4-propanoylphenylazo); an acyloxy group (such as acetoxy); a carbamoyloxy group (such as N-methylcarbamoyloxy and N-phenylcarbamoyloxy); a silyloxy group (such as trimethylsilyloxy and dibutylmethylsilyloxy); an aryloxycarbonylamino group (such as phenoxycarbonylamino); an imido group (such as N-succimido and N-phthalimido); a heterocyclic thio group (such as 2-benzothiazolylthio-1-2,4-diphenoxy-1,3,5-triazole-6-thio, and 2-pyridylthio); a sulfinyl group (such as 3-phenoxypropylsulfinyl); a phosphonyl group (such as phenoxyphosphonyl, octyloxyphosphonyl, and phenylphosphonyl); an aryloxycarbonyl group (such as phenoxycarbonyl); an acyl group (such as acetyl, 3-phenylpropanoyl, and benzoyl); and an ionic hydrophilic group (such as a carboxyl group, a sulfo group, a phosphino group, and a quaternary ammonium group).

a1 to a4 and b1 to b4 represent the numbers of the substituents X₁ to X⁴ and Y₁ to Y₄, respectively. a1 to a4 each independently represents a number of from 0 to 4, provided that all of a1 to a4 are not 0 at the same time. b1 to b4 each independently represents a number of 0 to 4. When a1 to a4 and b1 to b4 each represents a number of 2 or more, plural X¹s′ to X⁴s, and Y¹s′ to Y⁴s′ may be the same or different.

a1 and b1 each independently represents a number of from 0 to 4 while meeting the relationship of (a1+b1)=4. Especially, a combination in which a1 is 1 or 2, and b1 is 3 or 2 is preferred, with a combination of a1=1 and b1=3 is most preferred.

In each of the combinations of a2 and b2, a3 and b3, and a4 and b4, there is the same relationship as in the case of the combination of a1 and b1, and a preferred combination is also the same.

M represents a hydrogen atom, a metal element, a metal oxide, a metal hydroxide, or a metal halide.

As preferred examples of M are enumerated a hydrogen atom; Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, and Bi as the metal element; VO and GeO as the metal oxide; Si(OH)₂, Cr(OH)₂, and Sn(OH)₂ as the metal hydroxide; and AlCl, SiCl₂, VCl, VCl₂, VOCl, FeCl, GaCl, and ZrCl as the metal halide. Among them, Cu, Ni, Zn, and Al are more preferred, with Cu being most preferred.

Further, Pc (phthalocyanine ring) may form a dimer (such as Pc-M-L-M-Pc) or a trimer via L (divalent connecting group). At that time, Ms′ may be the same or different from each other.

As the divalent connecting group represented by L are preferable an oxy group (—O—), a thio group (—S—), a carbonyl group (—CO—), a sulfonyl group (—SO₂—), an imino group (—NH—), a methylene group (—CH₂—), and a group formed from a combination thereof.

As the phthalocyanine-based pigment represented by the general formula (C-I) are especially preferable the following combinations.

Particularly preferably, X¹ to X⁴ each independently represents —SO₂-Z or —SO₂NR¹R².

Preferably, Zs′ each independently represents a substituted or unsubstituted alkyl group, a substituted or unsubstituted aryl group, or a substituted or unsubstituted heterocyclic group, and most preferably a substituted alkyl group, a substituted aryl group, or a substituted heterocyclic group.

Preferably, R¹ and R² each independently represents a hydrogen atom, a substituted or unsubstituted alkyl group, a substituted or unsubstituted aryl group, or a substituted or unsubstituted heterocyclic group, and most preferably a hydrogen atom, a substituted alkyl group, a substituted aryl group, or a substituted heterocyclic group.

Preferably, Y¹ to Y⁴ each independently represents a hydrogen atom, a halogen atom, an alkyl group, an aryl group, a cyano group, an alkoxy group, an amide group, a ureido group, a sulfonamide group, a carbamoyl group, a sulfamoyl group, an alkoxycarbonyl group, a carboxyl group, or a sulfo group, and more preferably a hydrogen atom, a halogen atom, a cyano group, a carboxyl group, or a sulfo group, with a hydrogen atom being most preferred.

Preferably, a1 to a4 each independently represents 1 or 2, and most preferably 1. Preferably, b1 to b4 each independently represents 3 or 2, and most preferably 3.

Preferably, M represents a hydrogen atom, a metal element, a metal oxide, a metal hydroxide, or a metal halide, more preferably Cu, Ni, Zn, or Al, and most preferably Cu.

With respect to the preferred combination of groups of the compound represented by the general formula (C-I), compounds in which at least one of the various groups represents a substituent as enumerated above as the preferred examples are preferable; compounds in which many of the various groups represent substituents as enumerated above as the preferred examples are more preferable; and compounds in which all of the groups represent substituents as enumerated above as the preferred examples are most preferable.

Of the phthalocyanine pigments represented by the general formula (C-I) is more preferable a phthalocyanine pigment having a structure represented by the following general formula (C-II). The phthalocyanine pigment represented by the general formula (C-II) of the present invention will be described below in detail.

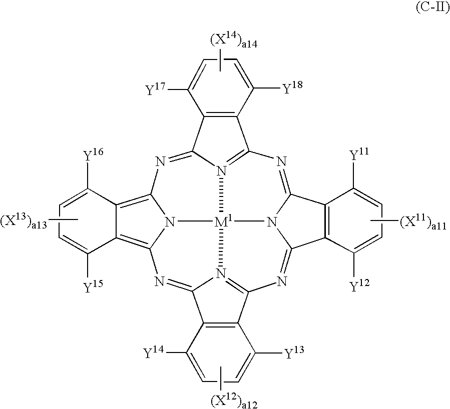

In the general formula (C-II), X¹¹ to X¹⁴ and Y¹¹ to Y¹⁸ are synonymous with X¹ to X⁴ and Y¹ to Y⁴ in the general formula (C-I), and their preferred examples are also the same. Further, M is synonymous with M in the general formula (C-I), and its preferred examples are also the same.

In the general formula (C-It), all to a14 each independently represents an integer of 1 or 2, and preferably, they meet the relationship of 4≦(a11+a12+a13+a14)≦6, with the case of a11=a12=a13=a14=1 being most preferred.

All of X¹¹, X¹², X¹³, and X¹⁴ may represent exactly the same substituent, or all of X¹¹, X¹², X¹³, and X¹⁴ may represent the same kind of substituent but a partially different substituent, for example, in the case where all of X¹¹, X¹², X¹³, and X¹⁴ represent —SO₂-Z, but Zs′ are different. Moreover, X¹¹, X¹², X¹³, and X¹⁴ may each contain different substituents, for example, in the case where —SO₂Z and —SO₂NR¹R² are substituted at the same time.

As the phthalocyanine pigment represented by the general formula (C-II) are especially preferable the following combinations.

Preferably, X¹¹ to X¹⁴ each independently represents —SO-Z, —SO₂-Z, —SO₂NR R², or —CONR¹R²; more preferably —SO₂-Z or —SO₂NR¹R²; and most preferably —SO₂-Z.

Preferably, Zs′ each independently represents a substituted or unsubstituted alkyl group, a substituted or unsubstituted aryl group, or a substituted or unsubstituted heterocyclic group, and most preferably a substituted alkyl group, a substituted aryl group, or a substituted heterocyclic group. Especially, the case where the substituent has an asymmetric carbon atom (use in a racemate) is preferred for the reason that the dye dissolution properties and ink stability are enhanced. Further, the case where the substituent has a hydroxyl group, an ether group, an ester group, a cyano group, an amide group, or a sulfonamide group is preferred for the reason that the dye association properties and fastness properties are enhanced.

Preferably, R¹ and R² each independently represents a hydrogen atom, a substituted or unsubstituted alkyl group, a substituted or unsubstituted aryl group, or a substituted or unsubstituted heterocyclic group, and most preferably a hydrogen atom, a substituted alkyl group, a substituted aryl group, or a substituted heterocyclic group. However, R¹ and R² do not represent a hydrogen atom at the same time. Especially, the case where the substituent has-an asymmetric carbon atom (use in a racemate) is preferred for the reason that the dye dissolution properties and ink stability are enhanced. Further, the case where the substituent has a hydroxyl group, an ether group, an ester group, a cyano group, an amide group, or a sulfonamide group is preferred for the reason that the dye association properties and fastness properties are enhanced.

Preferably, Y¹¹ to Y¹⁸ each independently represents a hydrogen atom, a halogen atom, an alkyl group, an aryl group, a cyano group, an alkoxy group, an amide group, a ureido group, a sulfonamide group, a carbamoyl group, a sulfamoyl group, an alkoxycarbonyl group, a carboxyl group, or a sulfo group, more preferably a hydrogen atom, a halogen atom, a cyano group, a carboxyl group, or a sulfo group, and most preferably a hydrogen atom.

Preferably, a11 to a14 each independently represents 1 or 2, with the case where all of a11 to a14 are 1 being most preferred.

Preferably, M represents a hydrogen atom, a metal element, a metal oxide, a metal hydroxide, or a metal halide, more preferably Cu, Ni, Zn, or Al, and most preferably Cu.

With respect to the preferred combination of groups of the compound represented by the general formula (C-II), compounds in which at least one of the various groups represents a substituent as enumerated above as the preferred examples are preferable; compounds in which many of the various groups represent substituents as enumerated above as the preferred examples are more preferable; and compounds in which all of the groups represent substituents as enumerated above as the preferred examples are most preferable.

It is preferred to introduce at least one of each of electron-withdrawing groups including a sulfinyl group, a sulfonyl group, and a sulfamoyl group into each of the benzene rings of the phthalocyanine such that the total sum of op values is 1.6 or more.

Now, the Hammett's substituent constant, op value as referred to in the specification and claims of this application will be described. The Hammett's rule is an empirical rule advocated by L. P. Hammett in 1935 in order to quantitatively discuss the influence of substituents on the reaction or equilibrium of benzene derivatives, and propriety of this rule is now widely recognized. The substituent constant required for the Hammett's rule includes a op value and a am value. These values can be found in many general books. For example, the details are given in J. A. Dean ed., Lange's Handbook of Chemistry, 12th Ed. (1979), by McGraw-Hill; and a special issue of Kagaku no Ryoiki (Regions of Chemistry), No. 122, pp. 96-103 (1979), by Nankodo.

In general, the phthalocyanine derivative represented by the general formula (C-I) is a mixture of analogues that are inevitably different in the position and number of the substituents Xn (n=1 to 4) and Ym (m=1 to 4) to be introduced depending on the synthesis process. In many cases, such a mixture of analogues is statically expressed in terms of average. When the mixture of analogues is classified into the following three classes, it has been found that a specific mixture is particularly preferred. That is, the mixture of analogues of the phthalocyanine-based pigment represented by the general formula (C-I) or (C-II) is classified into the following three classes and defined on.

(1) β-Position Substitution Type:

(Phthalocyanine-based pigment having specific substituents at the 2- and/or 3-position, 6- and/or 7-position, 10- and/or 11-position, and 14- and/or 15-position)

(2) α-Position Substitution Type:

(Phthalocyanine-based pigment having specific substituents at the 1- and/or 4-position, 5- and/or 8-position, 9- and/or 12-position, and 13- and/or 16-position)

(3) α,β-Positions-Mixed Substitution Type:

(Phthalocyanine-based pigment having specific substituents without regularity at the 1- to 16-positions)

In the present invention, in the case where the phthalocyanine-based pigment derivatives having a different structure (particularly with respect to the substitution position) are described, the foregoing α-position substitution type, β-position substitution type, and α,β-positions-mixed substitution type will be used.

The phthalocyanine compound represented by the general formula (C-I) of the present invention can be synthesized by the methods as described in, for example, Shirai and Kogayashi, Phtalocyanines—Chemistry and Functions, pp. 1-62, by IPC and C. C. Leznoff and A. B. P. Lever, Phthalocyanines—Properties and Applications, pp. 1-5 by VCH, or cited documents therein or analogous methods thereof.

The phthalocyanine compound represented by the general formula (C-I) of the present invention can be synthesized through, for example, sulfonation, sulfonyl chlorination and amidation of an unsubstituted phthalocyanine compound as described in WO 00/17275, WO 00/08103, WO 00/08101, WO 98/41853, and JP-A-10-36471. In this case, not only the sulfonation can occur at any position on the phthalocyanine nucleus, but also it is difficult to control the number of positions to be sulfonated. Accordingly, in the case where the sulfo group is introduced under such reaction conditions, it is impossible to specify the positions and number of the sulfo groups as introduced into the product, so that a mixture of products having the different number and substitution positions of the substituents is always given. Thus, when the compound of the present invention is synthesized using this product as a starting material, it is impossible to specify the number and substitution positions of the sulfamoyl group to be substituted on the heterocyclic ring, so that the compound of the present invention is obtained as the α,β-positions-mixed substitution type mixture contains some kinds of compounds having the different number and substitution positions of the substituents.

As described above, for example, when many electron-withdrawing groups such as a sulfamoyl group are introduced into the phthalocyanine nucleus, the oxidation potential becomes more positive, whereby the ozone resistance is enhanced. According to the foregoing synthesis, the number of the electron-withdrawing groups to be introduced is small. That is, it is inevitable that the phthalocyanine pigment having a more negative oxidation potential is mingled. Accordingly, in order to enhance the ozone resistance, it is preferred to employ the synthesis upon which the formation of a compound having a more negative oxidation potential is depressed.

On the other hand, the phthalocyanine compound represented by the general formula (C-II) of the present invention can be derived from a compound obtained by reacting a phthalonitrile derivative represented by the following general formula (compound P) and/or a diiminoisoindoline derivative represented by the following general formula (compound Q) with a metal derivative represented by the following general formula (C-M).

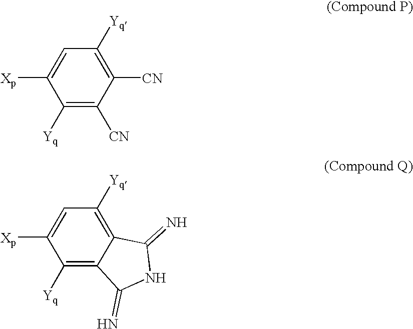

In the general formulae, p is from 11 to 14, and q and q′ are each from 11 to 18.
M-(Y)_{d} (C-M)

In the general formula (C-M), M is the same as M in the foregoing general formulae (C-I) and (C-II); Y represents a monovalent or divalent ligand such as a halogen atom, an acetic acid anion, and acetylacetonate; and d represents an integer of from 1 to 4.

That is, according to the foregoing synthesis, it is possible to introduce a specified number of the desired substituent. In particular, in the case where many electron-withdrawing groups are introduced in order to increase the oxidation potential as in the present invention, the foregoing synthesis is extremely superior as compared with the synthesis of the general formula (C-I).

The thus obtained phthalocyanine compound represented by the general formula (C-II) is usually of a β-position substitution type of a mixture of compounds represented by the following general formulae (a)-1 to (a)-4, which are isomers at the respective positions of Xₚ in the case of Y_{q}=Y_{q′}=H.

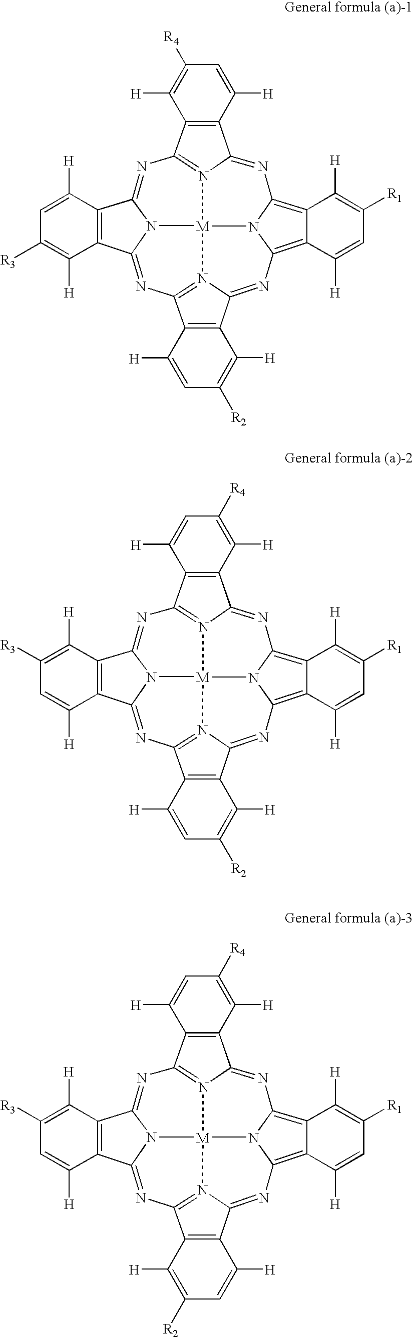

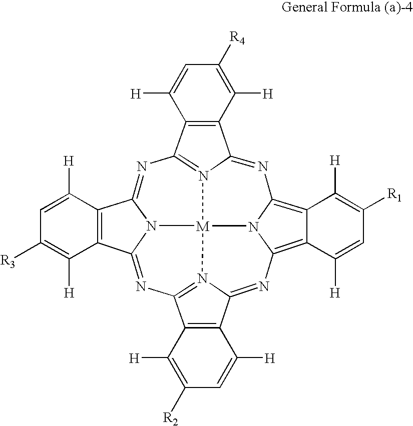

In the foregoing synthesis, when Xₚs′ are all the same, a β-position substitution type phthalocyanine dye of the general formula (C-II) wherein all of X¹¹, X¹², X¹³, and X¹⁴ are the same substituent can be obtained. On the other hand, when Xₚs′ are different, it is possible to synthesize a dye having the same kind of substituents that are, however, partially different from each other or a dye having different kinds of substituents. Among the compounds represented by the general formula (C-II), dyes having different electron-withdrawing substituents are particularly preferred because the dye dissolution and association properties and the lapsing stability of the ink can be adjusted.

In the present invention, in any of the substitution types, it is very important for enhancing the fastness properties that the oxidation potential is more positive than 1.0 V (vs SCE). Especially, the β-position substitution type tended to be explicitly superior to the α,β-positions-mixed substitution type in the hue, lightfastness and resistance to ozone gas.

Specific examples of the phthalocyanine-based pigments represented by the general formulae (C-I) and (C-II) will be given below, but it should not be construed that the present invention is limited thereto.

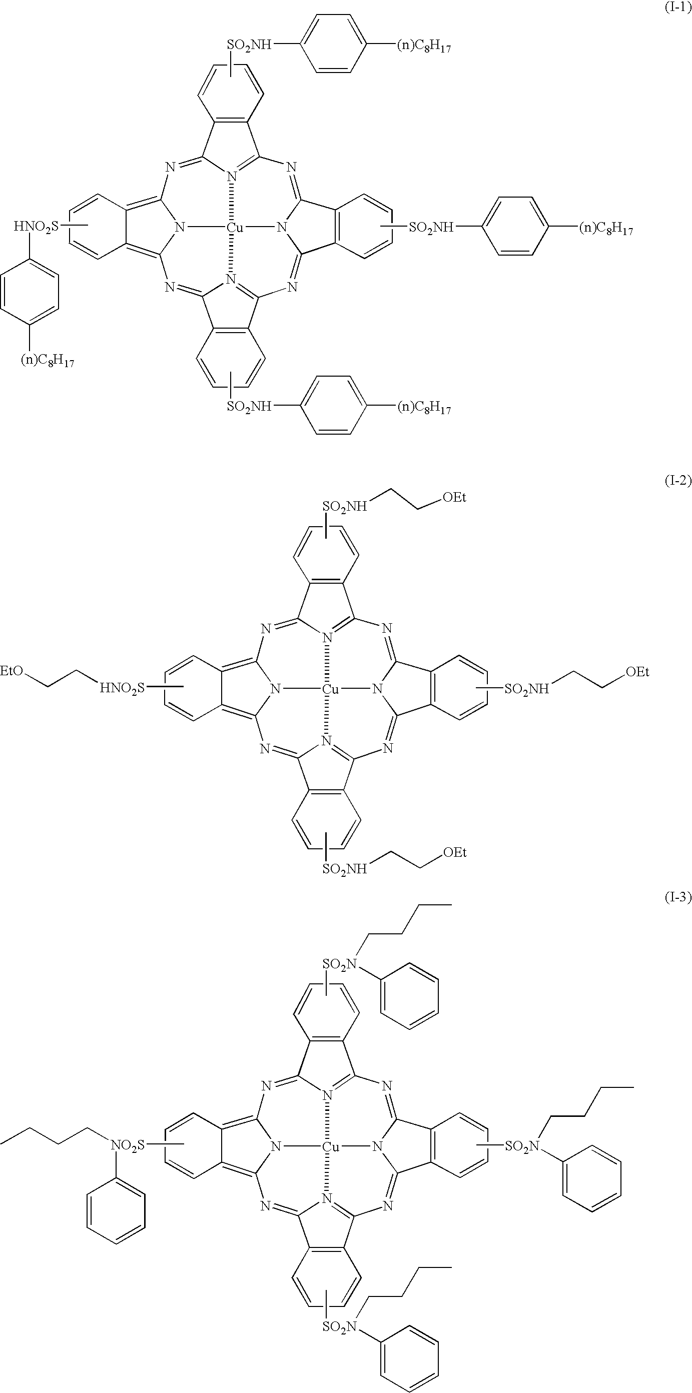

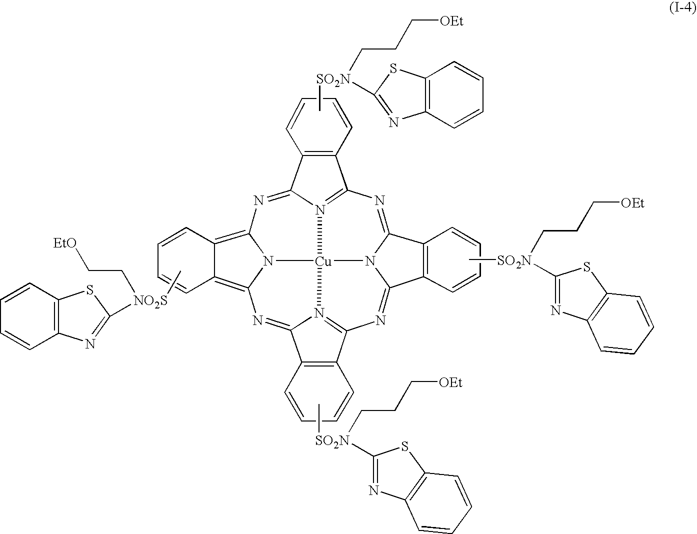

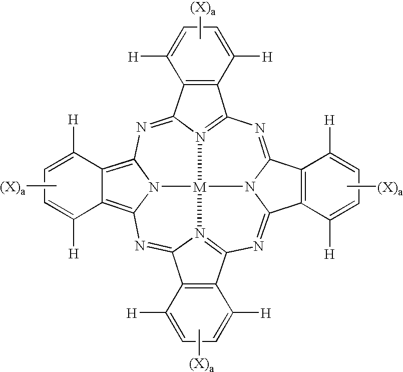

| Compound No. | M | X | a |
|---|---|---|---|
| AII-1 | Cu | 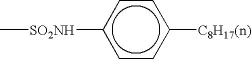 | 1 |
| AII-2 | Cu | 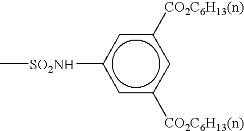 | 1 |
| AII-3 | Cu | 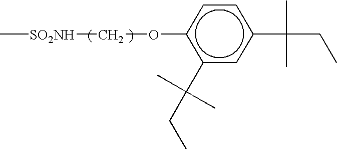 | 1 |
| AII-4 | Cu | 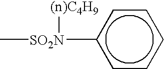 | 1 |
| AII-5 | Cu | 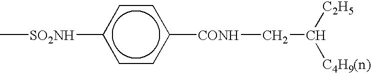 | 1 |
| AII-6 | Cu | 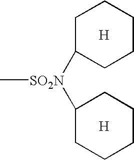 | 1 |
| AII-7 | Cu | 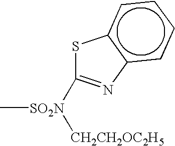 | 1 |
| AII-8 | Cu | —SO₂N(CH₂CH₂OC₂H₅)₂ | 1 |
| AII-9 | Cu | 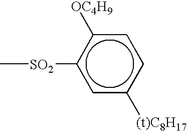 | 1 |
| AII-10 | Cu | 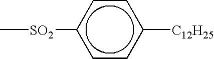 | 1 |
| AII-11 | Cu | —SO₂—CH₂CO₂C₂H₅ | 1 |
| AII-12 | Cu | 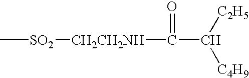 | 1 |
| AII-13 | Cu | —SO₂—CH₂CH₂CO₂C₆H₁₃(n) | 1 |
| AII-14 | Cu | —SO₂—C₄H₉(n) | 2 |
| AII-15 | Cu | 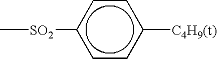 | 1 |
| AII-16 | Cu | 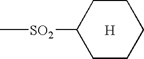 | 1 |
| AII-17 | Cu | 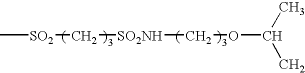 | 1 |
| AII-18 | Cu | 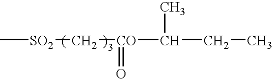 | 1 |
| AII-19 | Cu | 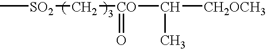 | 1 |
| AII-20 | Cu | 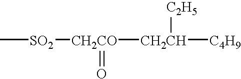 | 1 |
| AII-21 | Cu | 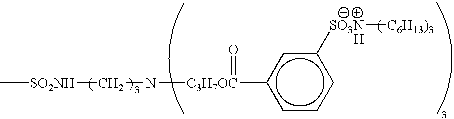 | 1 |
| AII-22 | Cu | 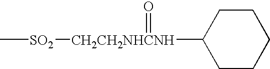 | 1 |
| AII-23 | Cu | 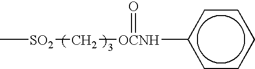 | 1 |

In the table, specific examples of each of combinations of (Y₁₁, Y₁₂), (Y₁₃, Y₁₄), (Y₁₅, Y₁₆) and (Y₁₇, Y₁₈) are independently not in order.

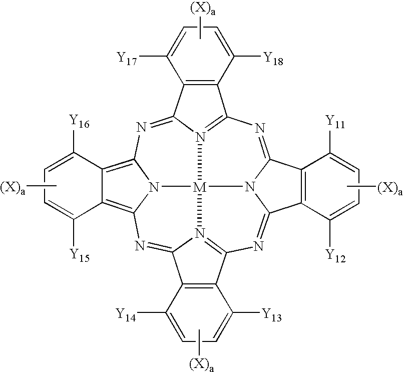

| Compound No. | M | X | Y₁₁, Y₁₂ | Y₁₃, Y₁₄ | Y₁₅, Y₁₆ | Y₁₇, Y₁₈ | a |
|---|---|---|---|---|---|---|---|
| AII-24 | Cu | 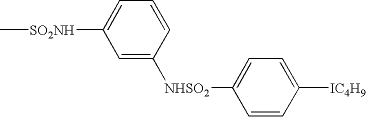 | H, Cl | H, Cl | H, Cl | H, Cl | 1 |
| AII-25 | Cu | 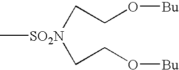 | H, Cl | H, Cl | H, Cl | H, Cl | 1 |
| AII-26 | Cu | 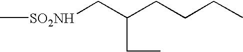 | H, Cl | H, Cl | H, Cl | H, Cl | 1 |
| AII-27 | Cu | 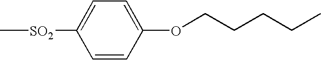 | Cl, Cl | Cl, Cl | Cl, Cl | Cl, Cl | 1 |
| AII-28 | Cu | 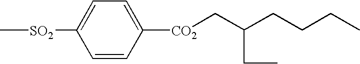 | H, Cl | H, Cl | H, Cl | H, Cl | 1 |

In the table, specific examples of each of combinations of (X₁, X₂), (Y₁₁, Y₁₂), (Y₁₃, Y₁₄), (Y₁₅, Y₁₆) and (Y₁₇, Y₁₈) are independently not in order.

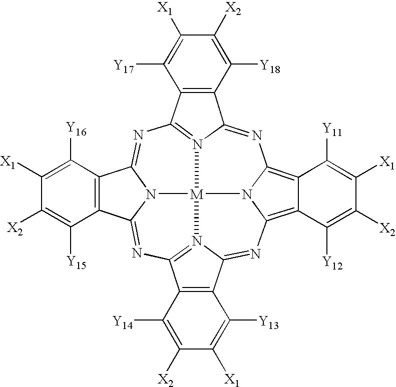

| Com- | | | | | | | |
|---|---|---|---|---|---|---|---|
| pound | | | | | | | |
| No. | M | X1 | X2 | Y11, Y12 | Y13, Y14 | Y15, Y16 | Y17, Y18 |
| II-1 | Cu | —SO₂—NH—C₈H₁₇(t) | —H | —H, —H | —H, —H | —H, —H | —H, —H |
| II-2 | Cu | 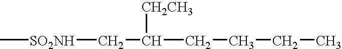 | —H | —H, —H | —H, —H | —H, —H | —H, —H |
| II-3 | Cu | 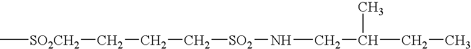 | —H | —H, —H | —H, —H | —H, —H | —H, —H |
| II-4 | Cu | 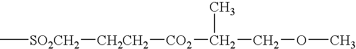 | —H | —H, —H | —H, —H | —H, —H | —H, —H |
| II-5 | Cu | —SO₂CH₂—CH₂CH₂SO₂—NH—(CH₃)₂O—Pr(i) | —H | —H, —H | —H, —H | —H, —H | —H, —H |
| II-6 | Zn | 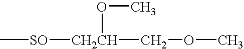 | —CN | —H, —H | —H, —H | —H, —H | —H, —H |
| II-7 | Cu | 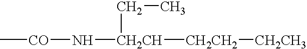 | —H | —Cl, —H | —Cl, —H | —Cl, —H | —Cl, —H |
| II-8 | Cu | 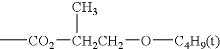 | —H | —H, —H | —H, —H | —H, —H | —H, —H |
| II-9 | Cu | —SO₂—CH₂CH₂SO₂NH—(CH₃)₂O-Pr(i) | —H | —H, —H | —H, —H | —H, —H | —H, —H |

In the table, specific examples of each of combinations of (X₁, X₂), (Y₁₁, Y₁₂), (Y₁₃, Y₁₄), (Y₁₅, Y₁₆) and (Y₁₇, Y₁₈) are independently not in order.

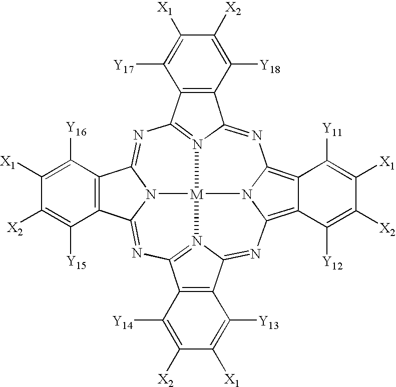

| Com- | | | | | | | |
|---|---|---|---|---|---|---|---|
| pound | | | | | | | |
| No. | M | X1 | X2 | Y11, Y12 | Y13, Y14 | Y15, Y16 | Y17, Y18 |
| II-10 | Cu | 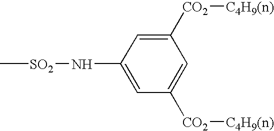 | —H | —H, —H | —H, —H | —H, —H | —H, —H |
| II-11 | Cu | 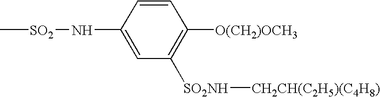 | —H | —H, —H | —H, —H | —H, —H | —H, —H |
| II-12 | Cu | 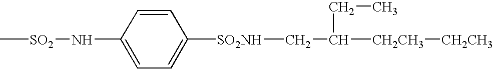 | —H | —H, —H | —H, —H | —H, —H | —H, —H |
| II-13 | Cu | —SO₂CH₂CH₂COOC₆H₁₃ | —H | —H, —H | —H, —H | —H, —H | —H, —H |

M-P_{c}(R₁)ₘ(R₂)ₙ: In the table, the respective substituents R₁ and R₂ are within a β-position substitution type, and the order of the introduction positions are not in order.

| Compound No. | M | R₁ | n |
|---|---|---|---|
| II-14 | Cu | 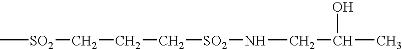 | 3 |
| II-15 | Cu | —SO₂—CH₂—CH₂—O—CH₂CH₂—OCH₃ | 3 |
| II-16 | Cu | —SO₂—CH₂—CH₂—O—CH₂CH₂—O—CH₂CH₂—OH | 3 |
| II-17 | Cu | 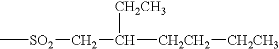 | 2 |
| II-18 | Cu | 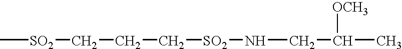 | 3 |
| II-19 | Cu | 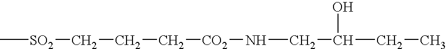 | 3 |
| II-20 | Cu | 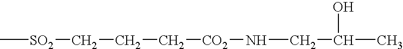 | 2.5 |
| II-21 | Cu | 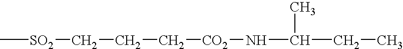 | 2 |
| II-22 | Cu | 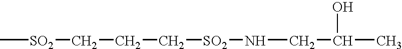 | 3 |
| II-23 | Cu | 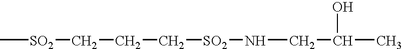 | 3 |
| II-24 | Cu | 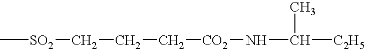 | 3 |
| II-25 | Cu | —SO₂—CH₂—CH₂—CH₂—SO₂NH—CH—(CH₃)₂ | 3 |
| II-26 | Cu | 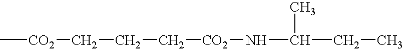 | 3 |
| II-27 | Cu | —CO—NH—CH₂—CH₂—SO₂NH—CH—(CH₃)₂ | 3 |
| II-28 | Cu | 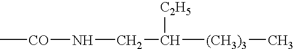 | 3 |

| Compound No. | M | R₁ | n |
|---|---|---|---|
| II-14 | Cu | 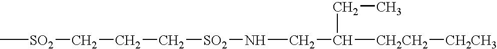 | 1 |
| II-15 | Cu | 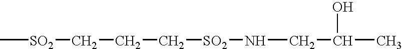 | 1 |
| II-16 | Cu | 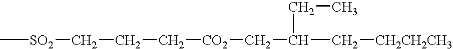 | 1 |
| II-17 | Cu | 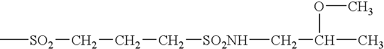 | 2 |
| II-18 | Cu | —SO₂—NH—CH₂—CH₂—SO₂NH—CH₂CH₂—O—CH₂CH₂OH | 1 |
| II-19 | Cu | 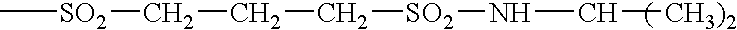 | 1 |
| II-20 | Cu | 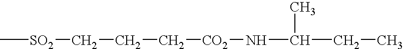 | 1.5 |
| II-21 | Cu | —SO₂—CH₂—CH₂—CH₂—SO₂—NH—(CH₂)₃—CH₂—O—CH₂CH₂—OH | 2 |
| II-22 | Cu | —SO₂—CH₂—CH₂—CH₂—O—CH₂—CH₂—O—CH₃ | 1 |
| II-23 | Cu | —SO₂—CH₂—CH₂—CH₂—O—CH₂—CH₂—O—CH₂CH₂—O—CH₃ | 1 |
| II-24 | Cu | —SO₂—CH₂—CH₂—CH₂—O—CH₂—CH₂—O—CH₂CH₂—OH | 1 |
| II-25 | Cu | 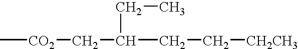 | 1 |
| II-26 | Cu | —CO—CH₂—CH₂—O—CH₂—CH₂—O—CH₃ | 1 |
| II-27 | Cu | 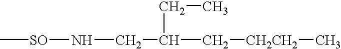 | 1 |
| II-28 | Cu | —CO—NH—CH₂—CH₂—O—CH₂—CH₂—O—CH₃ | 1 |

The phthalocyanine pigment represented by the general formula (C-I) can be synthesized by referring to the patents as cited above. Further, the phthalocyanine pigment represented by the general formula (C-II) can be synthesized by the methods as described in JP-A-2002-302623, JP-A-2002-294097, JP-A-2002-256167 and JP-A-2002-249677. Moreover, the raw substances, pigment intermediates and synthesis routes are not limited thereto.

The compound represented by the general formula (Y-I) of the present invention will be described below in detail.
A-N═N-B (Y-I)

In the general formula (Y-I), A and B each independently represents an optionally substituted heterocyclic group. As the heterocyclic ring, a heterocyclic ring constituted of a 5-membered ring or a 6-membered ring is preferred. The heterocyclic ring may be of a monocyclic structure or a polycyclic structure in which two or more rings are condensed, and may be an aromatic heterocyclic ring or a non-aromatic heterocyclic ring. As the hetero atom constituting the heterocyclic ring are preferable a nitrogen atom, an oxygen atom, and a sulfur atom.

As the heterocyclic ring represented by A are preferable 5-pyrazolone, pyrazole, oxazolone, isoxazolone, barbituric acid, pyridone, rhodanine, pyrazolidinedione, pyrazolopyridone, Meldrum's acid, and condensed heterocyclic rings of the foregoing heterocyclic rings with a hydrocarbon aromatic ring or a heterocyclic ring. Of these are more preferable 5-pyrazolone, 5-aminopyrazole, pyridone, and pyrazoloazole, with 5-aminopyrazole, 2-hydroxy-6-pyridone, and pyrazolotriazole being particularly preferred.

As the heterocyclic ring represented by B are suitable pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, isoxazole, benzoxazole, thiazole, benzothiazole, isothiazole, benzoisothiazole, thiadiazole, benzoisoxazole, pyrrolidine, piperidine, piperazine, imidazoline, and thiazoline. Of these, pyridine, quinoline, thiophene, benzothiophene, pyrazole, imidazole, benzimidazole, triazole, oxazole, isoxazole, benzoxazole, thiazole, benzothiazole, isothiazole, benzoisothiazole, thiadiazole, and benzoisoxazole are preferable; quinoline, thiophene, pyrazole, thiazole, benzoxazole, benzoisoxazole, isothiazole, imidazole, benzothiazole, and thiadiazole are more preferable; and pyrazole, benzothiazole, benzoxazole, imidazole, 1,2,4-thiadiazole, and 1,3,4-thiadiazole are most preferable.

Examples of the substituent that is substituted on A and B include a halogen atom, an alkyl group, a cycloalkyl group, an aralkyl group, an alkenyl group, an alkynyl group, an aryl group, a heterocyclic group, a cyano group, a hydroxyl group, a nitro group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkyl- or arylsulfonylamino group, a mercapto group, an alkylthio group, an arylthio, group, a heterocyclic thio group, a sulfamoyl group, an alkyl- or arylsulfinyl group, an alkyl- or arylsufonyl group, an acyl group, an aryloxycarbonyl group, an alkoxycarbonyl group, a carbamoyl group, an imido group, a phosphino group, a phosphinyl group, a phosphinyloxy group, a phosphinylamino group, and a silyl group.

Among the dyes represented by the general formula (Y-1) are more preferable dyes represented by the following general formulae (Y-II), (Y-III) and (Y-IV).

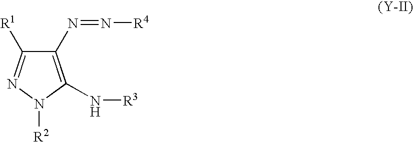

In the general formula (Y-II), R¹ and R³ each represents a hydrogen atom, a cyano group, an alkyl group, a cycloalkyl group, an aralkyl group, an alkoxy group, an alkylthio group, an arylthio group, an aryl group, or an ionic hydrophilic group; R² represents a hydrogen atom, an alkyl group, a cycloalkyl group, an aralkyl group, a carbamoyl group, an acyl group, an aryl group, or a heterocyclic group; and R⁴ represents a heterocyclic group.

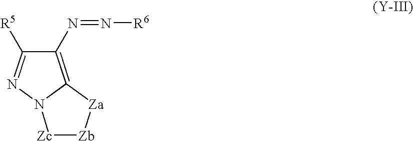

In the general formula (Y-III), R⁵ represents a hydrogen atom, a cyano group, an alkyl group, a cycloalkyl group, an aralkyl group, an alkoxy group, an alkylthio group, an arylthio group, an aryl group, or an ionic hydrophilic group; Za represents —N═, —NH—, or C(R¹¹)═; Za and Zc each independently represents —N═ or C(R¹¹)═; R¹¹, represents a hydrogen atom or a non-metallic substituent; and R⁶ represents a heterocyclic group.

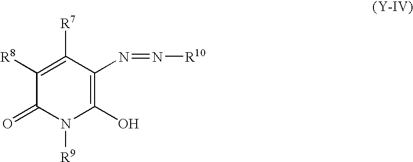

In the general formula (Y-IV), R⁷ and R⁹ each represents a hydrogen atom, a cyano group, an alkyl group, a cycloalkyl group, an aralkyl group, an aryl group, an alkylthio group, an arylthio group, an alkoxycarbonyl group, a carbamoyl group, or an ionic hydrophilic group; R⁸ represents a hydrogen atom, a halogen atom, an alkyl group, an alkoxy group, an aryl group, an aryloxy group, a cyano group, an acylamino group, a sulfonylamino group, an alkoxycarbonylamino group, a ureido group, an alkylthio group, an arylthio group, an alkoxycarbonyl group, a carbamoyl group, a sulfamoyl group, a sulfonyl group, an acyl group, an alkylamino group, an arylamino group, a hydroxyl group, or an ionic hydrophilic group; and R¹⁰ represents a heterocyclic group.

In the general formula (Y-II), R¹ and R³ each represents a hydrogen atom, a cyano group, an alkyl group, a cycloalkyl group, an aralkyl group, an alkoxy group, an alkylthio group, an arylthio group, an aryl group, or an ionic hydrophilic group; R² represents a hydrogen atom, an alkyl group, a cycloalkyl group, an aralkyl group, a carbamoyl group, an acyl group, an aryl group, or a heterocyclic group; and R⁴ represents a heterocyclic group.

In the general formula (Y-III), R⁵ represents a hydrogen atom, a cyano group, an alkyl group, a cycloalkyl group, an aralkyl group, an alkoxy group, an alkylthio group, an arylthio group, an aryl group, or an ionic hydrophilic group; Za represents —N═, —NH—, or C(R¹¹)═; Za and Zc each independently represents —N═ or C(R¹¹)═; R¹¹ represents a hydrogen atom or a non-metallic substituent; and R⁶ represents a heterocyclic group.

In the general formula (Y-IV), R⁷ and R⁹ each represents a hydrogen atom, a cyano group, an alkyl group, a cycloalkyl group, an aralkyl group, an aryl group, an alkylthio group, an arylthio group, an alkoxycarbonyl group, a carbamoyl group, or an ionic hydrophilic group; R⁸ represents a hydrogen atom, a halogen atom, an alkyl group, an alkoxy group, an aryl group, an aryloxy group, a cyano group, an acylamino group, a sulfonylaimino group, an alkoxycarbonylamino group, a ureido group, an alkylthio group, an arylthio group, an alkoxycarbonyl group, a carbamoyl group, a sulfamoyl group, a sulfonyl group, an acyl group, an alkylamino group, an arylamino group, a hydroxyl group, or an ionic hydrophilic group; and R¹⁰ represents a heterocyclic group.

The substituents represented by R¹, R², R³, R⁵, R⁷, R⁸, and R⁹ in the general formulae (Y-II), (Y-III) and (Y-IV) will be described below in detail.

The alkyl group represented by R¹, R², R³, R⁵, R⁷, R⁸, and R⁹ includes a substituted alkyl group and an unsubstituted alkyl group.

As the alkyl group is preferable an alkyl group having from 1 to 20 carbon atoms. Examples of the substituent include a hydroxyl group, an alkoxy group, a cyano group, a halogen atom, and an ionic hydrophilic group.

Suitable examples of the alkyl group include methyl, ethyl, butyl, isopropyl, t-butyl, hydroxyethyl, methoxyethyl, cyanoethyl, trifluoromethyl, 3-sulfopropyl, and 4-sulfobutyl.

The cycloalkyl group represented by R¹, R², R³, R⁵, R⁷, R⁸, and R⁹ includes a substituted cycloalkyl group and an unsubstituted cycloalkyl group.

As the cycloalkyl group is preferable a cycloalkyl group having from 5 to 12 carbon atoms. Examples of the substituent include an ionic hydrophilic group.

Suitable examples of the cycloalkyl group include cyclohexyl.

The aralkyl group represented by R¹, R², R³, R⁵, R⁷, R⁸, and R⁹ includes a substituted aralkyl group and an unsubstituted aralkyl group.

As the aralkyl group is preferable an aralkyl group having from 7 to 20 carbon atoms. Examples of the substituent include an ionic hydrophilic group.

Suitable examples of the aralkyl group include benzyl and 2-phenethyl.

The aryl group represented by R¹, R², R³; R⁵, R⁷, R⁸, and R⁹ includes a substituted aryl group and an unsubstituted aryl group.

As the aryl group is preferable an aryl group having from 6 to 20 carbon atoms. Examples of the substituent include an alkyl group, an alkoxy group, a halogen atom, an alkylamino group, and an ionic hydrophilic group.

Suitable examples of the aryl group include phenyl, p-tolyl, p-methoxyphenyl, o-chlorophenyl, and m-(3-sulfopropylamino)phenyl.

The alkylthio group represented by R¹, R², R³, R⁵, R⁷, R⁹, and R⁹ includes a substituted alkylthio group and an unsubstituted alkylthio group.

As the alkylthio group is preferable an alkylthio group having from 1 to 20 carbon atoms. Examples of the substituent include an ionic hydrophilic group.

Suitable examples of the alkylthio group include methylthio and ethylthio.

The arylthio group represented by R¹, R², R³, R⁵, R⁷, R⁸, and R⁹ includes a substituted arylthio group and an unsubstituted arylthio group.

As the arylthio group is preferable an arylthio group having from 6 to 20 carbon atoms. Examples of the-substituent include an alkyl group and an ionic hydrophilic group.

Suitable examples of the arylthio group include phenylthio and p-tolylthio.

As the heterocyclic group represented by R² is preferable a 5-membered or 6-membered heterocyclic ring. The heterocyclic ring may further be condensed. As the hetero atom constituting the heterocyclic ring are preferable a nitrogen atom, a sulfur atom, and an oxygen atom. Further, the heterocyclic ring may be an aromatic heterocyclic ring or a non-aromatic heterocyclic ring. The heterocyclic ring may further be substituted. Examples of the substituent are suitably the same substituents enumerated later for the aryl group. As the heterocyclic ring are enumerated 6-membered nitrogen-containing aromatic heterocyclic rings, with triazine, pyrimidine, and phthalazine being particularly preferred.

As the halogen atom represented by R⁸ are suitably enumerated a fluorine atom, a chlorine atom, and a bromine atom.

The alkoxy group represented by R¹, R³, R⁵, and R⁸ includes a substituted alkoxy group and an unsubstituted alkoxy group.

As the alkoxy group is preferable an alkoxy group having from 1 to-20 carbon atoms. Examples of the substituent include a hydroxyl group and an ionic hydrophilic group.

Suitable examples of the alkoxy group include methoxy, ethoxy, isopropoxy, methoxyethoxy, hydroxyethoxy, and 3-carboxypropoxy.

The aryloxy group represented by R⁸ includes a substituted aryloxy group and an unsubstituted aryloxy group.

As the aryloxy group is preferable an aryloxy group having from 6 to 20 carbon atoms. Examples of the substituent include an alkoxy group and an ionic hydrophilic group.

Suitable examples of the aryloxy group include phenoxy, p-methoxyphenoxy, and o-methoxyphenoxy.

The acylamino group represented by R⁸ includes a substituted acylamino group and an unsubstituted acylamino group.

As the acylamino group is preferable an acylamino group having from 2 to 20 carbon atoms. Examples of the substituent include an ionic hydrophilic group.

Suitable examples of the acylamino group include acetamide, propionamide, benzamide, and 3,5-disulfobenzamide.

The sulfonylamino group represented by R⁸ includes a substituted sulfonylamino group and an unsubstituted sulfonylamino group.

As the sulfonylamino group is preferable a sulfonylamino group having from 1 to 20 carbon atoms.

Suitable examples of the sulfonylamino group include methylsulfonylamino and ethylsulfonylamino.

The alkoxycarbonylamio group represented by R⁸ includes a substituted alkoxycarbonylamino group and an unsubstituted alkoxycarbonylamino group.

As the alkoxycarbonylamino group is preferable an alkoxycarbonylamino group having from 2 to 20 carbon atoms. Examples of the substituent include an ionic hydrophilic group.

Suitable examples of the alkoxycarbonylamino group include ethoxycarbonylamino.

The ureido group represented by R⁸ includes a substituted ureido group and an unsubstituted ureido group.

As the ureido group is preferable a ureido group having from 1 to 20 carbon atoms.

Examples of the substituent include an alkyl group and an aryl group.

Suitable examples of the ureido group include 3-methylureido, 3,3-dimethylureido, and 3-phenylureido.

The alkoxycarbonyl group represented by R⁷, R⁸, and R⁹ includes a substituted alkoxycarbonyl group and an unsubstituted alkoxycarbonyl group.

As the alkoxycarbonyl group is preferable an alkoxycarbonyl group having from 2 to 20 carbon atoms. Examples of the substituent include an ionic hydrophilic group.

Suitable examples of the alkoxycarbonyl include methoxycarbonyl and ethoxycarbonyl.

The carbamoyl group represented by R², R⁷, R⁸, and R⁹ includes a substituted carbamoyl group and an unsubstituted carbamoyl group. Examples of the substituent include an alkyl group.

Suitable examples of the carbamoyl group include a methylcarbamoyl group and a dimethylcarbamoyl group.

The sulfamoyl group represented by R⁸ includes a substituted sulfamoyl group and an unsubstituted sulfamoyl group. Examples of the substituent include an alkyl group.

Suitable examples of the sulfamoyl group include a dimethylsulfamoyl group and a di-(2-hydroxyethyl)sulfamoyl group.

Suitable examples of the sulfonyl group represented by R⁸ include methanesulfonyl and phenylsulfonyl.

The acyl group represented by R² and R⁸ includes a substituted acyl group and an unsubstituted acyl group. As the acyl group is preferable an acyl group having from 1 to 20 carbon atoms. Examples of the substituent include an ionic hydrophilic group.

Suitable examples of the acyl group include acetyl and benzoyl.

The amino group represented by R⁸ includes a substituted amino group and an unsubstituted amino group. Examples of the substituent include an alkyl group, an aryl group, and a heterocyclic group.

Suitable examples of the amino group include methylamino, diethylamino, anilino, and 2-chloroanilino.

The heterocyclic group represented by R⁴, R⁶, and R¹⁰ is the same as the optionally substituted heterocyclic group represented by B in the general formula (Y-I), and its preferred examples, more preferred examples and most preferred examples are also the same.

Examples of the substituent include an ionic hydrophilic group, an alkyl group having from 1 to 12 carbon atoms, an aryl group, an alkyl- or arylthio group, a halogen atom, a cyano group, a sulfamoyl group, an sulfonamino group, a carbamoyl group, and an acylamino group. Each of the alkyl group and the aryl group may further have a substituent.

In the general formula (Y-III), Za represents —N═, —NH—, or C(R¹¹)═; Za and Zc each independently represents —N═ or C(R¹¹)═; R¹¹ represents a hydrogen atom or a non-metallic substituent. As the non-metallic substituent represented by R¹¹ are preferable a cyano group, a cycloalkyl group, an aralkyl group, an aryl group, an alkythio group, an arylthio group, and an ionic hydrophilic group. Each of the substituents is synonymous with each of the substituents represented by R¹, and preferred examples thereof are also the same. Examples of a skeleton (i.e., a basic structure) comprising two 5-membered rings, which is included in the general formula (Y-III), are given below.

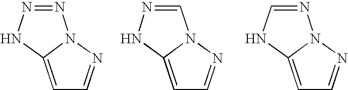

In the case where each of the foregoing substituents may further have a substituent, examples of the substituent include the substituents that may be substituted on the heterocyclic rings A and B of the general formula (Y-I).

Specific examples of the dye represented by the general formula (Y-I) (Y-101 to Y-160) will be given below, but it should not be construed that the present invention is limited thereto. These compounds can be synthesized by referring to JP-A-2-24191 and JP-A-2001-279145.

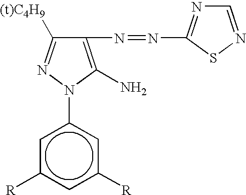

| Dye | R |
|---|---|
| Y-101 | CON(C₂H₅)₂ |
| Y-102 | CON(C₆H₉)₂ |
| Y-103 | CON(C₆H₁₃)₂ |
| Y-104 | COOC₄H₉ |
| Y-105 | COOC₆H₁₃ |
| Y-106 | COC₄H₉ |
| Y-107 | CONHC₄H₉ |
| Y-108 | CONHC₆H₁₃ |
| Y-109 | COOC₄H₉ |
| Y-110 | CONHC₄H₉ |
| Y-111 | CON(C₄H₉)₂ |
| Y-112 | SO₂NHC₆H₁₃ |
| Y-113 | SO₂N(C₄H₉)₂ |
| Y-114 | NHCOC₆H₁₃ |
| Y-115 | NHSO₂C₈H₁₇ |
| Y-116 | C₄H₉ |
| Y-117 | OC₆H₁₃ |
| Y-118 | COOC₁₂H₂₅ |
| Y-119 | 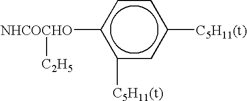 |
| Y-120 | 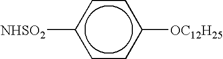 |

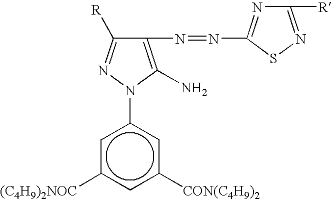

| Dye | R | R′ |
|---|---|---|
| Y-121 | CH₃ | H |
| Y-122 | Ph | H |
| Y-123 | OC₂H₅ | H |
| Y-124 | C₄H₉(t) | SCH₃ |
| Y-125 | C₄H₉(t) | Ph |
| Y-126 | C₄H₉(t) | CH₃ |
| Y-127 | C₄H₉(t) | SC₈H₁₇ |

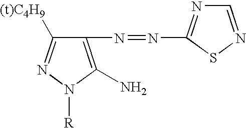

| Dye | R |
|---|---|
| Y-128 | CH₂Ph |
| Y-129 | C₄H₉ |
| Y-130 | C₈H₁₇ |
| Y-131 | CONH₂ |

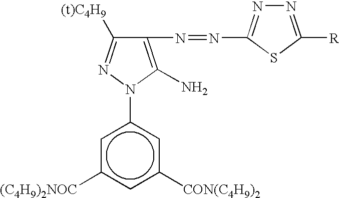

| Dye | R |
|---|---|
| Y-132 | H |
| Y-133 | CH₃ |
| Y-134 | Ph |
| Y-135 | SCH₃ |

Y-136

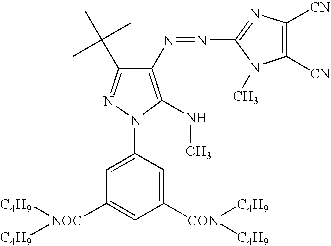

Y-137

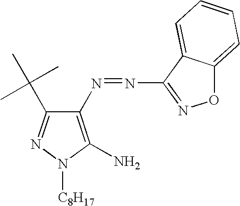

Y-138

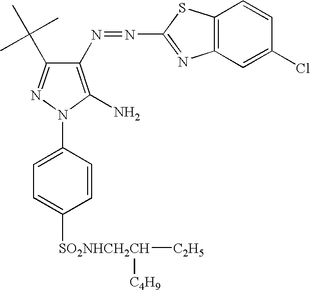

Y-139

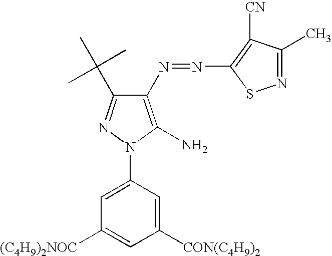

Y-140

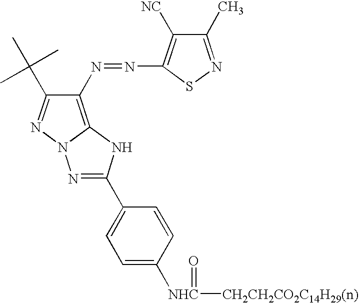

Y-141

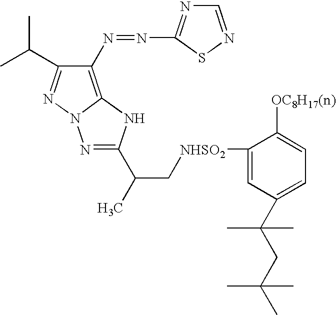

Y-142

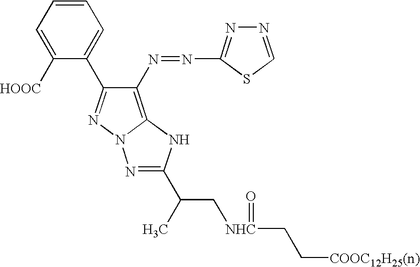

Y-143

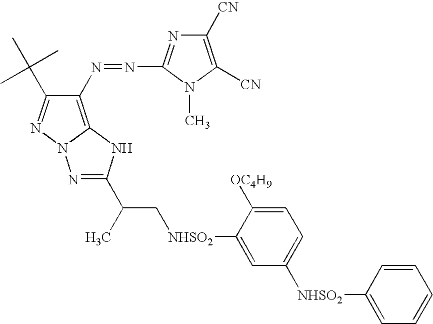

Y-144

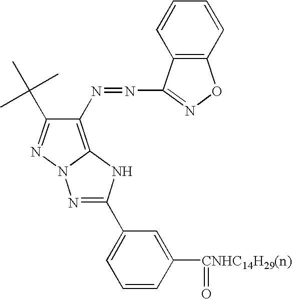

Y-145

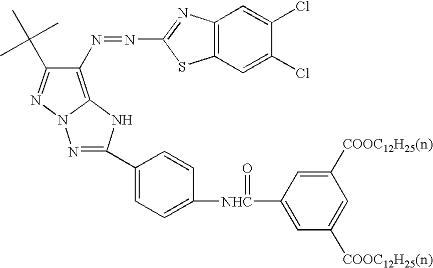

Y-146

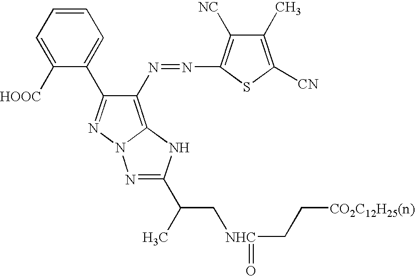

Y-147

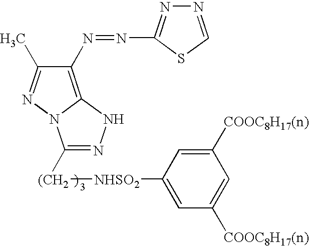

Y-148

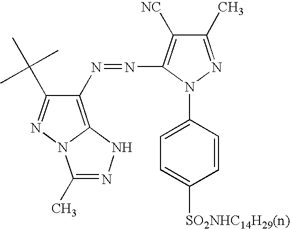

Y-149

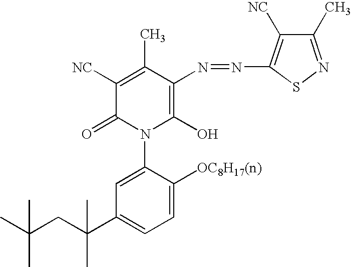

Y-150

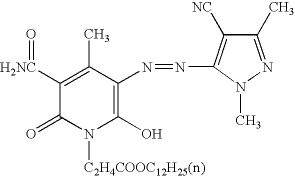

Y-151

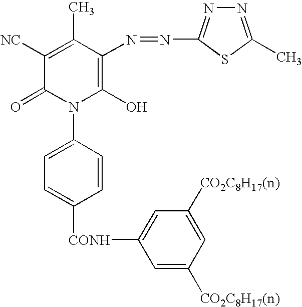

Y-152

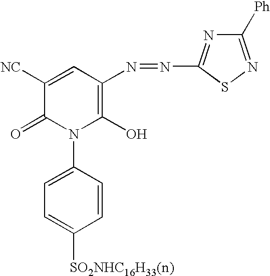

Y-153

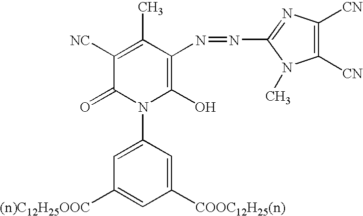

Y-154

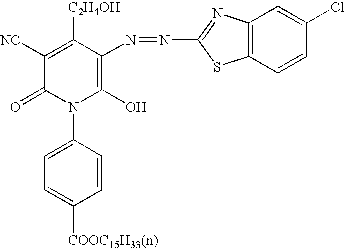

Y-155

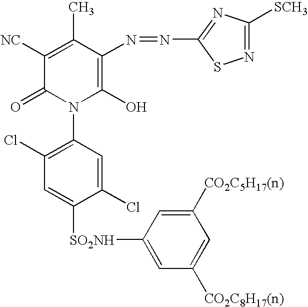

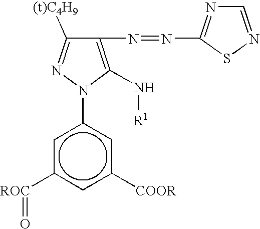

| | | |
|---|---|---|
| Dye | R | R¹ |
| Y-156 | —C₁₆H₃₃ | C₄H₉ |
| Y-157 | —C₁₆H₃₃ | C₂H₅ |
| Y-158 | —C₁₄H₃₇ | H |
| Y-159 | —C₁₈H₃₇ | H |
| Y-160 | 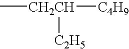 | CH₃ |

While it is essential that the oil-soluble dye is dissolved in the monomer, it is also important that no crystal deposits with a lapse of time. In general, it is said to be better that a solubility parameter (hereinafter referred to as “SP value”) of a monomer is closed to the SP value of an oil-soluble dye. However, since a portion relying on the structures of a molecule to be dissolved (the oil-soluble dye in the present invention) and a solvent (the monomer in the present invention) is present, there may be the case where interpretation cannot be made only in terms of the SP value. In the case of the oil-soluble dyes represented by the general formulae (Y-I), (Y-II), (Y-III), and (Y-IV), it has been found that the solubility and storage stability with time are made superior by using the two physical properties of the molar volume V value and the SP value.

The SP value is preferably from 26 to 21, more preferably from 25 to 21, further preferably from 24 to 21, and most preferably 24 to 22. The V value is preferably from 810 to 270, more preferably from 800 to 300, further preferably from 750 to 350, and most preferably from 700 to 380.

Here, the V value (cm³/mole) and SP value (J^{0.5}/cm^{1.5}) are values calculated by the Fedors method. The calculation method is described in Polym. Eng. Sci., Vol. 14, pp. 147 (1974).

In the present invention, the oil-soluble dye represented by the general formula (M-I), (C-I) or (Y-I) may be used singly or in admixture of two or more thereof. Further, the oil-soluble dye may be used in combination with other dyes than those represented by the general formulae (M-I), (C-I) and (Y-I).

As the dyes that can be used in combination, dyes as described in, for example, paragraphs (0014) to (0084) of JP-A-2001-262039 can be used. Incidentally, the term “substituted or unsubstituted indolinin-1-yl group” as described in paragraph (0040) of JP-A-2001-262039 should be interpreted as “substituted or unsubstituted indolin-1-yl group”.

In the inkjet inks of magenta, cyan, yellow and black colors to be used for full-color inkjet recording, a recording method in which the ink composition of the present invention using the oil-soluble dye represented by the general formula (M-I) is used as a magenta ink, the ink composition of the present invention using the oil-soluble dye represented by the general formula (C-I) is used as a cyan ink, and the ink composition of the present invention using the oil-soluble dye represented by the general formula (Y-I) is used as a yellow ink, respectively is particularly preferred from the both standpoints of recorded image quality and image preservability.

The inkjet ink composition of the present invention preferably contains the dye represented by the general formula (M-I), (C-I) or (Y-I) in an amount of from 0.1 to 20% by weight, and more preferably from 0.2 to 15% by weight.

(Oil-Soluble Polymer)

The oil-soluble polymer will be described below in detail.

With respect to the oil-soluble polymer, there are no particular limitations, but known oil-soluble polymers can be properly chosen depending upon the purpose for use. Examples include vinyl polymers and condensed polymers (such as polyurethanes, polyesters, polyamides, polyureas, and polycarbonates).

Though the oil-soluble polymer may be any type of a water-insoluble type, a water dispersing type (self-emulsifiable type), and a water-soluble type, the water-insoluble type or water-dispersing type is preferred from the standpoints of the easiness of production of colored fine particles and dispersion stability.

The water-dispersed polymer may be any type of an ionic dissociation type or a type containing a nonionic dispersing group or a mixture thereof.

Examples of polymers of the ionic dissociation type include polymers having a cationic dissociation group such as a tertiary amino group and polymers containing an anionic dissociation group such as a carboxyl group and a sulfonic acid group.

Examples of polymers of the type containing a nonionic dispersing group include polymers containing a nonionic dispersing group such as a polyethylene oxy group.

Among them, the polymers of ionic dissociation type containing an anionic dissociation group, the polymers of type containing a nonionic dispersing group, and mixtures thereof are preferred from the standpoint of the dispersion stability of the colored fine particles.

Examples of monomers that form the vinyl polymer are as follows:

Acrylic esters or methacrylic esters (the ester group is an optionally substituted alkyl group or aryl group, such as a methyl group, an ethyl group, an n-propyl group, an isopropyl group, an n-butyl group, a sec-butyl group, a t-butyl group, a hexyl group, a 2-ethylhexyl group, a t-octyl group, a 2-chloroethyl group, a cyanoethyl group, a 2-acetoxyethyl group, a tetrahydrofurfuryl group, a 5-hydroxypentyl group, a cyclohexyl group, a benzyl group, a hydroxyethyl group, a 3-methoxybutyl group, a 2-(2-methoxyethoxy)ethyl group, a 2,2,2-tetrafluoroethyl group, a 1H,1H,2H,2H-perfluorodecyl group, a phenyl group, a 2,4,5-tetramethylphenyl group, and a 4-chlorophenyl group).

Vinyl esters such as optionally substituted aliphatic carboxylic acid vinyl esters (such as vinyl acetate, vinyl propionate, vinyl butyrate, vinyl isobutyrate, vinyl carproate, and vinyl chloroacetate) and optionally substituted aromatic carboxylic acid vinyl esters (such as vinyl benzoate, vinyl 4-methylbenzoate, and vinyl salicylate).

Acrylamides such as acrylamides, N-mono-substituted acryalmides, and N-di-substituted acrylamides (the substituent includes an optionally substituted alkyl group, an optionally substituted aryl group, and an optionally substituted silyl group (such as a methyl group, an n-propyl group, an isopropyl group, an n-butyl group, a t-butyl group, a t-octyl group, a cyclohexyl group, a benzyl group, a hydroxymethyl group, an alkoxymethyl group, a phenyl group, a 2,4,5-tetramethylphenyl group, a 4-chlorophenyl group, and a trimethylsilyl group)).

Methacrylamides such as methacrylamides, N-mono-substituted methacrylamides, and N-di-substituted methacrylamides (the substituent includes an optionally substituted alkyl group, an optionally substituted aryl group, and an optionally substituted silyl group (such as a methyl group, an n-propyl group, an isopropyl group, an n-butyl group, a t-butyl group, a t-octyl group, a cyclohexyl group, a benzyl group, a hydroxymethyl group, an alkoxymethyl group, a phenyl group, a 2,4,5-tetramethylphenyl group, a 4-chlorophenyl group, and a trimethylsilyl group)).

Olefins (such as ethylene, propylene, 1-pentene, vinyl chloride, vinylidene chloride, isoprene, chloroprene, and butadiene), styrenes (such as styrene, methylstyrene, isopropylstyrene, methoxystyrene, acetoxystyrene, and chlorostyrene), and vinyl ethers (such as methyl vinyl ether, butyl vinyl ether, hexyl vinyl ether, and methoxyethyl vinyl ether).

Other monomers such as crotonic esters, itaconic esters, maleic diesters, fumaric diesters, methyl vinyl ketone, phenyl vinyl ketone, methoxyethyl vinyl ketone, N-vinyl oxazolidone, N-vinylpyrrolidone, vinylidene chloride, methylene malonitrile, vinylidene, diphenyl-2-acryloyloxyethyl phosphate, diphenyl-2-methacryloyloxyethyl phosphate, dibutyl-2-acryloyloxyethyl phosphate, and dioctyl-2-methacryloyloxyethyl phosphate.

Examples of the monomers having a dissociating group include monomers having an anionic dissociating group and monomers having a cationic dissociating group.

Examples of the monomers having an anionic dissociating group include carboxylic acid monomers, sulfonic acid monomers, and phosphoric acid monomers.

Examples of the carboxylic acid monomers include acrylic acid, 2-carboxyethyl acrylate, methacrylic acid, itaconic acid, maleic acid, fumaric acid, citraconic acid, crotonic acid, itaconic acid monoalkyl esters (such as monomethyl itaconate, monoethyl itaconate, and monobutyl itaconate), and maleic acid monoalkyl esters (such as monomethyl maleate, monoethyl maleate, and monobutyl maleate).

Examples of the sulfonic acid monomers include styrenesulfonic acid, vinylsulfonic acid, acryloyloxyalkanesulfonic acids (such as acryloyloxyethanesulfonic acid and acryloyloxypropanesulfonic acid), methacryloyloxyalkanesulfonic acids (such as acryloyloxyethanesulfonic acid and acryloyloxypropanesulfonic acid), acrylamide alkanesulfonic acids (such as 2-acrylamide-2-methylethanesulfonic acid, 2-acrylamide-2-methylpropanesulfonic acid, and 2-acrylamide-2-methylbutanesulfonic acid), and methacrylamide alkanesulfonic acids (such as 2-methacrylamide-2-methylethanesulfonic acid, 2-methacrylamide-2-methylpropanesulfonic acid, and 2-methacrylamide-2-methylbutanesulfonic acid).

Examples of the phosphoric acid monomers include vinylphosphonic acid and methacryloyloxyethenephosphonic acid.

Of these, acrylic acid, 2-carboxyethyl acrylate, methacrylic acid, styrenesulfonic acid, vinylsulfonic acid, acrylamide alkanesulfonic acids, and methacrylamide alkanesulfonic acids are preferred; acrylic acid, 2-carboxyethyl acrylate, methacrylic acid, styrenesulfonic acid, and 2-acrylamide-2-methylpropanesulfonic acid are more preferred; and acrylic acid, 2-carboxyethyl acrylate, and 2-acrylamide-2-methylpropanesulfonic acid are most preferred.

Examples of the monomers having a cationic dissociating group include monomers having a tertiary amino group, such as dialkylaminoethyl methacrylate s and dialkylaminoethyl acrylates.

Examples of the monomers having a nonionic dispersing group include esters of a polyethylene glycol monoalkyl ether and a carboxylic acid monomer; esters of a polyethylene glycol monoalkyl ether and a sulfonic acid monomer; esters of a polyethylene glycol monoalkyl ether and a phosphoric acid monomer; vinyl group-containing urethanes formed from a polyethylene glycol monoalkyl ether and an isocyanate group-containing monomer; and macro monomers having a polyvinyl alcohol structure. The repeating number of the ethylene oxy moiety of the polyethylene glycol monoalkyl ether is preferably from 8 to 50, and more preferably from 10 to 30. The number of carbon atoms of the alkyl group of the polyethylene glycol monoalkyl ether is preferable from 1 to 20, and more preferably from 1 to 12.

Next, the condensed polymer will be described below in detail.

The polyurethane is basically synthesized by polyaddition reaction of a diol compound and a diisocyanate compound as the starting materials.

Examples of the diol compound are as follows:

Non-dissociating diols such as ethylene glycol, 1,2-propanediol, 1,3-propanediol, 1,3-butanediol, 2,3-butanediol, 2,2-dimethyl-1,3-propanediol, 1,4-pentanediol, 2,4-pentanediol 3,3-dimethyl-1,2-butanediol, 2-ethyl-2-methyl-1,3-propanediol, 1,6-hexanediol, 2,5-hexanediol, 2-methyl-2,4-pentanediol, 2,2-diethyl-1,3-propanediol, 2,4-dimethyl-2,4-pentanediol, 2-methyl-2-propyl-1,3-propanediol, 2,5-dimethyl-2,5-hexanediol, 2-ethyl-1,3-hexanediol, 1,2-octanediol, 2,2,4-trimethyl-1,3-pentanediol, 1,4-cyclohexanedimethanol, diethylene glycol, triethylene glycol, dipropylene glycol, tripropylene glycol, polyethylene glycols (average molecular weight: 200, 300, 400, 600, 1,000, 1,500, and 4,000), polypropylene glycols (average molecular weight: 200, 400, and 1,000), polyester polyols, 4,4′-dihydroxy-diphenyl-2,2-prapane, and 4,4′-dihydroxyphenyl sulfone.

Diols having an anionic group, such as 2,2-bis(hydroxymethyl)propionic acid, 2,2-bis(hydroxymethyl)butanoic acid, 2,5,6-trimethoxy-3,4-dihydroxyhexanoic acid, 2,3-dihydroxy-4,5-dimethoxypentanoic acid, 2,4-di (2-hydroxy)ethyloxycarbonylbezenesulfonic acid, and salts thereof.

The diol compound is not particularly limited to these specific examples.

Preferred examples of the diisocyanate compound include ethylene diisocyanate, isophorone diisocyanate, hexamethylene diisocyanate, 1,4-cyclohexane diisocyanate, 2,4-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, dicyclohexylmethane diisocyanate, and methylene bis-(4-cyclohexyl isocyanate).

The polyester is basically synthesized by dehydration condensation of a diol compound and a dicarboxylic acid compound.

Specific examples of the dicarboxylic acid compound include oxalic acid, malonic acid, succinic acid, glutaric acid, dimethylmalonic acid, adipic acid, pimelic acid, α,α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethylene terephthalate)dicarboxylic acid, 1,2-cyclohexanedicarboxylic acid, 1,4-cyclohexanedicarboxylic acid, ω-poly(ethylene oxide)dicarboxylic acid, and p-xylylenedicarboxylic acid. These compounds may be used in the form of an alkyl ester (such as a dimethyl ester) of the dicarboxylic acid or an acid salt of the dicarboxylic acid, or of an acid anhydride (such as maleic anhydride, succinic anhydride, and phthalic anhydride) during the polycondensation reaction with the diol compound.

Preferred examples of the dicarboxylic acid having a sulfonic acid group include sulfophthalic acids (such as 3-sulfophthalic acid, 4-sulfophthalic acid, 4-sulfoisophthalic acid, 5-sulfoisophthalic acid, and 2-sulfoterephthalic acid), sulfosuccinic acid, sulfonaphthalenedicarboxylic acids (such as 4-sulfo-1,8-naphthalenedicarboxylic acid and 7-sulfo-1,5-naphthalenedicarboxylic acid), 2,4-di(2-hydroxy)ethyloxycarbonylbenzenesulfonic acid, and salts thereof.

As the diol compound, the compound selected from the same group of diols described in the foregoing urethane can be used.

Though the representative synthesis of the polyester is a condensation reaction of the diol compound and the dicarboxylic acid or its derivative, the polyester can also be obtained by condensation of a hydroxycarboxylic acid (such as 12-hydroxystearic acid). Also, polyesters obtained by ring opening polymerization of a cyclic ether and a lactone (the details are described in Takeo Saugusa, Lecture of Polymerization Reaction Theory: Ring Opening Polymerization (I), by Kagaku-Dojin Publishing Co., Lnc. (1971) can be suitably used in the present invention.

The polyamide is obtained by polycondensation of a diamine compound and a dicarboxylic acid compound, polycondensation of an aminocarboxylic acid compound, or ring opening polymerization of a lactam.

Examples of the diamine compound include ethylenediamine, 1,3-propanediamine, 1,2-propanediamine, hexamethylenediamine, octamethylenediamine, o-phenylenediamine, m-phenylenediamine, p-phenylenediamine, piperazine, 2,5-dimethylpiperazine, 4,4′-diaminodiphenyl ether, 3,3′-diaminodiphenyl sulfone, and xylylenediamine. Examples of the aminocarboxylic acid include glycine, alanine, phenylalanine, ω-aminohexanoic acid, ω-aminodecanoic acid, ω-aminoundecanoic acid, and anthranilic acid. Examples of the monomer that can be used for the ring opening polymerization include ω-caprolactam, azetidine, and pyrrolidone.

As the dicarboxylic acid compound, the compound selected from the same group of dicarboxylic acids described in the foregoing polyester can be used.

The polyurea can be basically obtained by polyaddition of a diamine compound and a diisocyanate compound or deammonification of a diamine compound and urea. As the diamine compound as the starting material, the compound selected from the same group of diamines described in the foregoing polyamide can be used. As the diisocyanate compound, the compound selected from the same group of diisocyanates described in the foregoing polyurethane can be used.

The polycarbonate can be basically obtained by reaction of a diol compound and phosgene or a carbonic ester derivative (such as aromatic esters, e.g., diphenyl carbonate). As the diol compound as the starting material, the compound selected from the same group of diols described in the foregoing polyurethane can be used.

With respect to the oil-soluble polymer, one kind of each of the necessary constitutional raw materials may be used, or two or more kinds of each of the necessary constitutional raw materials can be used in an arbitrary proportion depending on various purposes (such as adjustment of the glass transition temperature (Tg) or dissolution of the polymer, affinity with the dye, and the stability of the dispersion).

Among the oil-soluble polymers, those having a dissociating group are preferred from the standpoint of dispersion stability of the colored fine particles; those in which at least one of a carboxyl group and a sulfonic acid group is contained at the dissociating group are more preferred; and those in which a carboxyl group is contained as the dissociating group are particularly preferred.

After the polymerization of each polymer, a compound capable of introducing a dissociating group by reaction of a reactive group (such as a hydroxyl group and an amino group) with an acid anhydride (such as maleic anhydride) can be exerted and introduced.

A content of the dissociating group is preferably from 0.1 to 3.0 mmoles/g, and more preferably from 0.2 to 2.0 mmoles/g. When the content of the dissociating group is too low, the self-emulsification properties of the polymer are low. On the other hand, when it is too high, the water solubility is too high so that the polymer is liable to become not suitable for the dispersion of the dye.

With respect to the dissociating group, the anionic dissociating group may further be a salt of an alkali metal (such as Na and K) or an ammonium ion; and the cationic dissociating group may further be a salt of an organic acid (such as acetic acid, propionic acid, and methanesulfonic acid) or an inorganic acid (such as hydrochloric acid and sulfuric acid).

In the oil-soluble polymer, the vinyl polymer, polyurethane and polyester are particularly preferred taking into consideration the easiness of introduction of the dissociating group from the standpoints of imparting the affinity with the oil-soluble dye and imparting superior dispersion stability.

Specific examples of the vinyl polymer will be given below (PA-1 to PA-38 and PA-51 to PA-61). The ratios in the following parentheses mean a weight ratio. It should not be construed that the present invention is limited thereto.
PA-1) Methyl methacrylate/ethyl acrylate copolymer (50/50)
PA-2) Butyl acrylate/styrene copolymer (50/50)
PA-3) Poly-n-butyl methacrylate
PA-4) Polyisopropyl methacrylate
PA-5) Poly(4-t-butylphenyl acrylate)
PA-6) n-Butyl methacrylate/N-vinyl-2-pyrrolidone copolymer (90/10)
PA-7) Methyl methacrylate/vinyl chloride copolymer (70/30)
PA-8) Isobutyl methacrylate/butyl acrylate copolymer (55/45)
PA-9) Vinyl acetate/acrylamide copolymer (85/15)
PA-10) n-Butyl acrylate/methyl methacrylate/n-butyl methacrylate copolymer (35/35/30)
PA-11) Ethyl methacrylate/n-butyl acrylate copolymer (70/30)
PA-12) t-Butyl acrylamide/n-butyl acrylate copolymer (50/50)
PA-13) t-Butyl acrylamide/n-butyl methacrylate copolymer (50/50)
PA-14) t-Butyl methacrylamide/methyl methacrylate/acrylic acid copolymer (60/30/10)
PA-15) n-Butyl acrylate/acrylic acid copolymer (80/20)
PA-16) sec-Butyl acrylate/acrylic acid copolymer (85/15)
PA-17) Isopropyl acrylate/acrylic acid copolymer (90/10)
PA-18) Butyl methacrylate/2-hydroxyethyl methacrylate/acrylic acid copolymer (85/5/10)
PA-19) Isobutyl methacrylate/tetrahydrofurfuryl acrylate/acrylic acid copolymer (60/30/10)
PA-20) n-Butyl methacrylate/1H,1R,2H,2H-perfluorodecyl acrylate/acrylic acid copolymer (75/20/5)
PA-21) Methyl methacrylate/n-butyl acrylate/acrylic acid copolymer (50/45/5)
PA-22) 3-Methoxybutyl methacrylate/styrene/acrylic acid copolymer (35/50/15)
PA-23) Ethyl acrylate/phenyl methacrylate/acrylic acid copolymer (72/15/13)
PA-24) Isobutyl methacrylate/methacrylic ester of polyethylene glycol monomethyl ether (repeating number of ethylene oxy chain: 23)/acrylic acid copolymer (70/20/10)
PA-25) Ethyl methacrylate/acrylic acid copolymer (95/5)
PA-26) Isobutyl acrylate/methoxystyrene/acrylic acid copolymer (75/15/10).
PA-27) Isobutyl acrylate/N-vinylpyrrolidone/acrylic acid copolymer (60/30/10)
PA-28) 2,2,2-Tetrafluoroethyl methacrylate/methyl methacrylate/methacrylic acid copolymer (25/60/15)
PA-29) Ethyl methacrylate/2-ethoxyethyl methacrylate/methacrylic acid copolymer (70/15/15)
PA-30) t-Butyl acrylamide/n-butyl acrylate/acrylic acid copolymer (50/47/3)
PA-31) n-Butyl methacrylate/diphenyl-2-methacryoyloxyethyl phosphate/methacrylic acid copolymer (80/5/15)
PA-32) n-Butyl methacrylate/phenyl acrylamide/methacrylic acid copolymer (70/15/15)
PA-33) n-Butyl methacrylate/N-vinylpyrrolidone/methacrylic acid copolymer (70/15/15)
PA-34) n-Butyl methacrylate/styrenesulfonic acid copolymer (90/10)
PA-35) Isobutyl methacrylate/styrenesulfonic acid copolymer (90/10)
PA-36) n-Butyl methacrylate/2-acrylamide-2-methylethanesulfonic acid copolymer (90/10)
PA-37) Isobutyl acrylate/n-butyl methacrylate/2-acrylamide-2-methylethanesulfonic acid copolymer (70/20/10)
PA-38) t-Butyl acrylate/methacrylic ester of polyethylene glycol monoethyl ether (repeating number of ethylene oxy chain: 23)/2-acrylamide-2-methylpropanesulfonic acid copolymer (60/30/10)
PA-51) 2-Carboxyethyl acrylate/n-butyl methacrylate copolymer (10/90)
PA-52) 2-Carboxyethyl acrylate/diphenyl acrylamide/isobutyl methacrylate copolymer (15/10/75)
PA-53) 2-Carboxyethyl acrylate/n-butyl methacrylate/diphenyl-2-methacryloyloxyethyl phosphate copolymer (10/60/30)
PA-54) N-(3-Carboxypropyl) acrylamide/t-butyl methacrylamide/butyl acrylate copolymer (12/18/70)
PA-55) Poly-n-butyl methacrylate using mercapto acetic acid as a chain transfer agent (96.6/3.4)
PA-56) Isobutyl methacrylate/butyl acrylate copolymer using 2-mercapto succinic acid as a chain transfer agent (40/56/4)
PA-57) Acrylonitrile/methacrylonitrile/isopropyl methacrylate/2-carboxyethyl acrylate copolymer (40/40/15/5)
PA-58) Butyl acrylate/n-butyl methacrylate copolymer (20/80)
PA-59) N-t-Butyl acrylamide/n-butyl methacrylate copolymer (50/50)
PA-60) N-t-Butyl acrylamide/n-butyl acrylate/acrylic acid copolymer (30/67/3)
PA-61) Mono(acryloyloxyethyl) succinate/n-butyl methacrylate copolymer (15/85)

Specific example of the condensed polymer will be described below in the form of a starting monomer (PC-1) to PC-20)-PC-12) and PC-17) et seq. will be described in the form of a polymer), but it should not be construed that the present invention is limited thereto. All of the acid groups in the polymers are expressed in the non-dissociating form. Further, the compounds as formed by condensation reaction, such as polyesters and polyamides will be all expressed as dicarboxylic acid, diol, diamine, hydroxycarboxylic acid, aminocarboxylic acid, etc. regardless of the starting materials of the constitutional components.
PC-1) Toluene diisocyanate/ethylene glycol/1,4-butanediol (50/15/35)
PC-2) Toluene diisocyanate/hexamethylene diisocyanate/ethylene glycol/polyethylene glycol (Mw=600)/1,4-butanediol (40/10/20/10/20)
PC-3) 4,4′-Diphenylmethane diisocyanate/hexamethylene diisocyanate/tetraethylene glycol/ethylene glycol/2,2-bis(hydroxymethyl)propionic acid (40/10/20/20/10)
PC-4) 1,5-Naphthylene diisocyanate/butanediol/4,4′-dihydroxy-diphenyl-2,2′-propane/polypropylene glycol (MW=400)/2,2-bis(hydroxymethyl)propinonic acid (50/20/5/10/15)
PC-5) Isophorone diisocyanate/diethylene glycol/neopentyl glycol/2,2-bis(hydroxymethyl)propinic acid (50/20/20/10)
PC-6) Diphenylmethane diisocyanate/hexamethylene diisocyanate/tetraethylene glycol/butanediol/2,4-di(2-hydroxy)ethyloxycarbonylbenznesulfonic acid (40/10/10/33/7)
PC-7) Terephthalic acid/isophthalic acid/cyclohexanedimethanol/1,4-butanediol/ethylene glycol (25/25/25/15/10)
PC-8) Terephthalic acid/isophthalic acid/4,4′-dihydroxy-diphenyl-2,2-propane/tetraethylene glycol/ethylene glycol (30/20/20/15/15)
PC-9) Terephthalic acid/isophthalic acid/4,4′-benzenedimethanol/diethylene glycol/neopentyl glycol (25/25/25/15/10)
PC-10) Terephthalic acid/isophthalic acid/5-sulfoisophthalic acid/ethylene glycol/neopentyl glycol (24/24/2/25/25)
PC-11) 11-Aminoundecanoic acid (100)
PC-12) Reaction product of poly(12-aminododecanoic acid) and maleic anhydride
PC-13) Hexamethylenediamine/adipic acid (50/50)
PC-14) N,N-Dimethylethylenediamine/adipic acid/cyclohexanedicarboxylic acid (50/20/30)
PC-15) Toluene diisocyanate/4,4′-diphenylmethane diisocyanate/hexamethylenediamine (30/20/50)
PC-16) Hexamethylenediamine/nonamethylenediamine/urea (25/25/50)

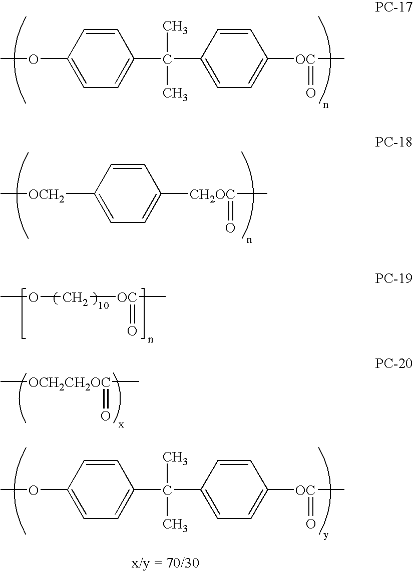

The oil-soluble polymer usually has a molecular weight (Mw) of from 1,000 to 200,000, and preferably from 2,000 to 50,000. When the molecular weight of the oil-soluble polymer is less than 1,000, it is liable to become difficult to obtain stable colored fine particles. On the other hand, when it exceeds 200,000, there is a tendency that the dissolution in the organic solvent becomes worse, or the viscosity of the organic solvent solution increases, whereby the polymer is hardly dispersed.

(Hydrophobic High-Boiling Organic Solvent)

In the present invention, the colored fine particles contain a hydrophobic high-boiling organic solvent. The hydrophobic high-boiling organic solvent is hydrophobic and has a boiling point of 150° C. or higher. The term “hydrophobic” as referred to herein means that the solubility in distilled water at 25° C. is 3% or less. The boiling point of the hydrophobic high-boiling organic solvent is preferably 170° C. or higher. Further, the high-boiling organic solvent preferably has a dielectric constant of from 3 to 12, and more preferably from 4 to 10. Incidentally, the term “dielectric constant” as referred to herein means a relative dielectric constant in vacuo at 25° C.

As the hydrophobic high-boiling organic solvent, the compounds as described in U.S. Pat. No. 2,322,027 can be used, and hydrophobic high-boiling organic solvents such as phosphoric esters, fatty acid esters, phthalic esters, benzoic esters, phenols, and amides are preferred. However, it should not be construed that the present invention is limited thereto.

As the hydrophobic high-boiling organic solvent, compounds represented by the following formulae [S-1] to [S-9] are particularly preferred.

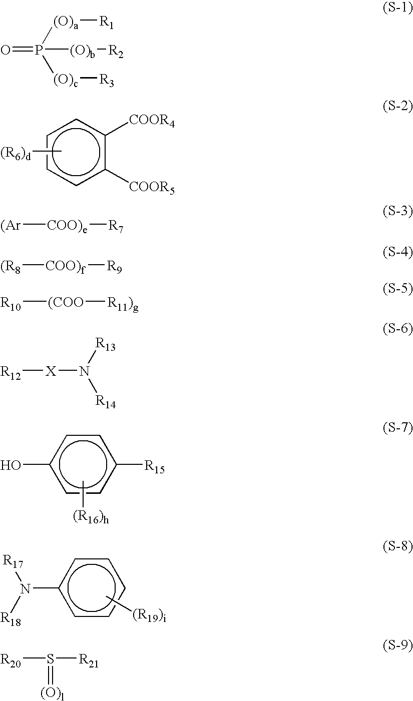

In the formula [S-1], R₁, R₂, and R₃ each independently represents an aliphatic group or an aryl group; and a, b, and c each independently represents 0 or 1.

In the formula [S-2], R₄ and R₅ each independently represents an aliphatic group or an aryl group; R⁶ represents a halogen atom (such as F, Cl, Br, and I, hereinafter the same), an alkyl group, an alkoxy group, an aryloxy group, an alkoxycarbonyl group, or an aryloxycarbonyl group; d represents an integer of from 0 to 3; and when plural ds′ are present, plural R₆s′ may be the same or different.

In the formula [S-3], Ar represents an aryl group; e represents an integer of from 1 to 6; and R₇ represents a hydrocarbon group having a valence of e or a hydrocarbon group bound to each other via an ether bond.

In the formula [S-4], R⁸ represents an aliphatic group; f represents an integer of from 1 to 6; and R⁹ represents a hydrocarbon group having a valence of f or a hydrocarbon group bound to each other via an ether group.

In the formula [S-5], g represents an integer of from 2 to 6; R₁₀ represents a hydrocarbon group having a valence of g (provided that an aryl group is excluded); and R¹, represents an aliphatic group or an aryl group.

In the formula [S-6], R₁₂, R₁₃, and R₁₄ each independently represents a hydrogen atom, an aliphatic group, or an aryl group; X represents —CO— or —SO₂—; and R₁₂ and R₁₃, or R₁₃ and R₁₄ may be taken together to form a ring.

In the formula [S-7], R₁₅ represents an aliphatic group, an alkoxycarbonyl group, an aryloxycarbonyl group, an alkylsulfonyl group, an arylsulfonyl group, an aryl group, or a cyano group; R₁₆ represents a halogen atom, an aliphatic group, an aryl group, an alkoxy group, or an aryloxy group; h represents an integer of 0 to 3; and when plural hs′ are present, plural R₁₆s′ may be the same or different.

In the formula [S-8], R₁₇ and R₁₈ each independently represents an aliphatic group or an aryl group; R¹⁹ represents a halogen atom, an aliphatic group, an aryl group, an alkoxy group, or an aryloxy group; i represents an integer of from 0 to 4; and when plural is′ are present, plural R₁₉s′ may be the same or different.

In the formula [S-9], R₂₀ and R₂₁ each independently represents an aliphatic group or an aryl group; and j represents 1 or 2.

In the formulae [S-1] to [S-9], when R₁ to R₆, R₈, and R¹¹ to R₂₁ represent an aliphatic group or a group containing an aliphatic group, the aliphatic group may be linear, branched or cyclic, or may contain an unsaturated bond or have a substituent. Examples of the substituent include a halogen atom, an aryl group, an alkoxy group, an aryloxy group, an alkoxycarbonyl group, a hydroxyl group, an acyloxy group, and an epoxy group.

In the formulae [S-1] to [S-9], when R₁ to R⁶, R₈, and R₁₁ to R₂₁ represent an alicyclic group, i.e., a cycloalkyl group, or a group containing a cycloalkyl group, the cycloalkyl group may contain an unsaturated bond in the 3-membered to 8-membered ring, or may have a substituent or a crosslinking group. Examples of the substituent include a halogen atom, an aliphatic group, a hydroxyl group, an acyl group, an aryl group, an alkoxy group, an epoxy group, and an alkyl group; and examples of the crosslinking group include methylene, ethylene, and isopropylidene.

In the formulae [S-1] to [S-9], when R₁ to R₆, R₈, and R₁₁ to R₂₁ represent an aryl group or a group containing an aryl group, the aryl group may be substituted with a substituent such as a halogen atom, an aliphatic group, an aryl group, an alkoxy group, an aryloxy group, and an alkoxycarbonyl group.

In the formulae [S-3], [S-4] and [S-5], when R₇, R₉, or R₁₀ represents a hydrocarbon group, the hydrocarbon group may contain a cyclic structure (such as a benzene ring, a cyclopentane ring, and a cyclohexane ring) or an unsaturated bond, or may have a substituent. Examples of the substituent include a halogen atom, a hydroxyl group, an acyloxy group, an aryl group, an alkoxy group, an aryloxy group, and an epoxy group.

Among the hydrophobic high-boiling organic solvents represented by the formulae [S-1] to [S-9], particularly preferred hydrophobic high-boiling organic solvents will be described below.

In the formula [S-1], R₁, R₂, and R₃ each independently represents an aliphatic group having from 1 to 24 carbon atoms, and preferably from 4′ to 18 carbon atoms (such as n-butyl, 2-ethylhexyl, 3,3,5-trimethylhexyl, n-dodecyl, n-octadecyl, benzyl, oleyl, 2-chloroethyl, 2,3-dichloropropyl, 2-butoxyethyl, 2-phenoxyethyl, cyclopentyl, cyclohexyl, 4-t-butylcyclohexyl, and 4-methylcyclohexyl) or an aryl group having from 6 to 24 carbon atoms, and preferably from 6 to 18 carbon atoms (such as phenyl, cresyl, p-nonylphenyl, xylyl, cumenyl, p-methoxyphenyl, and p-methoxycarbonylphenyl); and a, b, and c each independently represents 0 or 1, and more preferably, a, b, and c are all 1.

In the formula [S-2], R₄ and R₅ each independently represents an aliphatic group having from 1 to 24 carbon atoms, and preferably from 4 to 18 carbon atoms (such as the same alkyl groups as described above for R₁, ethoxycarbonylmethyl, 1,1-diethylpropyl, 2-ethyl-1-methylhexyl, cyclohexylmethyl, 1-ethyl-1,5-dimethylhexyl, 3,5,5-trimethylcyclohexyl, menthyl, bornyl, and 1-methylcyclohexyl) or an aryl group having from 6 to 24 carbon atoms, and preferably from 6 to 18 carbon atoms (such as the same aryl groups as described above for R₁, 4-t-butylphenyl, 4-t-octylphenyl, 1,3,5-trimethylphenyl, 2,4-di-t-butylphenyl, and 2,4,-di-t-pentylphenyl); R₆ represents a halogen atom (preferably a chlorine atom), an alkyl group having from 1 to 18 carbon atoms (such as methyl, isopropyl, t-butyl, and n-dodecyl), an alkoxy group having from 1 to 18 carbon atoms (such as methoxy, n-butoxy, n-octyloxy, methoxyethoxy, and benzyloxy), an aryloxy group having from 6 to 18 carbon atoms (such as phenoxy, p-tolyloxy, 4-methoxyphenoxy, and 4-t-butylphenoxy), an alkoxycarbonyl group having from 2 to 19 carbon atoms (such as methoxycarbonyl, n-butoxycarbonyl, and 2-ethylhexyloxycarbonyl), or an aryloxycarbonyl group having from 6 to 25 carbon atoms; and d is 0 or 1.

In the formula [S-3], Ar represents an aryl group having from 6 to 24 carbon atoms, and preferably from 6 to 18 carbon atoms (such as phenyl, 4-chlorophenyl, 4-methoxyphenyl, 1-naphthyl, 4-n-butoxyphenyl, and 1,3,5-trimethylphenyl); e represents an integer of from 1 to 4, and preferably from 1 to 3; R₇ represents a hydrocarbon group having a valence of e and having from 2 to 24 carbon atoms, and preferably from 2 to 18 carbon atoms, such as the same alkyl groups, cycloalkyl groups and aryl groups as described above for R⁴, —(CH₂)₂—, 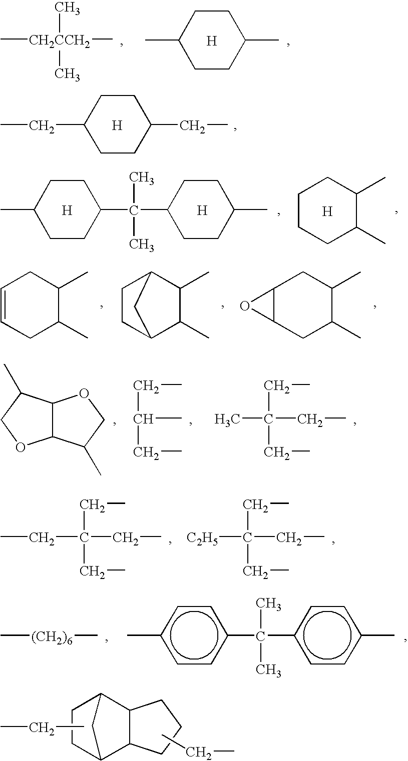
or a hydrocarbon group bound having a valence of e and having from 4 to 24 carbon atoms, and preferably from 4 to 18 carbon atoms to each other via an ether bond, such as —CH₂CH₂OCH₂CH₂—, —CH₂CH₂(OCH₂CH₂)₃—, —CH₂CH₂CH₂OCH₂CH₂CH₂—,

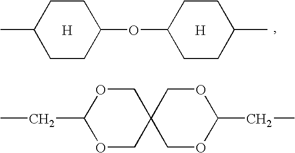

In the formula [S-4], R₈ represents an aliphatic group having from 3 to 24 carbon atoms, and preferably from 3 to 17 carbon atoms (such as n-propyl, 1-hydroxyethyl, 1-ethylpentyl, n-undecyl, pentadecyl, 8,9-epoxyheptadecyl, cyclopropyl, cyclohexyl, and 4-methylcyclohexyl); f represents an integer of from 1 to 4, and preferably from 1 to 3; R₉ represents a hydrocarbon group having a valence of f and having from 2 to 24 carbon atoms, and preferably from 2 to 18 carbon atoms or a hydrocarbon group bound having a valence of f and having from 4 to 24 carbon atoms, and preferably from 4 to 18 carbon atoms to each other via an ether group (such as the same groups as described above for R₇)

In the formula [S-5], g is from 2 to 4, and preferably 2 or 3; R₁₀ represents a hydrocarbon group having a valence of g, such as —CH₂—, —(CH₂)₂—, —(CH₂)₄—, —(CH₂)₇—, 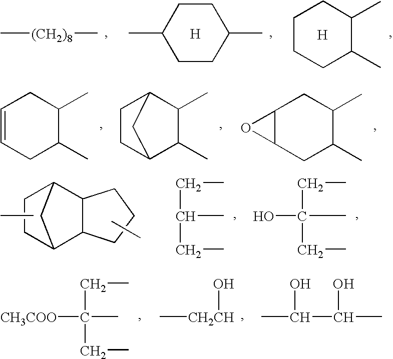
and R₁₁ represents an aliphatic group having from 1 to 24 carbon atoms, and preferably from 4 to 18 carbon atoms or an aryl group having from 6 to 24 carbon atoms, and preferably from 6 to 18 carbon atoms (such as the same aliphatic groups and aryl groups as described above for R₄).

In the formula [S-6], R₁₂ represents an aliphatic group having from 1 to 20 carbon atoms (such as n-propyl, 1-ethylpentyl, n-undecyl, n-pentadecyl, 2,4,-di-t-pentylphenoxymethyl, 4-t-octylphenoxymethyl, 3-(2,4-di-t-butylphenoxy)propyl, 1-(2,4-di-t-butylphenoxy)propyl, cyclohexyl, and 4-methylcyclohexyl) or an aryl group having from 6 to 24 carbon atoms, and preferably from 6 to 18 carbon atoms (such as the same aryl groups as described above for Ar); R₁₃ and R₁₄ each independently represents an aliphatic group having from 3 to 24 carbon atoms, and preferably from 3 to 18 carbon atoms (such as isopropyl, n-butyl, n-hexyl, 2-ethylhexyl, n-dodecyl, cyclopentyl, and cyclopropyl) or an aryl group having from 6 to 18 carbon atoms, and preferably from 6 to 15 carbon atoms (such as phenyl, 1-naphthyl, and p-tolyl); R₁₃ and R₁₄ may be taken together to form a pyrrolidine ring, a piperizine group, or a morpholine ring together with N; R₁₂ and R₁₃ may be taken together to form a pyrrolidone ring; and X represents —CO— or —SO₂—, and preferably —CO—.

In the formula [S-7], R₁₅ represents an aliphatic group having from 1 to 24 carbon atoms, and preferably from 3 to 18 carbon atoms (such as methyl, isopropyl, t-butyl, t-pentyl, t-hexyl, t-octyl, 2-butyl, 2-hexyl, 2-octyl, 2-dodecyl, 2-hexadecyl, t-pentadeyl, cyclopentyl, and cyclohexyl), an alkoxycarbonyl group having from 2 to 24 carbon atoms, and preferably from 5 to 17 carbon atoms (such as n-butoxycarbonyl, 2-ethylhexyloxycarbonyl, and n-dodecyloxycarbonyl), an alkylsulfonyl group having from 1 to 24 carbon atoms, and preferably from 3 to 18 carbon atoms (such as n-butylsulfonyl and n-dodecylsulfonyl), an arylsulfonyl group having from 6 to 30 carbon atoms, and preferably from 6 to 24 carbon atoms (such as p-tolylsulfonyl, p-dodecylphenylsulfonyl, and p-hexadecyloxyphenylsulfonyl), an aryl group having from 6 to 32 carbon atoms, and preferably from 6 to 24 carbon atoms (such as phenyl and p-tolyl), or a cyano group; R₁₆ represents a halogen atom (preferably, Cl), an alkyl group having from 1 to 24 carbon atoms, and preferably from 3 to 18 carbon atoms (such as the same alkyl groups as described above for R₁₅), a cycloalkyl group having from 5 to 17 carbon atoms (such as cyclopentyl and cyclohexyl), an aryl group having from 6 to 32 carbon atoms, and preferably from 6 to 24 carbon atoms (such as phenyl and p-tolyl), an alkoxy group having from 1 to 24 carbon atoms, and preferably from 1 to 18 carbon atoms (such as methoxy, n-butoxy, 2-ethylhexyloxy, benzyloxy, n-dodecyloxy, and n-hexadecyloxy), or an aryloxy group having from 6 to 32 carbon atoms, and preferably from 6 to 24 carbon atoms (such as phenoxy, p-t-butylphenoxy, p-t-octylphenoxy, m-pentadecylphenoxy, and p-dodecyloxyphenoxy); and h represents an integer of from 1 to 2.

In the formula [S-8], R₁₇ and R₁₈ are the same as R₁₃ and R₁₄; and R₁₉ is the same as R₁₆.

In the formula [S-9], R₂₀ and R₂₁ are the same as R₁, R₂, and R₃; and j represents 1 or 2, and preferably 1.

Specific examples S-1 to S-81 of the hydrophobic high-boiling organic solvent that is used in the present invention will be given below.
Compounds Represented by the Formula [S-1]: 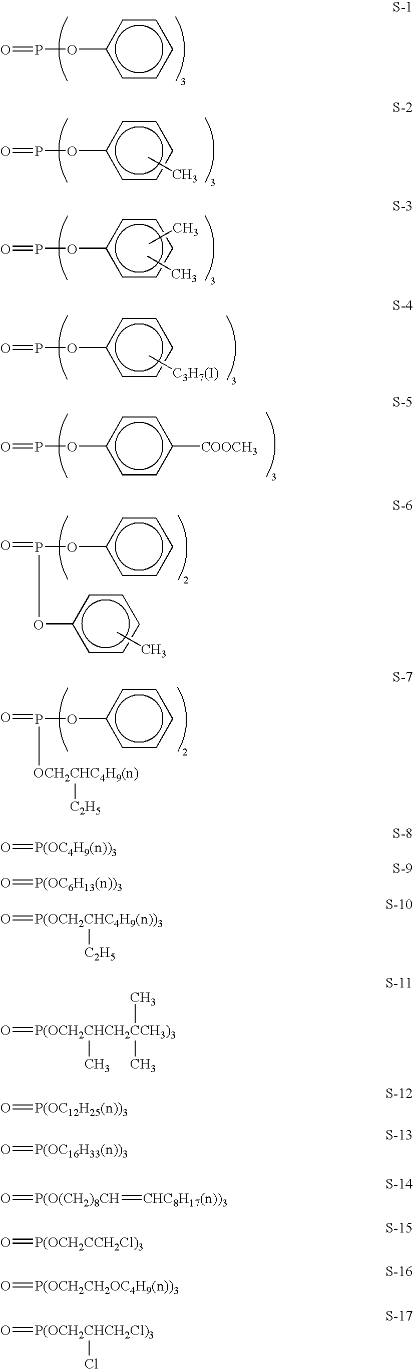 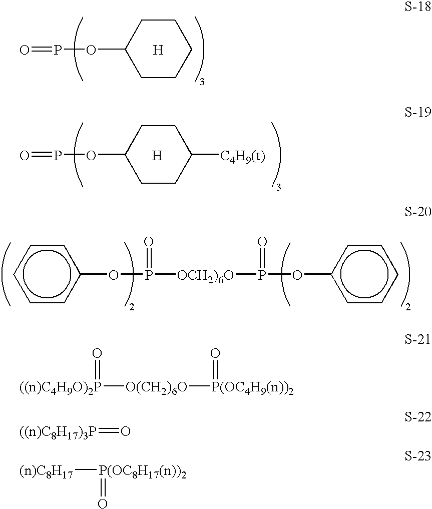
Compounds Represented by the Formula [S-2]: 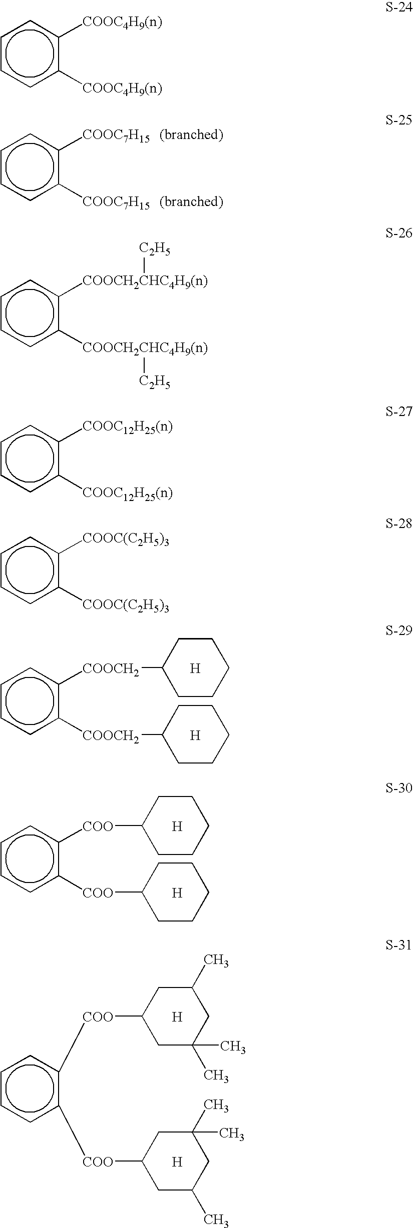 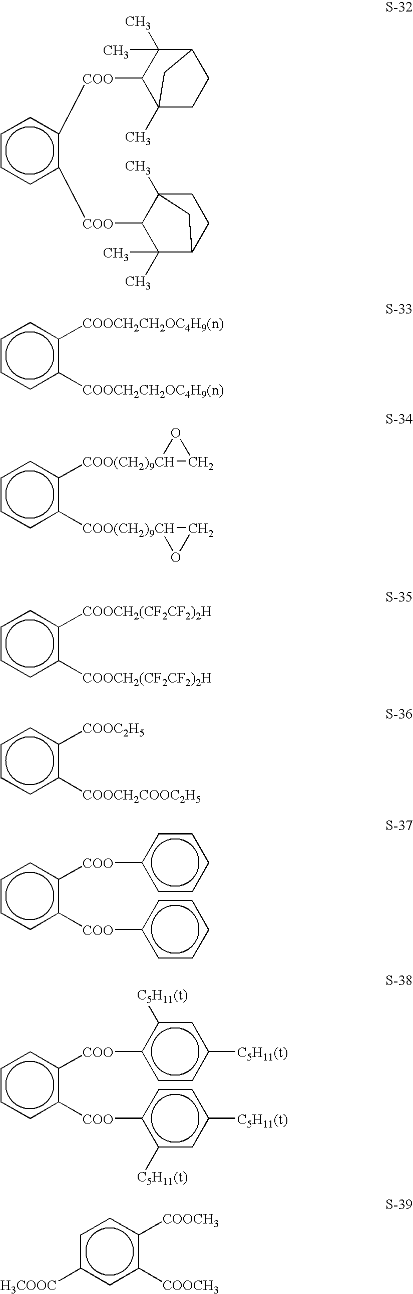
Compounds Represented by the Formula [S-3]: 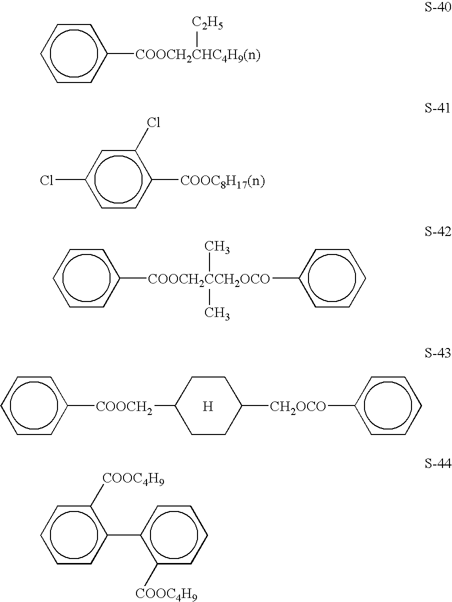
Compounds Represented by the Formula [S-4]: 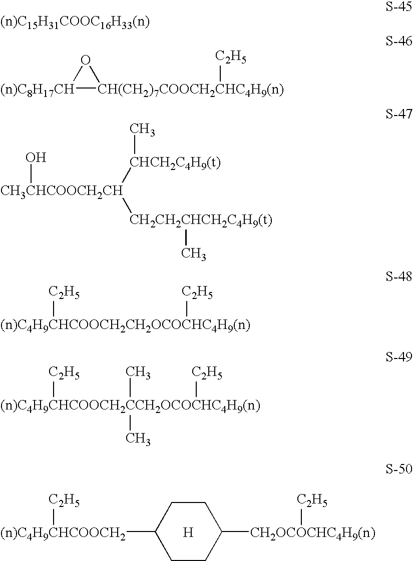
Compounds Represented by the Formula [S-5]: 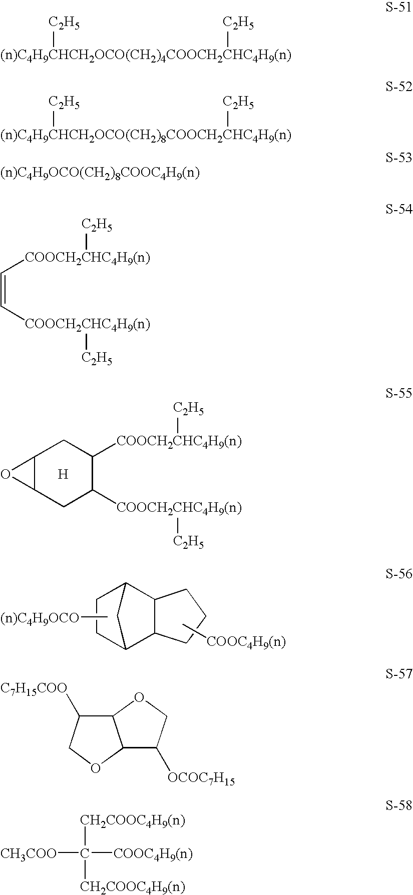
Compounds Represented by the Formula [S-6]: 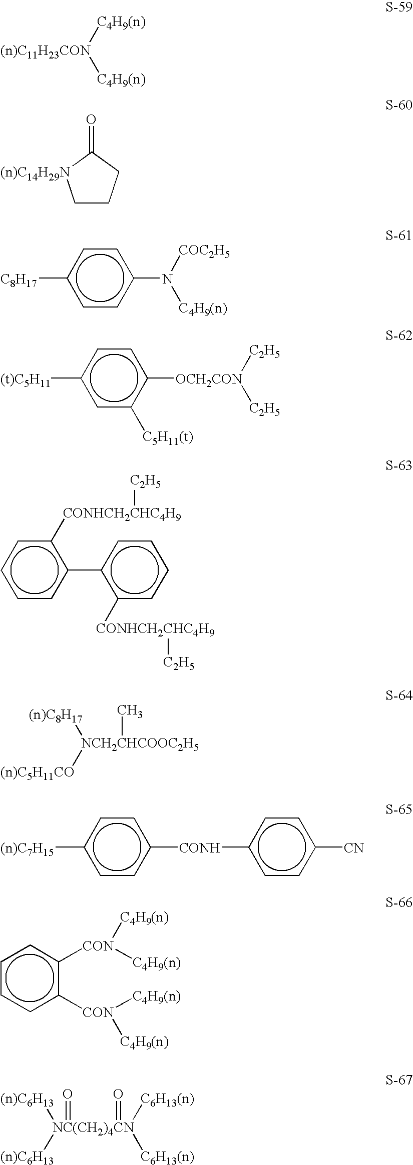
Compounds Represented by the Formula [S-7]: 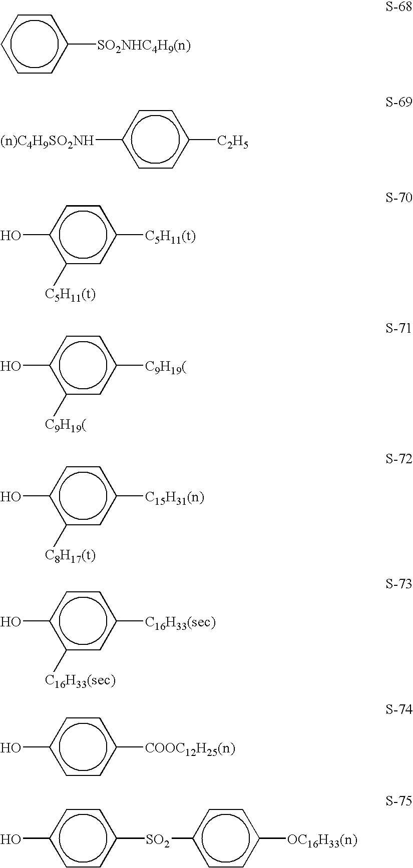
Compounds Represented by the Formula [S-8]: 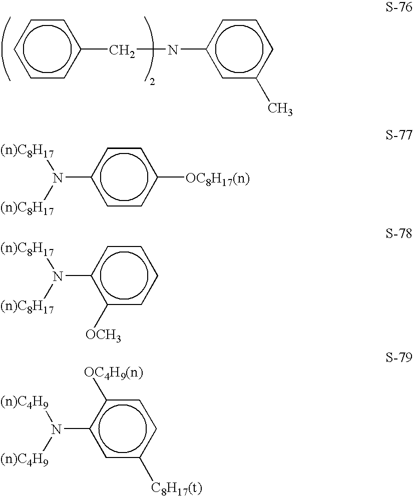
Compounds Represented by the Formula [S-9]:

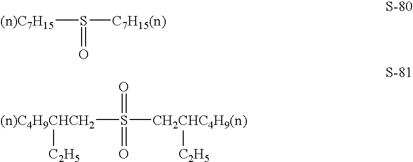

In the present invention, the hydrophobic high-boiling organic solvent may be used singly or in admixture of two or more thereof (such as a mixture of tricresyl phosphate and dibutyl phthalate and a mixture of trioctyl phosphate and di(2-ethylhexyl) sebacate).

Other examples of the hydrophobic high-boiling organic solvent that can be used in the present invention and the synthesis methods of these hydrophobic high-boiling organic solvents are described in, for example, U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,207,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321 and 5,013,639, European Patent Nos. 276,319A, 286,253A, 289,820A, 309,158A, 309,159A, 309,160A, 509,311A and 510,576A, East German Patent Nos. 147,009, 157, 147, 159,573 and 225,240A, British Patent No. 2,091,124A, JP-A-48-47335, JP-A-50-26530, JP-A-51-25133, JP-A-51-26036, JP-A-51-27921, JP-A-51-27922, JP-A-51-149028, JP-A-52-46816, JP-A-53-1520, JP-A-53-1521, JP-A-53-15127, JP-A-53-146622, JP-A-54-91325, JP-A-54-106228, JP-A-54-118246, JP-A-55-59464, JP-A-56-64333, JP-A-56-81836, JP-A-59-204041, JP-A-61-84641, JP-A-62-118345, JP-A-62-247364, JP-A-63-167357, JP-A-63-214744, JP-A-63-301941, JP-A-64-9452, JP-A-64-9454, JP-A-64-68745, JP-A-1-101543, JP-A-1-102454, JP-A-2-792, JP-A-2-4239, JP-A-2-43541, JP-A-4-29237, JP-A-4-30165, JP-A-4-232946, and JP-A-4-346338.

(Production of Colored-Fine Particles Containing Oil-Soluble Polymer)

The dispersion of colored fine particles of the present invention is a dispersion of colored fine particles containing the oil-soluble dye, the oil-soluble polymer, and the hydrophobic high-boiling organic solvent, in an aqueous medium. Concretely, for example, there are included a method in which a latex of the oil-soluble polymer is previously prepared, with which are then impregnated the oil-soluble dye and the hydrophobic high-boiling organic solvent; and a co-emulsification dispersion method. Of these is preferable the co-emulsification dispersion method.

The co-emulsification dispersion method can be carried out by dispersing an oil phase of the oil-soluble polymer and the oil-soluble dye dissolved in the hydrophobic high-boiling organic solvent or if desired, a mixed solvent thereof with a low-boiling organic solvent in an aqueous phase composed mainly of water to form fine droplets of the oil phase. In the co-emulsification dispersion, a method of adding the oil phase into the aqueous phase is general. However, so-called phase reversal of emulsion can also be preferably employed. During the emulsification dispersion, if desired, additives as described later, such as a surfactant, a drying inhibitor, a dye stabilizer, an emulsification stabilizer, an antiseptic, and a mildewcide, can be added to either one of the aqueousphase or the oil phase or the both phases.

As the surfactant that can be used during the emulsification dispersion are enumerated various surfactants. Preferred examples include anionic surfactants, such as fatty acid salts, alkylsulfuric acid esters, alkylbenzenesulfonic acid salts, alkalynaphthalenesulfonic acid salts, dialkylsulfosuccinic acid salts, alkylphosphoric acid ester salts, naphthalenesulfonic acid-formalin condensates, and polyoxyethylene alkylsulfuric acid ester salts; and nonionic surfactants such as polyoxyethylene alkyl ethers, polyoxyethylene alkylaryl ethers, polyoxyethylene fatty acid esters, sorbitan fatty acid esters, polyoxyethylene sorbitan fatty acid esters, polyoxyethylene alkylamines, glycerin fatty acid esters, and oxyethylene-oxypropylene block copolymers. Further, SURFYNOLS (manufactured by Air Products and Chemicals, Inc.) as an acetylene-based polyoxyethylene oxide surfactant can be suitably used. Moreover, ampholytic surfactants of an amine oxide type, such as N,N-dimethyl-N-alkylamine oxides, are also preferred. In addition, the surfactants as described in JP-A-59-157636, pages 37-38 and Research Disclosure No. 308119 (1989) are also useful.

For the purpose of stabilization immediately after the emulsification, a water-soluble polymer can be added in combination with the surfactant. Preferred examples of the water-soluble polymer include polyvinyl alcohol, polyvinylpyrrolidone, polyethylene oxide, polyacrylic acid, polyacrylamide, and copolymers thereof. Also, natural water-soluble polymers such as polysaccharides, casein, and gelatin are suitably used.

In the case where the colored fine particles containing the oil-soluble polymer, the oil-soluble dye, and the hydrophobic high-boiling solvent are dispersed in the aqueous medium to form an aqueous ink according to the co-emulsification dispersion method, it is particularly important to control the particle size. In order to increase the color purity and density during the formation of an image by inkjet, it is preferred that the colored fine particles have a small mean particle size. Concretely, the colored fine particles preferably have a volume average particle size of 100 nm or less, and more preferably 1 n═ or more and 80 nm or less.

When coarse particles are present in the colored fine particles, the printing performance may be likely lowered. For example, there may be the case wherein the printing performance is adversely affected, such as the case where the coarse particles clog a head nozzle, and the case where though the coarse particles do not clog the head nozzle, they form stains to cause non-ejection of the ink or stagger of the ejection. Accordingly, it is preferred that a proportion of the coarse particles to be present is low. In the case of preparing the ink, it is preferred that the number of particles of 5 μm or larger is 10 or less, and the number of particles of 1 μm or larger is 1,000 or less per μL of the ink. As a method of removing the coarse particles, known centrifugation and precision filtration are employable. Such separation means may be carried out immediately after the emulsification dispersion, or after adding various additives such as a wetting agent and a surfactant to the emulsification dispersion and immediately before filling the ink in an ink cartridge. In order to make the mean particle size of the colored fine particles small and decrease the number of coarse particles, it is effective to use a mechanical emulsification device.

As the emulsification device are employable known devices of, for example, a simple stirrer or impeller agitation mode, an inline agitation mode, a mill mode (such as colloid mill), and a ultrasonic mode. Use of a high-pressure homogenizer is particularly preferred. The detailed mechanism of the high-pressure homogenizer is described in, for example, U.S. Pat. No. 4,533,254 and JP-A-6-47264. As commercially available devices, a Gaulin homogenizer (manufactured by A.P. V GAULIN INC.), a micro-fluidizer (manufactured by MICROFLUIDEX INC.), and a ultimaizer (manufacture by SUGINO MACHINE LIMITED) can be used. Examples of the high-pressure homogenizer provided with a mechanism of forming fine particles within a ultra-high pressure jet stream is enumerated DeBEE 2000 (manufactured by BEE INTERNATIONAL LTD.).

The pressure under which the emulsification-is carried out by the high-pressure emulsification dispersion device is generally 50 MPa or more, preferably 60 MPa or more, and more preferably 180 MPa or more. For example, a method of employing a combination of two or more emulsification devices such that after undergoing the emulsification by an emulsification device, the emulsion is passed through a high-pressure homogenizer is particularly preferred. Further, a method in which after once undergoing the emulsification dispersion by these emulsification devices, additives such as a wetting agent and a surfactant are added, and the ink is then passed again through the high-pressure homogenizer while filling it in a cartridge, is preferred.

In the case where the low-boiling organic solvent is used in addition to the hydrophobic high-boiling organic solvent, it is preferred to remove the low-boiling organic solvent from the standpoints of the stability and safety and hygiene of the emulsion. As the method of removing the low-boiling organic solvent, various known methods can be employed depending on the kind of the solvent. That is, examples include evaporation, vacuum evaporation, and ultrafiltration. It is preferred to undergo the removal step of the low-boiling organic solvent as quickly as possible immediately after the emulsification.

In the colored fine particles of the present invention, the amount of the oil-soluble polymer to be used is preferably from 1 to 70% by weight, and more preferably from 2 to 50% by weight based on the total sum of the oil-soluble dye, the oil-soluble polymer, and the hydrophobic high-boiling organic solvent, each of which constitutes the oil phase. Further, in the dispersion of the colored fine particles of the present invention, the amount of the hydrophobic high-boiling organic solvent is preferably from 25 to 95% by weight, more preferably from 30 to 90% by weight, and most preferably from 40 to 85% by weight based on the total sum of the oil-soluble dye, the oil-soluble polymer, and the hydrophobic high-boiling organic solvent, each of which constitutes the oil phase.

(Organic Solvent)

With respect to the organic solvent other than the hydrophobic high-boiling organic solvent, which is used for preparing the colored fine particles, there are no particular limitations. Such an organic solvent can be properly chosen on a basis of the dissolution of the oil-soluble dye and the oil-soluble polymer. Examples include ketone-based solvents such as acetone, methyl ethyl ketone, and diethyl ketone; alcoholic solvents such as methanol, ethanol, 2-propanol, 1-propanol, 1-butanol, and t-butanol; chlorine-based solvents such as chloroform and methylene chloride; aromatic solvents such as benzene and toluene; ester-based solvents such as ethyl acetate, butyl acetate, and isopropyl acetate; ether-based solvents such as diethyl ether, tetrahydrofuran, and dioxane; and glycol ether-based solvents such as ethylene glycol monomethyl ether and ethylene glycol dimethyl ether.

The organic solvent may be used singly or in admixture of two or more thereof. A mixed solvent thereof with water may be used depending on the dissolution of the dye and polymer.

The amount of the organic solvent to be used is not particularly limited so far as the effects of the present invention are hindered but is preferably from 10 to 2,000 parts by weight, and more preferably from 100 to 1,000 parts by weight based on 100 parts by weight of the oil-soluble polymer. When the amount of the organic solvent is less than 10 parts by weight, it is liable to become difficult to finely and stably disperse the colored fine particles. On the other hand, when it exceeds 2,000 parts by weight, the desolvation and concentration steps for removing the organic solvent become essential and complicated, whereby a margin in the compounding design tends to disappear.

In the case where the solubility of the organic solvent in water is 10% or less, or the vapor pressure of the organic solvent is higher than that of water, it is preferred to remove the organic solvent later from the standpoint of stability of the colored fine particles.

Incidentally, it is preferred to remove the organic solvent as used after preparing the dispersion of the colored fine particles. The removal of the organic solvent can be carried out at from 10° C. to 100° C. under atmospheric pressure or reduced pressure, and preferably at from 40° C. to 100° C. under atmospheric pressure or at from 10° C. to 50° C. under reduced pressure.

(Additives)

The dispersion of the colored fine particles of the present invention may contain additive to be properly chosen depending upon the purpose so far as the effects of the present invention are not hindered.

Examples of the additives include a dispersion stabilizer. The dispersion stabilizer may be added to any of the oil phase and the aqueous phase. It is preferred to add the dispersion stabilizer after completion of the emulsification dispersion. Examples of the dispersion stabilizer include various cationic, anionic or nonionic surfactants, water-soluble or water-dispersing low-molecular weight compounds, and oligomers. The amount of the dispersion stabilizer to be added is from 0 to 100% by weight, and preferably from 0 to 20% by weight based on the total sum of the oil-soluble dye and the oil-soluble polymer.

In the dispersion of the colored fine particles of the present invention, the colored fine particles are preferably contained in an amount of from 1 to 45% by weight, and more preferably from 2 to 30% by weight. The content of the colored fine particles can be properly regulated by dilution, evaporation, ultrafiltration, etc.

The dispersion of the colored fine particles of the present invention can be used in various fields but is suitable as, for example, an aqueous ink for writing, an aqueous ink for printing, or an ink for information recording. The dispersion of the colored fine particles of the present invention is particularly suitable as an inkjet ink as described below.

(Inkjet Ink and Inkjet Recording Method)

The inkjet ink of the present invention contains the dispersion of the colored fine particles of the present invention and further contains other components as properly chosen, if desired.

In the inkjet recording method of the present invention, the recording is carried out using the inkjet ink. An ink nozzle that is used is not particularly limited but can be properly chosen depending upon the purpose.

Other components may be contained so far as the effects of the present invention are not hindered.

Examples of these other components include known additives such as a drying inhibitor, a penetration promoter, a ultraviolet ray absorber, an antioxidant, a mildewrcide, a pH regulator, a surface tension regulator, a defoaming agent, a viscosity regulator, a dispersion stabilizer, a rust proofing agent, and a chelating agent.

The drying inhibitor is suitably used for the purpose of preventing clogging of an ink injection port of a nozzle to be used in the inkjet recording mode, which is caused by drying of the inkjet ink.

As the drying inhibitor, a water-soluble organic solvent having a vapor pressure lower than water is preferable. Specific examples include polyhydric alcohols represented by ethylene glycol, propylene glycol, diethylene glycol, polyethylene glycol, thioglycol, dithioglycol, 2-methyl-1,3-propanediol, 1,2,6-hexanetriol, acetylene glycol derivatives, glycerin, and trimethylolpropane; lower alkyl ethers of polyhydric alcohols, such as ethylene glycol monomethyl (or monoethyl) ether, diethylene glycol monomethyl (or monoethyl) ether, and triethylene glycol monoethyl (or monobutyl) ether; heterocyclic compounds such as 2-pyrrolidone, N-methyl-2-pyrrolidone, 1,3-dimethyl-2-imidazolinone, and N-ethylmorpholine; sulfur-containing compounds such as sulfolane, dimethyl sulfoxide, and 3-sulfolen; polyfunctional compounds such as diacetone alcohol and diethanolamine; and urea derivatives.

Of these are more preferable polyhydric alcohols such as glycerin and diethylene glycol. The drying inhibitor may be used singly or in admixture of two or more thereof.

The content of the drying inhibitor used in the inkjet ink is preferably 10 to 50% by weight based on the inkjet ink.

The penetration promoter is suitably used for the purpose of promoting the penetration of the inkjet ink into paper.

Examples the penetration promoter include alcohols such as ethanol, isopropanol, butanol, di(or tri)ethylene glycol monobutyl ether, and 1,2-hexanediol; sodium lauryl sulfate; sodium oleate; and nonionic surfactants.

The penetration promoter is contained within the range where bleeding of printing and print-through do not occur. When the penetration promoter is contained in an amount of from about 5 to 30% by weight in the inkjet ink, sufficient effects are usually exhibited.

The ultraviolet ray absorber is used for the purpose of enhancing the preservability of the image.

Examples of the ultraviolet ray absorber include benzotriazole-based compounds as described in JP-A-58-185677, JP-A-61-190537, JP-A-2-0.7-82, JP-A-5-197075, and JP-A-9-34057; benzophenone-based compounds as described in JP-A-46-2784, JP-A-5-194483, and U.S. Pat. No. 3,214,463; cinnamic acid-based compounds as described in JP-B-48-30492, JP-B-56-21141, and JP-A-10-88106; triazine-based compounds as described in JP-A-4-298503, JP-A-8-53427, JP-A-8-239368, JP-A-10-182621, and JP-T-8-501291; compounds as described in Research Disclosure No. 24239; and compounds emitting a fluorescent light upon absorption of ultraviolet rays, so-called fluorescent brighteners, represented by stilbene-based compounds and benzoxazole-based compounds.

The antioxidant is used for the purpose of enhancing the preservability of the image.

As the antioxidant, various organic or metal complex-based anti-fading agents can be used.

Examples of the organic anti-fading agent include hydroquinones, alkoxyphenols, dialkoxyphenols, phenols, anilines, amines, indanes, chromans, alkoxyanilines, and heterocyclic compounds.

Examples of the metal complex-based anti-fading agent include nickel complexes and zinc complexes. Concretely, there can be used compounds as described in the patents cited in Research Disclosure No. 17643, Chapter VII, items I to J, ibid., No. 15162, ibid., No. 18716, page 650, left column, ibid., No. 36544, page 527, ibid., 307105, page 872, and ibid., No. 15162; compounds falling within the general formulae of representative compounds and illustrative compounds as described in JP-A-62-215272, pages 127 to 137.

Examples of the mildewcide include sodium dehydroacetate, sodium benzoate, sodium pyridine thione-1-oxide, ethyl p-hydroxybenzoate, and 1,2-benzisothiazolin-3-one or a salt thereof. It is preferred to use the mildewcide in an amount of from 0.02 to 1.00% by weight in the ink.

As the pH regulator, organic bases can be used. Examples of the organic base include triethanolamine, diethanolamine, N-methyldiethanolamine, and dimethylethanolamine. The pH regulator is added such that the inkjet ink preferably has a pH of from 6 to 10, and more preferably form 7 to 10 for the purpose of enhancing the storage stability of the inkjet ink.

As the surface tension regulator are enumerated anionic, cationic or nonionic surfactants. The surfactant that is used as the surface tension regulator is properly chosen and used from the standpoints of foaming properties and defoaming properties of the ink composition, especially the inkjet ink, the presence or absence of bleeding of printing, and flying properties of ink droplets. As specific examples of the surfactant can be enumerated various surfactants including those as described above for the emulsification dispersion. Among them, nonionic surfactants are preferred, and surfactants represented by the following general formula (W-I) or (W-II) are more preferred for use.

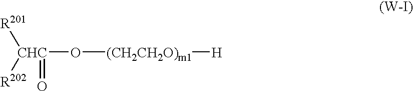

In the general formula (W-I) R²⁰¹ and R²⁰² each independently represents a saturated hydrocarbon group having from 2 to 20 carbon atoms, and preferably from 4 to 13 carbon atoms. Examples of the saturated hydrocarbon group include ethyl, n-butyl, isobutyl, n-pentyl, n-hexyl, n-heptyl, n-octyl, 2-ethylhexyl, n-nonyl, n-decyl, n-dodecyl, n-hexadecyl, and n-octadecyl. The total sum of carbon atoms of R²⁰¹ and R²⁰² is preferably from 5 to 30. m1 is a mean addition mole number of ethylene oxide and is from 2 to 40, and preferably from 3 to 30.

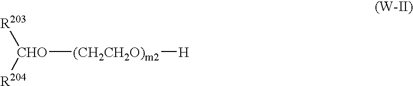

In the general formula (W-II), R²⁰³ and R²⁰⁴ each independently represents a saturated hydrocarbon group having from 4 to 20 carbon atoms, and preferably from 4 to 13 carbon atoms. Examples of the saturated hydrocarbon group include ethyl, n-butyl, isobutyl, n-pentyl, n-hexyl, n-heptyl, n-octyl, 2-ethylhexyl, n-nonyl, n-decyl, n-dodecyl, n-hexadecyl, and n-octadecyl. The total sum of carbon atoms of R²⁰³ and R²⁰⁴ is preferably from 8 to 18, and more preferably from 8 to 16. m2 is a mean addition mole number of ethylene oxide and is from 3 to 20, preferably from 5 to 20, and more preferably from 6 to 18.

The inkjet ink of the present invention preferably has a surface tension of from 25 to 70 mN/m, and more preferably from 25 to 60 mN/m. Further, the inkjet ink of the present invention preferably has a viscosity of 30 mP·s or less, and more preferably 20 mP·s or less.

As the defoaming agent, fluorine-based compounds, silicone-based compounds, and chelating agents represented by EDTA can be used, if desired.

In the inkjet ink of the present invention can be suitably printed on a known material to be recorded. As the material to be recorded are enumerated plain papers, resin-coated papers, special inkjet papers, films, electrophotographic shared papers, cloths, glass, metals, and ceramics.

Though the material to be recorded is not particularly limited, special inkjet papers are preferred.

Examples of the special inkjet papers include those described in JP-A-8-169172, JP-A-8-27693, JP-A-2-276670, JP-A-7-276789, JP-A-9-323475, JP-A-62-238783, JP-A-10-153989, JP-A-10-217473, JP-A-10-235995, JP-A-10-337947, JP-A-10-217597, and JP-A-10-337947.

Further, as the material to be recorded, besides the foregoing special inkjet papers, the following recording paper and recording film are suitably used.

The recording paper or recording film comprises a support having an ink receiving layer and optionally, other layers (such as a back coat layer) laminated thereon.

Each of the layers including the ink receiving layer may be a single layer of a layer made of two or more layers.

As the support are enumerated those made of, for example, chemical pulps such as LBKP and NBKP; mechanical pulps such as GP, PGW, RMP, TMP, CTMP, CMP, and CGP; and waste paper pulps such as DIP. If desired, conventionally known pigments, binders, sizing agents, fixing agents, cationic agents, and paper strength additives may be added to and mixed with the pulps. The support can be formed using various apparatus such as a fourdrinier paper machine and a cylinder paper machine. Besides, synthetic papers and plastic films may be used.

The support desirably has a thickness of from 10 to 250 μm and a basis weight of from 10 to 250 g/m².

The support may be provided directly with an ink receiving layer and a back coat layer. Alternatively, after size pressing with starch or polyvinyl alcohol or providing an anchor layer, the support may be provided with an ink receiving layer and a back coat layer.

Further, the support may be subjected to flattening processing by calender apparatus such as a machine calender, a TG calender, and a soft calender.

As the support of the present invention, papers or plastic films, the both surfaces of which are laminated with a polyolefin (such as polyethylene, polystryrene, polyethylene terephthalate, polybutene, and copolymers thereof), are suitably used. Preferably, a white pigment (such as titanium oxide and zinc oxide) or a tinting dye (such as cobalt blue, ultramarine, and neodymium oxide) is added in the polyolefin.

The ink receiving layer contains a pigment, an aqueous binder, a mordant, a waterproofing agent, a lightfastness enhancer, a surfactant, and other additives.

As the pigment, a white pigment is preferable.

Examples of the white pigment include white inorganic pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide, and zinc carbonate; and organic pigments such as styrenic pigments, acrylic pigments, urea resins, and melamine resins.

Of these, porous inorganic pigments are preferred, and particularly, synthetic amorphous silica having a large pore area is suitable.

As the synthetic amorphous silica, any of silicic anhydride obtained by the dry production process and hydrated silicic acid obtained by the wet production process can be used, and particularly, the hydrated silicic acid is suitably used.

Examples of the aqueous binder to be contained in the ink-receiving layer include water-soluble polymeric materials such as polyvinyl alcohol, silanol-modified polyvinyl alcohol, starch, cationic starch, casein, gelatin, carboxymethyl cellulose, hydroxymethyl cellulose, polyvinyl pyrrolidone, polyalkylene oxides, and polyalkylene oxide derivatives; and water-dispersible polymeric materials such as styrene-butadiene latices and acrylic emulsions.

The aqueous binder may be used singly or in admixture of two ore more thereof.

Among them, polyvinyl alcohol and silanol-modified polyvinyl alcohol are particularly suitable from the standpoints of adhesion to the pigment and peeling resistance of the ink receiving layer.

It is preferred that the mordant is immobilized. For this reason, polymer mordants are suitably used.

The polymer mordants are described in, for example, JP-A-48-28325, JP-A-54-74430, JP-A-54-124726, JP-A-55-22766, JP-A-55-142339, JP-A-60-23850, JP-A-60-23851, JP-A-60-23852, JP-A-60-23853, JP-A-60-57836, JP-A-60-60643, JP-60-118834, JP-A-60-122940, JP-A-60-122941, JP-A-60-122942, JP-A-60-235134, JP-A-1-161236, and U.S. Pat. Nos. 2,484,430, 2,548,564, 3,148,061, 3,309,690, 4,115,124, 4,124,386, 4,193,800, 4,273,853, 4,282,305, and 4,450,224. Of these are particularly preferable image-receiving materials containing the polymer mordant as described on pages 212 to 215 of JP-A-1-161236. When the polymer mordant as described in this patent is used, not only images having a superior image quality are obtained, but also lightfastness of the images is improved.

The waterproofing agent is used for the purpose of making the image waterproof.

As the waterproofing agent is particularly preferable a cationic resin.

Examples of the cationic resin include polyamidepolyamine epichlorohydrin, polyethyleneimine, polyaminesulfone, dimethyldiallyammonium chloride polymers, cationic polyacrylamide, and colloidal silca. Of these are particularly suitable polyamidepolyamine epichlorohydrin.

A content of the cationic resin is preferably from 1 to 15% by weight, and particularly preferably from 3 to 10% by weight based on all of the solids of the ink receiving layer.

Examples of the lightfastness enhancer include zinc sulfate, zinc oxide, hindered amine-based antioxidants, and benzotriazole-based ultraviolet absorbers such as benzophenone. Of these is particularly suitable zinc sulfate.

The surfactant functions as a coating assistant, a peeling improver, a slipperiness improver, or an antistatic agent.

The surfactant is described in JP-A-62-173463 and JP-A-62-183457.

An organic fluorocarbon compound may be used in place of the surfactant.

Preferably, the organic fluorocarbon compound is hydrophobic.

Examples of the organic fluorocarbon compound include fluorine-based surfactants, oily fluorine-based compounds (such as fluorocarbon oils), and solid fluorine-based compounds (such as tetrafluoroethylene resins). The organic fluorocarbon compound is described in JP-B-57-9053 (columns 8 to 17), JP-A-61-20994, and JP-A-62-135826.

Examples of other additives to be added to the ink-receiving layer include a pigment dispersing agent, a thickening agent, an antifoaming agent, a dye, a fluorescent brightener, an antiseptic, a pH regulator, a matting agent, and a hardener.

The back coat layer contains a white pigment, an aqueous binder, and other components.

Examples of the white pigment include white inorganic pigments such as precipitated calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, alumina, lithopone, zeolite, hydrated halloysite, magnesium carbonate, and magnesium hydroxide; and organic pigments such as styrenic plastic pigments, arylic plastic pigments, polyethylene, microcapsules, urea resins, and melamine resins.

Examples of the aqueous binder include water-soluble polymeric materials such as a styrene/maleic acid salt copolymer, a styrene/acrylic acid salt copolymer, polyvinyl alcohol, silanol-modified polyvinyl alcohol, starch, cationic starch, casein, gelatin, carboxymethyl cellulose, hydroxymethyl cellulose, and polyvinyl pyrrolidone; and water-dispersible polymeric materials such as styrene-butadiene latices and acrylic emulsions.

Examples of other components to be contained in the back coat layer include an antifoaming agent, a foam inhibitor, a dye, a fluorescent brightener, an antiseptic, and a waterproofing agent.

In the respective layers of the recording paper or recording film may be added a polymer latex.

The polymer latex is used for the purpose of improving the film physical properties such as dimensional stabilization, prevention of curling, prevention of adhesion, and prevention of film cracks.

The polymer latex is described in JP-A-62-245258, JP-A-62-1316648, and JP-A-62-110066. When a polymer latex having a low glass transition temperature (40° C. or lower) is added in the layer containing a mordant, the film cracks and the curling can be prevented. Further, when a polymer latex having a high glass transition temperature is added to the back coat layer, the curling can be prevented.

The recording medium that is used in the inkjet recording method of the present invention is not particularly limited. However, when a recording medium comprising a support having an ink receiving layer laminated thereon, the ink receiving layer containing a white pigment, is used as the recording medium, the formed image becomes a high-quality image, and hence, such is preferred. With respect to the conventional inks, in the case where a recording paper provided with an ink receiving layer containing a porous inorganic pigment such as a white pigment is used, there was a problem such that the penetration of the ink into the recording paper is poor so that the dye likely peels apart from the surface of the recording paper upon rubbing by fingers. However, since the ink of the present invention is superior in penetration, such a problem is solved. Accordingly, when the foregoing recording medium, it is possible to form a high-quality and high-intensity image.

The inkjet ink of to the present invention may be applied to any inkjet recording mode. As the inkjet recording mode are suitably employed a charge control mode for discharging the ink utilizing an electrostatic induction force; a drop-on-demand mode (pressure pulse mode) utilizing an oscillation pressure of piezoelectric elements; an acoustic inkjet mode for converting electric signals into acoustic beams, irradiating the ink with the acoustic beams and discharging the ink utilizing a radiation pressure; and a thermal inkjet (bubble jet) mode for heating the ink to form foams and utilizing a generated pressure. Among them are preferable a charge control mode, a pressure pulse mode, and an acoustic inkjet mode, with a charge control mode and a pressure pulse mode being particularly preferred.

The inkjet recording mode includes a mode for injecting many small-volume inks having a low concentration, called a photo-ink; a mode for using a plurality of inks having substantially the same hue and a different concentration to improve the image quality; and a mode for using a colorless transparent ink.

### EXAMPLE

The present invention will be described below with reference to the following Examples, but it should not be construed that the present invention is limited thereto.

### Example 1

(1) Preparation of Dispersions of Colored Fine Particles:

<Preparation of Dispersion BM-1 of Colored Fine Particles>

8 g of a magenta dye (a-16) and 2 g of an oil-soluble polymer (PA-12) were dissolved in 6.4 g of a high-boiling organic solvent (s-2), 9.6 g of a high-boiling organic solvent (s-11), 4.0 g of dioctyl sulfosuccinate, and 50 mL of ethyl acetate at 70° C. To the solution was added 200 mL of deionized water while stirring by a magnetic stirrer, to prepare a dispersion of coarse particles of an oil-in-water type.

The dispersion of coarse particles was passed through a micro-fluidizer (manufactured by MICROFLUIDEX INC) under a pressure of 600 bar 5 times, to prepare fine particles. The obtained emulsion was subjected to desolvation by a rotary evaporator until the odor of ethyl acetate had disappeared. A volume average particle size of the colored fine particles in the dispersion was measured using MICROTRAC UPA (manufactured by NIKKISO CO., LTD.) and found to be 38 nm.

<Preparation of Dispersions BM-2 to BM-5 of Colored Fine Particles and Dispersion BM-6 of Colored Fine Particles for Comparison>

Dispersions BM-2 to BM-5 of colored fine particles (magenta dye dispersions) of the present invention and a dispersion BM-6 of colored fine particles of a different dye species for comparison (magenta dye dispersion) were prepared basically in the same manner as in the foregoing preparation of the dispersion BM-1 of colored fine particles, except that the kinds and amounts of the dye, the high-boiling organic solvent, and the oil-soluble polymer were changed as shown in Table 1.

TABLE 1

| | Oil- | High-boiling | Oil- | Dye/oil/polymer | Particle size | |
|---|---|---|---|---|---|---|
| | soluble | organic solvent | soluble | ratio | of dispersion | |
| No. | dye | (oil) | polymer | (weight ratio) | (nm) | Remarks |
| BM-1 | a-16 | s-2/s-11 (4/6) | PA-12 | 1/2/0.25 | 38 | Invention |
| BM-2 | a-16 | s-10/s-15 (8/2) | PA-14 | 1/3/0.5 | 38 | Invention |
| BM-3 | a-3 | s-2/s-11 (4/6) | PA-21 | 1/2/0.25 | 27 | Invention |
| BM-4 | a-3 | s-1/s-30 (3/7) | PC-6 | 1/3/0.5 | 32 | Invention |
| BM-5 | a-21 | s-2/s-11 (4/6) | PA-10 | 1/2/0.25 | 35 | Invention |
| BM-6 | M-1 | s-2/s-11 (4/6) | PA-12 | 1/2/0.25 | 37 | Comparison |

The ratio of dye/polymer/high-boiling organic solvent is a relative value when the amount of the dye is 1. 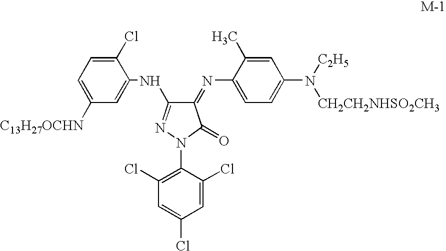
(2) Preparation of Inks for Inkjet Recording:
<Preparation of Ink 101>

The foregoing dispersion of colored fine particles was mixed with the following materials, and the mixture was filtered by a 0.45-μm filter to prepare an aqueous ink 101 for magenta inkjet recording.

| | | |
|---|---|---|
| Dispersion of colored fine particles (BM-1): | 15 | g |
| Diethylene glycol: | 10 | g |
| Tetraethylene glycol monobutyl ether: | 2 | g |
| Glycerin: | 4 | g |
| Diethanolamine: | 1 | g |
| Polyethylene glycol (mean repeating number | 1 | g |
| of ethylene oxide: 12) having 2-butyl | | |
| octanate as one terminal end: | | |
| Water to make: | 100 | g |

<Preparation of Inks 102 to 107>

Aqueous inks 102 to 105 for inkjet recording of the present invention and inks 106 and 107 for inkjet recording for comparison were prepared in the same manner as in the preparation of the ink 101, except that the dispersion of colored fine particles (BM-1) as used in the preparation of the ink 101 was changed to each of the dispersions of colored fine particles (BM-2 to BM-5 and BM-6), and that the amounts of the dispersion of colored fine particles and water to be added finally were changed such that the ultimate solids content of the dye was identical.

<Preparation of ink 107>

The following materials including the aqueous dye were mixed, and the mixture was filtered by a 0.45-μm filter to prepare an aqueous ink 107 for inkjet recording for comparison

(2.8 g of a dye M-2 was used in the ink 107).

| | | |
|---|---|---|
| Aqueous coloring agent: | 2.8 | g |
| Diethylene glycol: | 10 | g |
| Tetraethylene glycol monobutyl ether: | 10 | g |
| Glycerin: | 5 | g |
| Triethanolamine: | 1 | g |
| Polyethylene glycol (mean repeating number of | 1 | g |
| ethylene oxide: 10) having 2-undecanol ether as one | | |
| terminal end: | | |
| Water to make: | 100 | g |

M-2

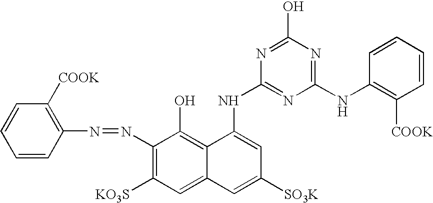

(Image Recording and Evaluation)

Each of the thus prepared inks 101 to 107 was filled in a cartridge of an inkjet printer, PM-670C (manufactured by SEIKO EPSON CORPORATION) and imagewise recorded on each of a plain paper for PPC and an inkjet paper photo glossy paper, EX (manufactured by FUJI PHOTO FILM CO., LTD.) using the same inkjet printer. The resulting images were evaluated in the following manners. The results are shown in Table 2 below.

<Evaluation of Printing Performance>

The cartridge was set in the printer. After confirming the ejection of the ink from all of nozzles, an image was output on ten A4-size papers, and disturbance of the printing was evaluated on the following criteria.
A: No disturbance of the printing was observed from the start until completion of the printing.,
B: The disturbance of the printing was sometimes observed from the start until completion of the printing.
C: The disturbance of the printing was observed from the start until completion of the printing.
   <Evaluation of Paper Dependency>

The image formed on the photo glossy paper was compared with the image formed on the plain paper for PPC in terms of color tone. The evaluation was made on the following three grades.
A: A difference was not substantially observed.
B: A little difference was observed.
C: A large difference was observed.
   <Evaluation of Gloss>

The sample printed on the photo glossy paper was visually evaluated for unevenness in gloss on the following three grades.
A: No unevenness in gloss was observed.
B: Unevenness in gloss was slightly observed.
C: Unevenness in gloss was explicitly observed.

In the case where the penetration of the ink for inkjet recording into paper is insufficient, the unevenness in gloss is remarkable. Thus, the unevenness in gloss will be an index of the penetration properties.

<Evaluation of Water Resistance>

The photo glossy paper having an image formed thereon was dried at room temperature for one hour, immersed in water for 30 seconds, and then spontaneously dried at room temperature, thereby observing bleeding. The bleeding was evaluated on the following three grades.
A: No bleeding was observed.
B: Bleeding was slightly observed.
C: Bleeding was greatly observed.
   <Evaluation of Lightfastness>

The photo glossy paper having an image formed thereon was irradiated with a xenon light (100,000 1×) using a weatherometer (Atlas C. 165) for 7 days, and the image density before and after the irradiation with a xenon light was measured using a reflection densitometer (X-Rite 310TR) and evaluated as a pigment retention rate. Incidentally, the reflection density was measured at three points of 1, 1.5 and 2.0.

The lightfastness was evaluated on the following three grades.
A: The pigment retention rate was 80% or more in any density.
B: The pigment retention rate was less than 80% and 70% or more in any density.
C: The pigment retention rate was less than 70% in any density.
   <Ozone Resistance>

The ozone resistance was evaluated by measuring the image density before and after preserving the sample under a condition having an ozone concentration of 0.5 ppm for 7 days using a reflection densitometer (X-Rite 310) and determining the pigment retention rate.

The ozone resistance was evaluated on the following five grades: the case where the pigment retention rate was 90% or more is designated as “A”; the case where the pigment retention rate was from 89 to 80% is designated as “B”; the case where the pigment retention rate was from 79 to 70% is designated as “C”; the case where the pigment retention rate was from 69 to 50% is designated as “D”; and the case where the pigment retention rate was less than 50% is designated as “E”, respectively.

TABLE 2

| Ink | Dispersion | Printing | Paper | | Water | Light- | Ozone | |
|---|---|---|---|---|---|---|---|---|
| No. | No. | performance | dependency | Gloss | resistance | fastness | resistance | Remarks |
| 101 | BM-1 | A | A | A | A | A | A | Invention |
| 102 | BM-2 | A | A | A | A | A | A | Invention |
| 103 | BM-3 | A | A | A | A | A | A | Invention |
| 104 | BM-4 | A | A | A | A | A | A | Invention |
| 105 | BM-5 | A | A | A | A | A | A | Invention |
| 106 | BM-6 | A | A | A | A | B | D | Comparison |
| 107 | M-2 | A | B | A | C | C | E | Comparison |

As is apparent from the results of Table 2, the ink compositions of the present invention were superior printability, color development, color tone and gloss, were free from paper dependency, and were superior in water resistance, lightfastness and ozone resistance.

### Example 2

(1) Preparation of Dispersions of Colored Fine Particles:

<Preparation of Dispersion BC-1 of Colored Fine Particles>

20 g of a cyan dye (II-5) and 5 g of an oil-soluble polymer (PA-12) were dissolved in 16.0 g of a high-boiling organic solvent (s-2), 24.0 g of a high-boiling organic solvent (s-11), 8.0 g of dioctyl sulfosuccinate, and 30 mL of ethyl acetate at 70° C. To the solution was added 200 mL of deionized water while stirring by a magnetic stirrer, to prepare a dispersion of coarse particles of an oil-in-water type.

The dispersion of coarse particles was passed through a micro-fluidizer (manufactured by MICROFLUIDEX INC) under a pressure of 600 bar 5 times, to prepare fine particles. The obtained emulsion was subjected to desolvation by a rotary evaporator until the odor of ethyl acetate had disappeared. A volume average particle size of the colored fine particles in the dispersion was measured using MICROTRAC UPA (manufactured by NIKKISO CO., LTD.) and found to be 45 nm.

<Preparation of Dispersions BC-2 to BC-8 of Colored Fine Particles and Dispersion BC-9 of Colored Fine Particles for Comparison>

Dispersions BC-2 to BC-8 of colored fine particles (cyan dye dispersions) of the present invention and a dispersion BC-9 of colored fine particles of a different dye species for comparison (cyan dye dispersion) were prepared basically in the same manner as in the foregoing preparation of the dispersion BC-1 of colored fine particles, except that the kinds and amounts of the dye, the high-boiling organic solvent, and the oil-soluble polymer were changed as shown in Table 3 below.

TABLE 3

| | Oil- | High-boiling | Oil- | Dye/oil/polymer | Particle size | |
|---|---|---|---|---|---|---|
| | soluble | organic solvent | soluble | ratio | of dispersion | |
| No. | dye | (oil) | polymer | (weight ratio) | (nm) | Remarks |
| BC-1 | II-5 | s-2/s-11 (4/6) | PA-12 | 1/2/0.25 | 45 | Invention |
| BC-2 | II-9 | s-9/s-24 (3/7) | PA-14 | 1/3/0.5 | 43 | Invention |
| BC-3 | II-3 | s-2/s-11 (4/6) | PA-25 | 1/2/0.25 | 33 | Invention |
| BC-4 | II-1 | s-9/s-24 (3/7) | PC-10 | 1/3/0.5 | 39 | Invention |
| BC-5 | II-13 | s-2/s-11 (4/6) | PC-8 | 1/2/0.25 | 40 | Invention |
| BC-6 | II-4 | s-2/s-11 (4/6) | PA-12 | 1/2/0.25 | 38 | Invention |
| BC-7 | II-14 | s-1/s-30 (3/7) | PA-21 | 1/2/0.25 | 42 | Invention |
| BC-8 | II-25 | s-2/s-11 (4/6) | PA-2 | 1/2/0.25 | 31 | Invention |
| BC-9 | C-1 | s-2/s-11 (4/6) | PA-12 | 1/2/0.25 | 35 | Comparison |

The ratio of dye/polymer/high-boiling organic solvent is a relative value when the amount of the dye is 1. 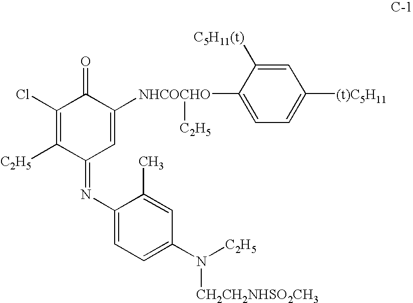
(2) Preparation of Inks for Inkjet Recording:
<Preparation of Ink 201>

The foregoing dispersion of colored fine particles was mixed with the following materials, and the mixture was; filtered by a 0.45-μm filter to prepare an aqueous ink 201 for inkjet recording.

| | | |
|---|---|---|
| Dispersion of colored fine particles (BC-1): | 20 | g |
| Diethylene glycol: | 10 | g |
| Tetraethylene glycol monobutyl ether: | 2 | g |
| Glycerin: | 4 | g |
| Diethanolamine: | 1 | g |
| Polyethylene glycol (mean repeating number | 1 | g |
| of ethylene oxide: 12) having 2-butyl | | |
| octanate as one terminal end: | | |
| Water to make: | 100 | g |

<Preparation of Inks 202 to 209>

Aqueous inks 202 to 208 for inkjet recording of the present invention and an ink 209 for inkjet recording for comparison were prepared in the same manner as in the preparation of the ink 201, except that the dispersion of colored fine particles (BC-1) as used in the preparation of the ink 201 was changed to each of the dispersions of colored fine particles (BC-2 to BC-9), and that the amounts of the dispersion of colored fine particles and water to be added finally were changed such that the ultimate solids content of the dye was identical.

<Preparation of Ink 210>

The following materials including the aqueous dye were mixed, and the mixture was filtered by a 0.45-μm filter to prepare an aqueous ink 210 for inkjet recording for comparison.

| | | |
|---|---|---|
| Aqueous coloring agent (C-2): | 3.5 | g |
| Diethylene glycol: | 10 | g |
| Tetraethylene glycol monobutyl ether: | 10 | g |
| Glycerin: | 5 | g |
| Triethanolamifle | 1 | g |
| Polyethylene glycol (mean repeating number of | 1 | g |
| ethylene oxide: 10) having 2-undecanol ether as one | | |
| terminal end: | | |
| Water to make: | 100 | g |

C-2

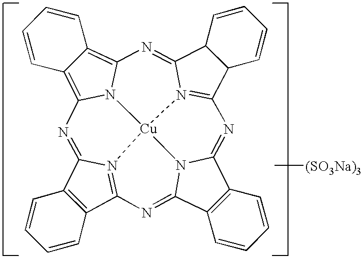

(Image Recording and Evaluation)

Each of the thus prepared inks 201 to 210 was filled in a cartridge of an inkjet printer, PM-670C (manufactured by SEIKO EPSON CORPORATION) and imagewise recorded on each of a plain paper for PPC and an inkjet paper photo glossy paper, EX (manufactured by FUJI PHOTO FILM CO., LTD.) using the same inkjet printer. The resulting images were evaluated in the following manners. The results are shown in Table 4 below. Incidentally, each of the evaluation items of the evaluation of printing performance, the evaluation of paper dependency, the evaluation of gloss, the evaluation of water resistance, the evaluation of lightfastness, and the ozone resistance was determined on the same evaluation standards as in Example 1.

TABLE 4

| Ink | Dispersion | Printing | Paper | | Water | Light- | Ozone | |
|---|---|---|---|---|---|---|---|---|
| No. | No. | performance | dependency | Gloss | resistance | fastness | resistance | Remarks |
| 201 | BC-1 | A | A | A | A | A | A | Invention |
| 202 | BC-2 | A | A | A | A | A | A | Invention |
| 203 | BC-3 | A | A | A | A | A | A | Invention |
| 204 | BC-4 | A | A | A | A | A | A | Invention |
| 205 | BC-5 | A | A | A | A | A | A | Invention |
| 206 | BC-6 | A | A | A | A | A | A | Invention |
| 207 | BC-7 | A | A | A | A | A | A | Invention |
| 208 | BC-8 | A | A | A | A | A | A | Invention |
| 209 | BC-9 | A | A | A | A | B | E | Comparison |
| 210 | C-2 | A | B | A | C | B | E | Comparison |

As is apparent from the results of Table 4, the ink compositions of the present invention were superior printability, color development, color tone and gloss, were free from paper dependency, and were superior in water resistance, lightfastness and ozone resistance.

### Example 3

(1) Preparation of Dispersions of Colored Fine Particles:

<Preparation of Dispersion of Colored Fine Particles (B-1)>

To a mixed solution of 4 g of tetrahydrofuran, 6 g of t-butanol, 1.5 g of an oil-soluble polymer (PA-56), and 0.5 g of a phthalocyanine coloring agent (AII-19) was gradually added 2 mole/L of sodium hydroxide in an amount such that the acid in the oil-soluble polymer was neutralized, and the mixture was elevated to a temperature of 70° C. Thereafter, 30 g of water was gradually added thereto to cause phase reversal of emulsion. The resulting solution was concentrated in vacuo at 30° C., to prepare a dispersion of colored fined particles having a solids content of 16%. A volume average particle size of the colored fine particles in the dispersion of colored fine particles was measured using MICROTRAC UPA 150 (manufactured by NIKKISO CO., LTD.) and found to be 23 nm. This dispersion is abbreviated as a dispersion of colored fine particles (B-1).

<Preparation of Dispersion of Colored Fine Particles (B-2)>

A mixed solution of 3 g of ethyl acetate, 0.5 g of cyclohexanone, 1.4 g of an oil-soluble polymer (PA-51), and 0.6 g of a phthalocyanine coloring agent (AII-19). Separately, a mixed solution of 2 mole/L of sodium hydroxide in an amount such that the acid in the oil-soluble polymer was neutralized, 15 g of water, and 0.3 g of sodium di(2-ethylhexyl)sulfosuccinate was prepared. The two kinds of the mixed solutions were gathered. The mixture was mixed and emulsified by a homogenizer and then concentrated in vacuo at 30° C. to prepare a dispersion of colored fine particles having a solids content of 13.3%. A volume average particle size of the colored fine particles in the dispersion of colored fine particles was measured and found to be 74 nm. This dispersion is abbreviated as a dispersion of colored fine particles (B-2).

<Preparation of Dispersion of Colored Fine Particles (B-3)>

A mixed solution of 3 g of ethyl acetate, 0.5 g of cyclohexanone, 0.8 g of an oil-soluble polymer (PA-60), 0.6 g of a phthalocyanine coloring agent (AII-19), and 0.4 g of a hydrophobic high-boiling organic solvent (s-2). Separately, a mixed solution of 2 mole/L of sodium hydroxide in an amount such that the acid in the oil-soluble polymer was neutralized, 15 g of water, and 0.3 g of sodium di(2-ethylhexyl)sulfosuccinate was prepared. The two kinds of the mixed solutions were gathered. The mixture was mixed and emulsified by a homogenizer and then concentrated in vacuo at 30° C. to prepare a dispersion of colored fine particles having a non-volatile matter content of 14.0%. A volume average particle size of the colored fine particles in the dispersion of colored fine particles was measured and found to be 82 nm. This dispersion is abbreviated as a dispersion of colored fine particles (B-3)-<

Preparation of Dispersion of Colored Fine Particles (B-4)>

6.4 g of a phthalocyanine coloring agent (AII-21), 7.0 g of sodium dioctylsulfosuccinate, and 7.8 g of an oil-soluble polymer (PA-59) were dissolved in 5.0 g of a hydrophobic high-boiling organic solvent (s-2) and 50 g of ethyl acetate at 70° C. To the solution was added 400 g of deionized water while stirring-by a-magnetic stirrer, to prepare a dispersion of coarse particles of an oil-in-water type. Next, the dispersion of coarse particles was passed through a micro-fluidizer (manufactured by MICROFLUIDEX INC) under a pressure of 600 bar 5 times, to prepare fine particles. Additionally, the resulting emulsion was concentrated into 160 g by a rotary evaporator. A volume average particle size of the colored fine particles in the dispersion of colored fine particles was measured and found to be 35 nm. This dispersion is abbreviated as a dispersion of colored fine particles (B-4).

<Preparation of Dispersions of Colored Fine Particles (B-5 to B-10)>

A dispersion of colored fine particles (B-5) was prepared in a similar manner to that in the preparation of the dispersion of colored fine particles (B-1); a dispersion of colored fine particles (B-6) was prepared in a similar manner to that in the preparation of the dispersion of colored fine particles (B-2); and dispersions of colored fine particles ((B-7) to (B-10)) were prepared in a similar manner to that in the preparation of the dispersion of colored fine particles (B-3), respectively. The oil-soluble polymers and phthalocyanine coloring agents as used are shown in Table 5 below. With respect to the “dispersion”, one in which coagulation was not substantially observed, and the particle size (volume average particle size) was 500 nm or less is evaluated as “good”.

TABLE 5

| | | | Hydrophobic | | | |
|---|---|---|---|---|---|---|
| | Oil-soluble | | High-boiling | | Particle size | |
| No. | polymer | Oil-soluble dye | organic solvent | Dispersion | (nm) | Remarks |
| B-1 | PA-56 | All-19 | — | Good | 23 | Invention |
| B-2 | PA-1 | All-19 | — | Good | 74 | InventIon |
| B-3 | PA-59 | All-19 | s-2 | Good | 82 | Invention |
| B-4 | PA-60 | All-21 | s-2 | Good | 35 | Invention |
| B-5 | PC-4 | All-Il | — | Good | 53 | InventIon |
| B-6 | PA-10 | All-17 | — | Good | 80 | Invention |
| B-7 | PA-59 | All-21 | s-2 & s-11* | Good | 78 | Invention |
| B-8 | PA-59 | All-3 | s-2 & s-11* | Good | 75 | Invention |
| B-9 | PA-59 | All-11 | s-2 & s-11* | Good | 80 | Invention |
| B-10 | PA-59 | DD-1 | s-2 & s-11* | Good | 72 | Comparison |

*(s-2) and (s-11) were used in a weight ratio of (s-2) to (s-11) of 36/64.
DD-1

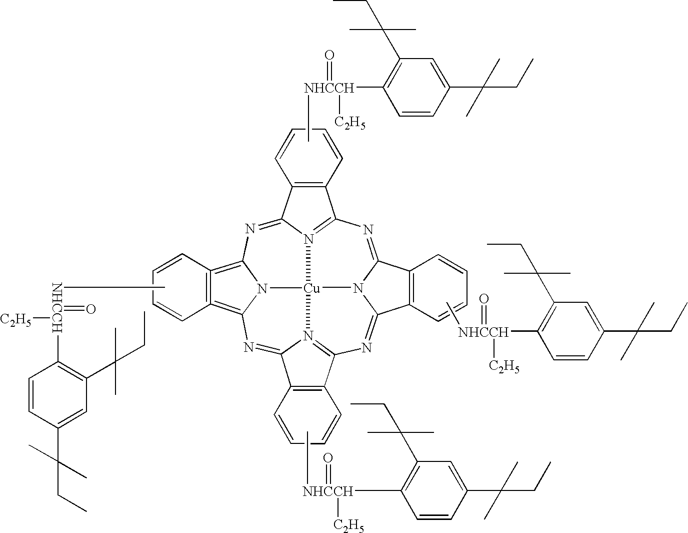

DD-2

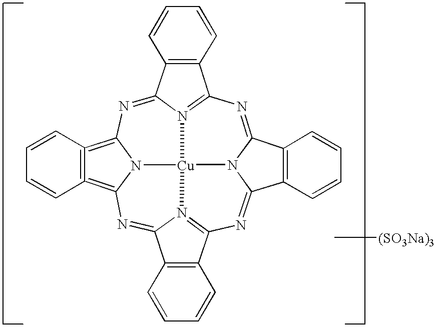

As is apparent from the results of Table 5, the dispersions of colored fine particles freed from coagulation and having a small particle size can be produced.

(2) Preparation of Inks for Inkjet Recording:

<Preparation of Ink 501>

The following materials were mixed, and the mixture was filtered by a 0.45-μm filter to prepare an aqueous ink 501 for inkjet recording.

| | | |
|---|---|---|
| Dispersion of colored fine particles (B-1): | 50 | g |
| Diethylene glycol: | 8 | g |
| Tetraethylene glycol monobutyl ether: | 2 | g |
| Glycerin: | 5 | g |
| Diethanolamine: | 1 | g |
| Polyethylene glycol (mean repeating number | 1 | g |
| of ethylene oxide: 10) having 2-butyl | | |
| octanate as one terminal end: | | |
| Water to make: | 100 | g |

<Preparation of ink 502>

An aqueous ink 502 for inkjet recording was prepared in the same manner as in the preparation of the ink 501, except that the dispersion of colored fine particles (B-1) as used in the preparation of the ink 501 was replaced by the dispersion of colored fine particles (B-2).

<Preparation of Ink 503>

The following materials were mixed, and the mixture was filtered by a 0.45-μm filter to prepare an aqueous ink 503 for inkjet recording.

| | | |
|---|---|---|
| Dispersion of colored fine particles (B-3): | 50 | g |
| Diethylene glycol: | 8 | g |
| Tetraethylene glycol monobutyl ether: | 2 | g |
| Glycerin: | 5 | g |
| Diethanolamine: | 1 | g |
| OLFIN E1010 | 0.8 | g |
| Polyethylene glycol (mean repeating number | 0.5 | g |
| of ethylene oxide: 10) having 2-butyl | | |
| octanate as one terminal end: | | |
| Water to make: | 100 | g |

<Preparation of Inks 504 to 510>

Aqueous inks 504 to 510 for inkjet recording were prepared in the same manner as in the preparation of the ink 503, except that the dispersion of colored fine particles (B-3) as used in the preparation of the ink 503 was replaced by each of the dispersions of colored fine particles (B-4) to (B-10).

<Preparation of Ink 511>

The following materials were mixed, and the mixture was filtered by a 0.45-μm filter to prepare an aqueous ink 511 for inkjet recording.

| | | |
|---|---|---|
| Water-soluble dye (DD-2): | 4 | g |
| Diethylene glycol: | 8 | g |
| Tetraethylene glycol monobutyl ether: | 5 | g |
| Glycerin: | 5 | g |
| Diethanolamine: | 1 | g |
| Polyethylene glycol (mean repeating number | 1 | g |
| of ethylene oxide: 10) having 2-butyl | | |
| octanate as one terminal end: | | |
| Water to make: | 100 | g |

(Image Recording and Evaluation)

The evaluation of the ink sets except for the ozone resistance and oxidation potential was carried out in the same manner as in Example 1.

<Ozone Resistance>

The ozone resistance was evaluated by measuring the image density before and after preserving the sample under a condition having an ozone concentration of 1.0 ppm for 3 days using a reflection densitometer (X-Rite 310) and determining the dye retention rate.

The ozone resistance was evaluated on the following five grades: the case where the pigment retention rate was 90% or more is designated as “A”; the case where the pigment retention rate was from 89 to 80% is designated as “B”; the case where the pigment retention rate was from 79 to 70% is designated as “C”; the case where the pigment retention rate was from 69 to 50% is designated as “D”; and the case where the pigment retention rate was less than 50% is designated as “E”, respectively.

<Oxidation Potential>

A definite amount (converted as molecular weight) of the dye was weighed and measured in N,N-dimethylformamide containing 0.1 moldm⁻³ of tetrapropylammonium perchlorate (dye concentration: 0.001 moldm⁻³) as a supporting electrolyte by direct current polarography, to determine a value of oxidation potential. In a polarography unit, a carbon (GC) electrode was used as a work electrode, and a rotating platinum electrode was used as a counter electrode; an oxidation wave obtained by sweeping at the oxidation side was subjected to linear approximation; and a middle point between an intersection with its peak value and an intersection with the residual current value was defined as the value of oxidation potential (vs SCE). The measurement results of the phthalocyanine compounds used in the Examples and the comparative compounds are shown in Table 6 below.

TABLE 6

| | Oil- | | | | | | | | |
|---|---|---|---|---|---|---|---|---|---|
| Ink | soluble | Printing | Paper | Water | Light- | Dark heat | Ozone | Oxidation | |
| No. | dye | performance | dependency | resistance | fastness | fastness | resistance | potential | Remarks |
| 501 | AII-19 | A | A | A | A | A | A | 1.16 | Invention |
| 502 | AII-19 | A | A | A | A | A | A | 1.16 | Invention |
| 503 | AII-19 | A | A | A | A | A | A | 1.16 | Invention |
| 504 | AII-21 | A | A | A | A | A | A | 1.27 | Invention |
| 505 | AII-17 | A | A | A | A | A | A | 1.15 | Invention |
| 506 | AII-17 | A | A | A | A | A | A | 1.15 | Invention |
| 507 | AII-21 | A | A | A | A | A | A | 1.27 | Invention |
| 508 | AII-3 | A | A | A | A | A | A | 1.25 | Invention |
| 509 | AII-12 | A | A | A | A | A | A | 1.16 | Invention |
| 510 | DD-1 | A | A | A | A | A | E | 0.75 | Comparison |
| 511 | DD-2 | A | B | C | B | A | E | 0.75 | Comparison |

As is apparent from the results of Table 6, the inks for inkjet recording of the present invention were superior printability, color development and color tone and gloss, were free from paper dependency, and were superior in water resistance, lightfastness, dark heat resistance and ozone resistance.

### Examples 4

The following ink sets were prepared, on which was then recorded a full-color image. Then, the evaluation was carried out in the same manners as in Example 1. Any of the dyes as used had an oxidation potential of 1.1 V or more.

<Cyan Ink>

The ink 201 as prepared in Example 2 was used as it was.

<Light Cyan Ink>

An ink having exactly the same constitution as in the ink 201 was prepared, except that the amount of the colored fine particles was reduced such that the concentration of the dispersion of colored fine particles of the ink 201 was ¼.

<Magenta Ink>

A magenta ink was prepared in the same manner as in the preparation of the cyan ink 201 of Example 2, except that 20 g of the coloring agent (II-5) was replaced by 8.0 g of the coloring agent (a-16).

<Light Magenta Ink>

A light magenta ink having exactly the same constitution as the foregoing magenta ink using the coloring agent (a-16) was prepared, except that the amount of the colored fine particles was reduced such that the concentration of the dispersion of colored fine particles was ¼.

<Yellow Ink>

A yellow ink was prepared in the same manner as in the preparation of the cyan ink 201, except that 20 g of the coloring agent (11-5) was replaced by 10.0 g of the coloring agent (Y-120) as described in Example 2.

<Black Ink>

A black ink was prepared in the same manner as in the preparation of the foregoing cyan ink, except that 20 g of the coloring agent (II-5) was replaced by 4 g of a coloring agent (a-16), 5.0 g of the coloring agent (Y-120) and 10.0 g of the coloring agent (II-5).

Incidentally, the rate of dye/high-boiling organic solvent/oil-soluble polymer in each of the magenta, light magenta, cyan, light can, yellow and black inks was made constant.

(Image Recording and Evaluation)

The evaluation of the ink sets except for the ozone resistance and oxidation potential was carried out in the same manner as in Example 1.

(Image Recording and Evaluation)

The thus prepared ink sets were evaluated in the same manner as in Example 1. Further, the evaluation of dryness, evaluation of dark heat fatness, evaluation of bleeding of fine lines, and evaluation of scratch resistance were made in the following manners.

<Evaluation of Dryness>

Immediately after printing an image, the image portion was touched with fingers, and the generated stain was visually evaluated.

<Evaluation of Dark Heat Fastness>

After printing an image, the image was preserved at a relative humidity of 80 to 70% for 7 days, and the image density before and after the preservation was measured using a reflection densitometer (X-Rite 310TR) and evaluated as a pigment retention rate. Incidentally, the reflection density was measured at three points of 1, 1.5 and 2.0.

The dark heat fastness was evaluated on the following three grades.
A: The pigment retention rate was 80% or more in any density.
B: The pigment retention rate was less than 80% at one or two points of the density.
C: The pigment retention rate was less than 80% in any density.
   <Evaluation of Bleeding of Fine Lines>

Yellow, magenta, cyan and black fine line patterns were printed, and the bleeding was visually evaluated.

<Evaluation of Scratch Resistance>

After printing an image, the image was allowed to stand for 30 minutes. Then, the image was rubbed by an eraser, and the presence of absence of the density change of the image portion was visually evaluated. In the case where the density change was not substantially observed, the sample is evaluated as “superior”.

As a result of the printing tests of the foregoing ink sets, the ink sets were superior in color tone, water resistance, lightfastness and ozone resistance in not only the foregoing four colors but also mixed colors (such as blue and red). Further, the inks exhibited superior properties in dryness, bleeding of fine lines and scratch resistance.

According to the present invention, it is possible to provide an ink composition that when printed using a nozzle, does not cause clogging at the chip of the nozzle, is free from paper dependency, and when printed on an arbitrarily chosen paper, exhibits superior properties in water resistance, scratch resistance, lightfastness and ozone resistance and an inkjet recording method using it.

The entitle disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

1. An ink composition comprising colored fine particles containing an oil-soluble polymer and an oil-soluble dye having an oxidation potential higher than 1.0 V (vs SCE), dispersed in an aqueous medium.

2. The ink composition as in claim 1, wherein the oil-soluble dye is at least one member selected from dyes represented by the following general formula (M-I): 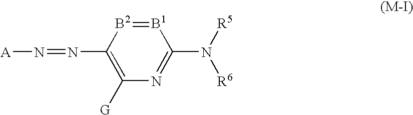
wherein A represents a residue of a 5-membered heterocyclic diazo component A-NH₂; B¹ and B² each represents —CR¹═ or —CR²═, or either one represents a nitrogen atom, and the other represents —CR¹═ or —CR²═; R⁵ and R⁶ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group, each of which may be substituted; G, R¹, and R² each independently represents a hydrogen atom, a halogen atom, an aliphatic group, an aromatic group, a heterocyclic group, a cyano group, a carboxyl group, a carbamoyl group, an alkoxycarbonyl group, an aryloxycarbonyl group, an acyl group, hydroxyl group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group (inclusive of an anilino group), an acylamino group, a ureido group, a sulfamoylamino group, an alkoxycarbonylamino group, an aryloxycarbonylamino group, an alkyl- or arylsulfonylamino group, an aryloxycarbonylamino group, a nitro group, an alkyl- or arylthio group, an alkyl- or arylsulfonyl group, an alkyl- or arylsulfinyl group, a sulfamoyl group, a sulfo group, or a heterocyclic thio group, each of which may further be substituted; and R¹ and R⁵, or R⁵ and R⁶ may be taken together to form a 5-membered or 6-membered ring,
dyes represented by the following general formula (C-I): 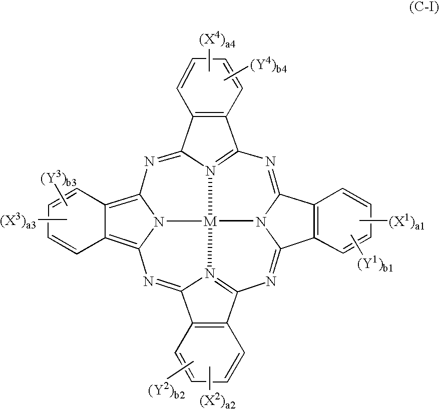
wherein X¹, X², X³, and X⁴ each independently represents at least one substituent selected from —SO-Z, —SO₂-Z, —SO₂NR¹R², —CONR¹R², and —CO₂R¹; Zs′ each independently represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group; R¹ and R² each independently represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, provided that both of R¹ and R² do not represent a hydrogen atom at the same time; Y¹, Y², Y³, and Y⁴ each independently represents a monovalent substituent; and a1 to a4 and b1 to b4 represent the number of substituents of X¹ to X⁴ and Y¹ to Y⁴, respectively, a1 to a4 each independently represents an integer of from 0 to 4, and b1 to b4 each independently represents an integer of from 0 to 4, provided that the total sum of a1 to a4 is 2 or more, and dyes represented by the following general formula (Y-I):
A-N═N-B (Y-I)
wherein A and B each independently represents an optionally substituted heterocyclic group.

3. The ink composition as in claim 1, further containing a hydrophobic high-boiling organic solvent having a boiling point of 150° C. or higher.

4. An inkjet recording method comprising using the ink composition according to claim 1.

5. The ink composition as in claim 2, wherein the dye represented by the general formula (C-I) is represented by the following general formula (C-II): 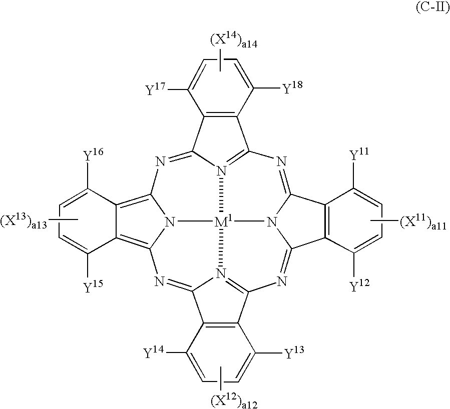
wherein X¹¹ to X¹⁴, Y¹¹ to Y¹⁸, and M¹ are synonymous with X¹ to X⁴, Y¹ to Y⁴, and M in the general formula (C-I), respectively; and a11 to a14 each independently represents an integer of 1 or 2.

6. The ink composition as in claim 1, wherein the oil-soluble polymer is a vinyl polymer.

7. The ink composition as in claim 3, wherein the hydrophobic high-boiling organic solvent has a relative dielectric constant as 25° C. in the range of from 3 to 12.

8. The ink composition as in claim 3, wherein a proportion of the hydrophobic high-boiling organic solvent to the dispersed particle component is 25% or more.

9. The ink composition as in claim 1, wherein the colored fine particles have a mean particle size of 100 nm or less.

10. The ink composition as in claim 1, containing at least one member of compounds represented by the following general formula (W-I) or (W-II): 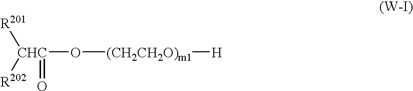
wherein R²⁰¹ and R²⁰² each independently represents a saturated hydrocarbon having from 2 to 20 carbon atoms, and m1 is from 2 to 40, and 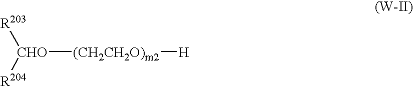
wherein R²⁰³ and R²⁰⁴ each independently represents a saturated hydrocarbon having from 4 to 10 carbon atoms, provided that the total sum of carbon atoms of R²⁰³ and R²⁰⁴ is from 8 to 18, and m2 is from 3 to 20.

11. The inkjet recording method as in claim 4, wherein the recording is carried out on a material to be recorded comprising a support having a porous inorganic pigment-containing ink receiving layer provided thereon.
